(19) United States
(12) Patent Application Publication
(10) Pub. No.: US 2023/0192929 A1
(43) Pub. Date: Jun. 22, 2023

(54) COMPOSITIONS COMPRISING MULTIPLE CHARGED CATIONIC COMPOUNDS FOR SOIL RELEASE

(71) Applicant: ECOLAB USA INC., Saint Paul, MN (US)

(72) Inventors: Ashish Dhawan, Saint Paul, MN (US); Paige Mary Owens-Polta, Saint Paul, MN (US); Carter M. Silvernail, Saint Paul, MN (US); Soni Basnet, Saint Paul, MN (US); Sukhwan Soontravanich, Saint Paul, MN (US)

(21) Appl. No.: 18/069,681

(22) Filed: Dec. 21, 2022

Related U.S. Application Data
(60) Provisional application No. 63/265,847, filed on Dec. 22, 2021.

(51) Int. Cl. C08F 226/02; C11D 3/00

(52) U.S. Cl. CPC C08F 226/02; C11D 3/0036; C11D 3/001

(57) ABSTRACT

Disclosed herein is a novel class of multiple charged cationic polymers that are derived from an aza-Michael Addition reaction between a polyamine (Michael donor) and an activated olefin (Michael acceptor), methods of making the same, and use thereof. Also disclosed herein are the methods of using multiple charged cationic polymers disclosed herein on a surface.

### TECHNICAL FIELD

The present disclosure relates generally to the field of multiple charged cationic polymers, methods of making the same, and use thereof. The present disclosure also relates generally to the field of soil removal from textiles using multiple charged cationic polymers, wherein the cationic compounds are preferably deposited onto the surface of the textile to improve soil removal. The present disclosure also relates to a novel class of multiple charged cationic polymers that are derived from an aza-Michael Addition reaction between a polyamine or a polyalkyleneimine such as branched, linear, or dendrimer polyethylenimines (Michael donor) and an α, β-unsaturated carbonyl compound, preferably one containing substituted alkyl trialkyl quaternary ammonium salts. (Michael acceptor), along with methods of making the same and use thereof. The disclosed multiple charged cationic polymers or their salts have at least two or three positive or negative charges within each molecule.

### TECHNICAL BACKGROUND

Soil release agents meant for deposition onto negatively charged surfaces, such as textiles, are included in many detergents and softening products. It is challenging to achieve effective deposition on such surfaces, particularly when the detergent or softening product is rinsed off of the textile surface. Such agents must also provide effective soil removal once deposited.

Soil removal and softening can be challenging given the wide variety of materials used in textile and paper manufacturing. For example, textiles may comprise many different fibers, including natural, manmade, or synthetic fibers. Natural fibers are generally derived from plants or animals. For example, protein-based natural fibers include wool and silk, while cellulosic fibers include cotton and linen. Manmade fibers such as rayon and acetate are generally manufactured from regenerated cellulose. Synthetic fibers include, for example, nylon, olefin, polyester, acrylic, and corterra. Cotton in particular is one of the most popular fibers used in textiles. Cotton can be combined or blended with other fibers to create blends that dry easily, demonstrate excellent elasticity, and feel soft. Cotton-containing textiles also demonstrate high absorbency, which is a desirable property for use but also means cotton stains easily. Additionally, cotton has poor resilience and poor abrasion resistance. The poor resiliency and abrasion resistance combined with harsher cleaning products typically required to remove soil from cotton-containing textiles result in a short lifespan and high replacement rate.

Stubborn cosmetic and oily soils pose a particular challenge in terms of soil removal. In the textile industry, a driving force behind textile replacement rate is due to stubborn stains which cannot be fully removed from the fabric. When soil is not properly removed after the first wash cycle, it must be re-washed one or more times, providing wear on the fabric. More effective product deposition on textile surfaces enhances soil removal, thereby minimizing the need for multiple wash cycles.

However, even when deposited effectively, deposition aids can still cause undue wear on textiles, including yellowing and reduction of softness. It is therefore necessary to provide compositions with deposition aids that provide effective soil removal efficacy without degrading textile texture or color.

Quaternary ammonium compounds have been used for many years as softeners and deposition aids. A distinction between quaternary ammonium compounds from other surfactants is their unique structure. Quaternary ammonium compounds consist mainly of two moieties, a hydrophobic group, e.g., long alkyl group, and a quaternary ammonium salt group. The unique positive charge of the ammonium plays a key role, e.g., electrostatic interactions, between the surfactant and surface or charge neutralization on surfaces of emulsion droplets. However, the quaternary ammonium compounds used as deposition aids can cause undesirable damage to textile surfaces and can be hazardous to use.

Therefore, there remains a need to develop compositions comprising deposition agents which are effectively placed on textile surfaces, providing enhanced soil removal of stubborn soils without degrading fabric quality.

A further object of the disclosure is to provide cleaning methods and compositions that are effective at removing cosmetic or oily soils from textiles.

A further object of the disclosure is to provide cleaning and/or softening methods and co wherein the target is a textile or a paper; compositions that are effective on paper.

These and other objects, advantages and features of the present disclosure will become apparent from the following specification taken in conjunction with the claims set forth herein.

### BRIEF SUMMARY

An advantage of the methods and compositions disclosed herein is that they are effective at removing soils from textiles, particularly stubborn soils, by depositing the multiple charged cationic polymer on the surface of textiles and/or paper. It is an advantage of the methods and compositions that even challenging soils, such as cosmetic and oily soils are effectively removed. A still further advantage of the methods and compositions is that the compositions do not degrade the texture or color of the textile, thereby reducing the replacement rate.

Disclosed herein are methods of cleaning a target comprising: contacting the target with a composition comprising a multiple charged cationic polymer formed from the reaction of a polyamine and a cationic monomer; depositing the composition on the target; and optionally removing soil from the target; wherein the polyamine is a linear polyamine according to the structure:

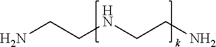

wherein k is an integer between 1 and 100; and wherein the cationic monomer is a monomer according to the structure:

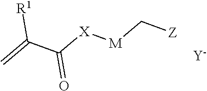

wherein R₁ is H, CH₃, or an unsubstituted, linear, or branched C₂-C₁₀ alkyl group; X is NH or O, M is absent or an unsubstituted, linear C₁-C₃₀ alkylene group; and Z is —NR₄R₅R₆(+) Y(−) wherein R₄, R₅, and R₆ are independently a C₁-C₁₀ alkyl group or a benzyl group, and Y is a halide or a methyl sulfate group.

In an embodiment, the target is a textile or a paper.

In an embodiment, the polyamine is tetraethylenepentamine, pentaethylenehexamine, hexaethyleneheptamine, or diethylenetriamine.

In a further embodiment, the polyamine is a branched polyethylenimine according to the structure:

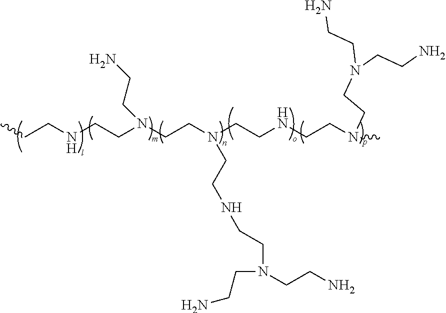

wherein l, m, n, o, or p is an integer of between 1 and 100.

In an embodiment, the cationic monomer is (3-acrylamidopropyl)trimethylammonium chloride (APTAC), [3-(methacryloylamino)propyl]trimethylammonium chloride (MAPTAC), N,N-dimethylaminoethyl acrylate benzyl chloride quaternary salt (DMAEA-BCQ), 2-(methacryloyloxy)-N,N,N-trimethylethan-1-aminium methyl sulfate (DMAEMA-MSQ), 2-(acryloyloxy)-N,N,N-trimethylethanaminium chloride (DMAEA-MCQ), or a combination thereof.

According to a further embodiment, the multiple charged cationic polymer is a compound according to the structure.

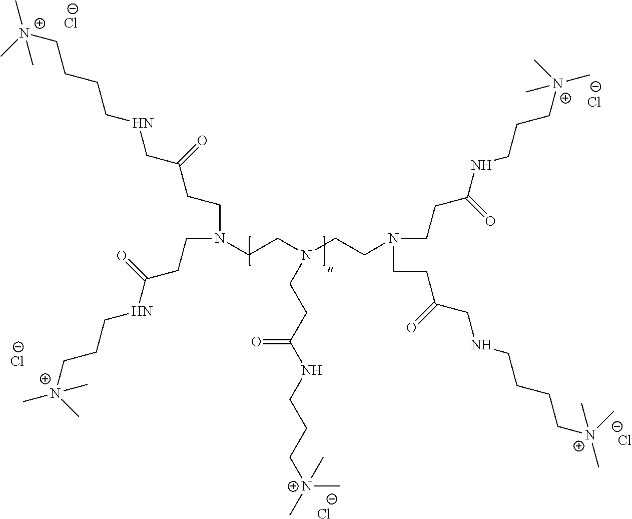

wherein n=0-1000.

In some embodiments, the multiple charged cationic polymer is a compound according to the structures:

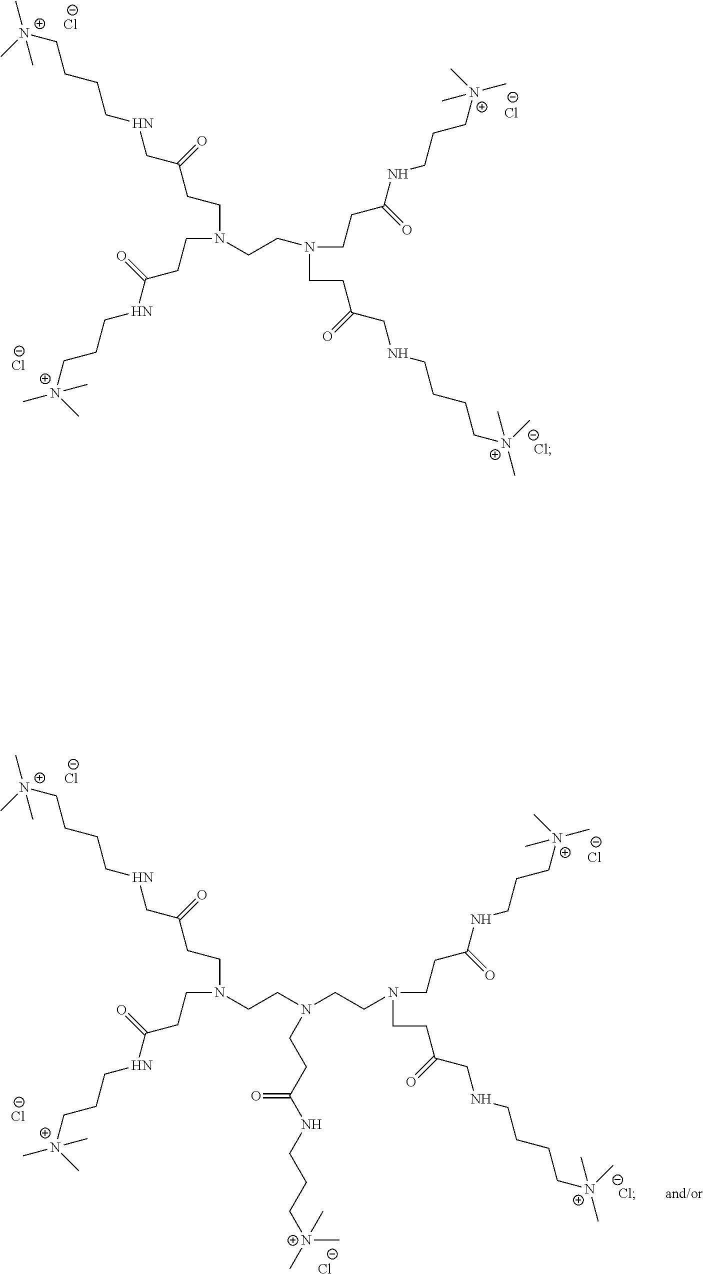

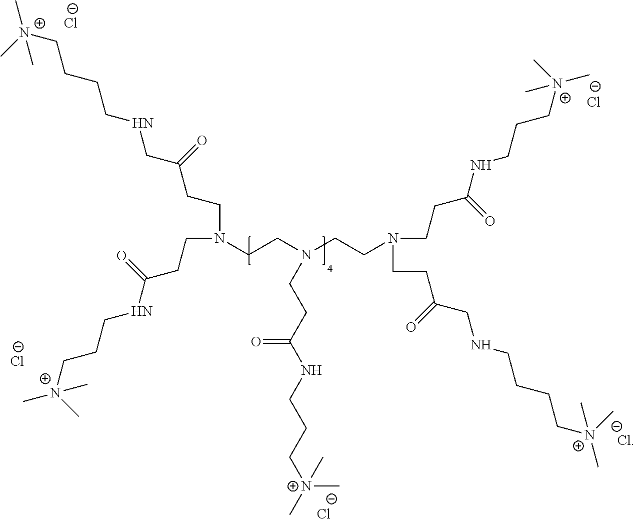

In some embodiments, the composition further comprises a silicone compound according to the structure:

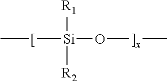

wherein each R₁ and R₂ are independently selected from a C₁-C₁₀ alkyl or alkenyl radical, phenyl, substituted alkyl, substituted phenyl, or units of —[—R₁R₂Si—O—]—; and x is a number from 50 to 300,000.

In other embodiments, the composition further comprises an amine softening agent comprising a triamine, an ether diamine, an aliphatic diamine, an ethoxylated amine, a branched amine surfactant, or a combination thereof.

In an embodiment, the amine softening agent is N-(3-aminopropyl)-N-dodecylpropane-1,3-diamine, N-(3-aminopropyl)-N-dodecylpropane-1,3-diamine, N, N-Bis (3-aminopropyl) dodecylamine, N1,N1,N3-tris(3-aminopropyl)-N3-dodecylpropane-1,3-diamine, N1,N1-bis(3-aminopropyl)-N3-dodecylpropane-1,3-diamine, N1-(3-aminopropyl)-N3-dodecylpropane-1,3-diamine, N-dodecylpropane-1,3-diamine, or a combination thereof.

According to some embodiments, the target is a textile and wherein the method occurs during a textile wash cycle comprising a pre-soak phase, a wash phase, a rinsing phase, a finishing phase, and an extraction phase.

In an embodiment, the composition is applied to the textile during the pre-soak phase, the finishing phase, the wash phase, or a combination thereof.

In an embodiment, the multiple charged cationic polymer is on the textile for more than one wash cycle.

According to some embodiments, the depositing provides effective soil removal for more than one wash cycle.

Also disclosed herein are multiple charged cationic polymer forming compositions comprising: a first reagent comprising a polyamine; and a second reagent comprising a cationic monomer; wherein the first reagent and the second reagent are contacted to generate a multiple charged cationic polymer.

In some embodiments, the polyamine is a linear polyamine according to the structure:

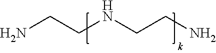

wherein k is an integer between 1 and 100.

In a further embodiment, the polyamine is tetraethylenepentamine, pentaethylenehexamine, hexaethyleneheptamine, or diethylenetriamine.

In a still further embodiment, the polyamine is a branched polyethylenimine according to the structure:

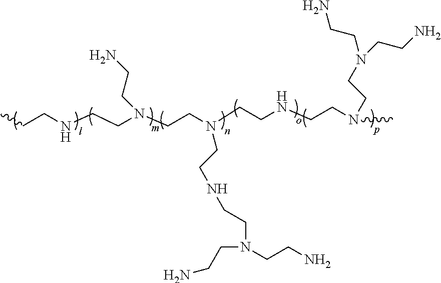

wherein l, m, n, o, or p is an integer of between 1 and 100.

In some embodiments, the cationic monomer is a monomer according to the structure:

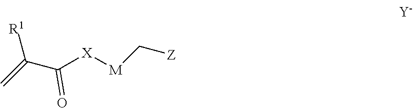

wherein R₁ is H, CH₃, or an unsubstituted, linear, or branched C₂-C₁₀ alkyl group; X is NH or O, M is absent or an unsubstituted, linear C₁-C₃₀ alkylene group; and Z is —NR₄R₅R₆(+) Y(−) wherein R₄, R₅, and R₆ are independently a C₁-C₁₀ alkyl group or a benzyl group, and Y is a halide or a methyl sulfate group.

In a further embodiment, the cationic monomer is (3-acrylamidopropyl)trimethylammonium chloride (APTAC), [3-(methacryloylamino)propyl]trimethylammonium chloride (MAPTAC), N,N-dimethylaminoethyl acrylate benzyl chloride quaternary salt (DMAEA-BCQ), 2-(methacryloyloxy)-N,N,N-trimethylethan-1-aminium methyl sulfate (DMAEMA-MSQ), 2-(acryloyloxy)-N,N,N-trimethylethanaminium chloride (DMAEA-MCQ), or a combination thereof.

According to some embodiments, the multiple charged cationic polymer is a compound according to any one of the structures:

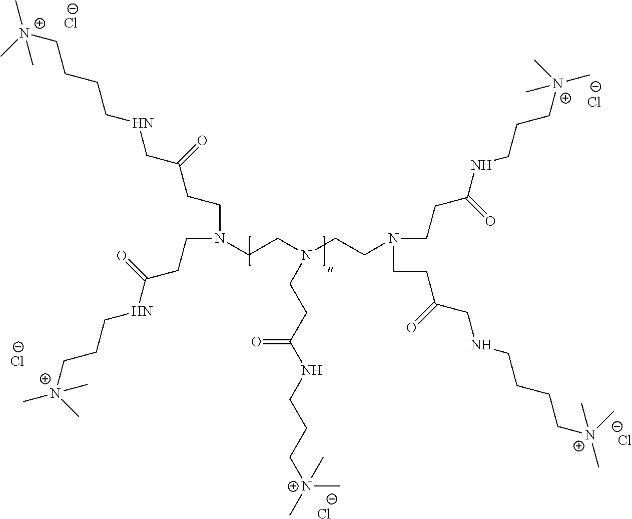

wherein n=0, 1, or 3;

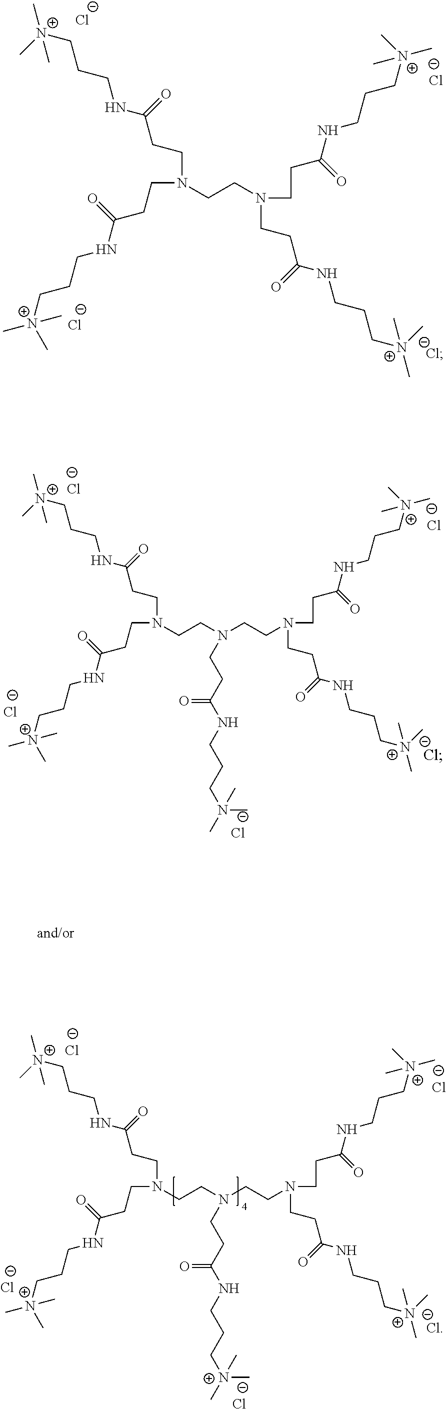

The disclosure also relates to methods of cleaning a textile comprising: contacting the textile with a composition comprising a multiple charged cationic polymer; depositing the composition on the textile; and removing soil from the textile.

In an embodiment, the multiple charged cationic polymer is a reaction product of a polyamine and a cationic monomer.

In a further embodiment, the polyamine is a linear polyamine according to the structure:

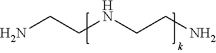

wherein k is an integer between 1 and 100.

In an embodiment, the polyamine is tetraethylenepentamine, pentaethylenehexamine, hexaethyleneheptamine, or diethylenetriamine.

In a further embodiment, the polyamine is a branched polyethylenimine according to the structure:

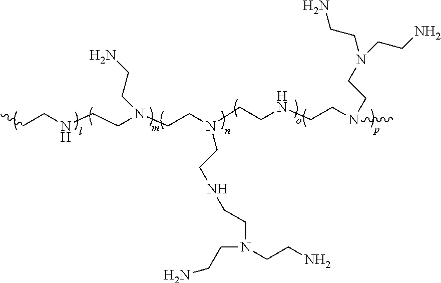

wherein l, m, n, o, or p is an integer of between 1 and 100.

In an embodiment, the cationic monomer is a monomer according to the structure:

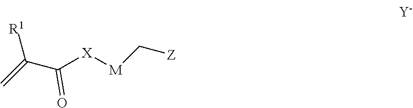

wherein R₁ is H, CH₃, or an unsubstituted, linear, or branched C₂-C₁₀ alkyl group; X is NH or O, M is absent or an unsubstituted, linear C₁-C₃₀ alkylene group; and Z is —NR₄R₅R₆(+) Y(−) wherein R₄, R₅, and R₆ are independently a C₁-C₁₀ alkyl group or a benzyl group, and Y is a halide or a methyl sulfate group.

In a further embodiment, the cationic monomer is (3-acrylamidopropyl)trimethylammonium chloride (APTAC), [3-(methacryloylamino)propyl]trimethylammonium chloride (MAPTAC), N,N-dimethylaminoethyl acrylate benzyl chloride quaternary salt (DMAEA-BCQ), 2-(methacryloyloxy)-N,N,N-trimethylethan-1-aminium methyl sulfate (DMAEMA-MSQ), 2-(acryloyloxy)-N,N,N-trimethylethanaminium chloride (DMAEA-MCQ), or a combination thereof.

According to some embodiments, the multiple charged cationic polymer is a compound according to the structure:

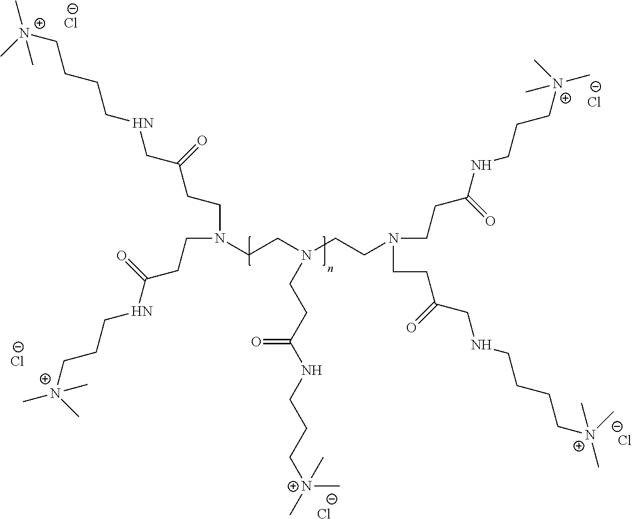

wherein n=0-1000.

In a further embodiment, the multiple charged cationic polymer is a compound according to the structures:

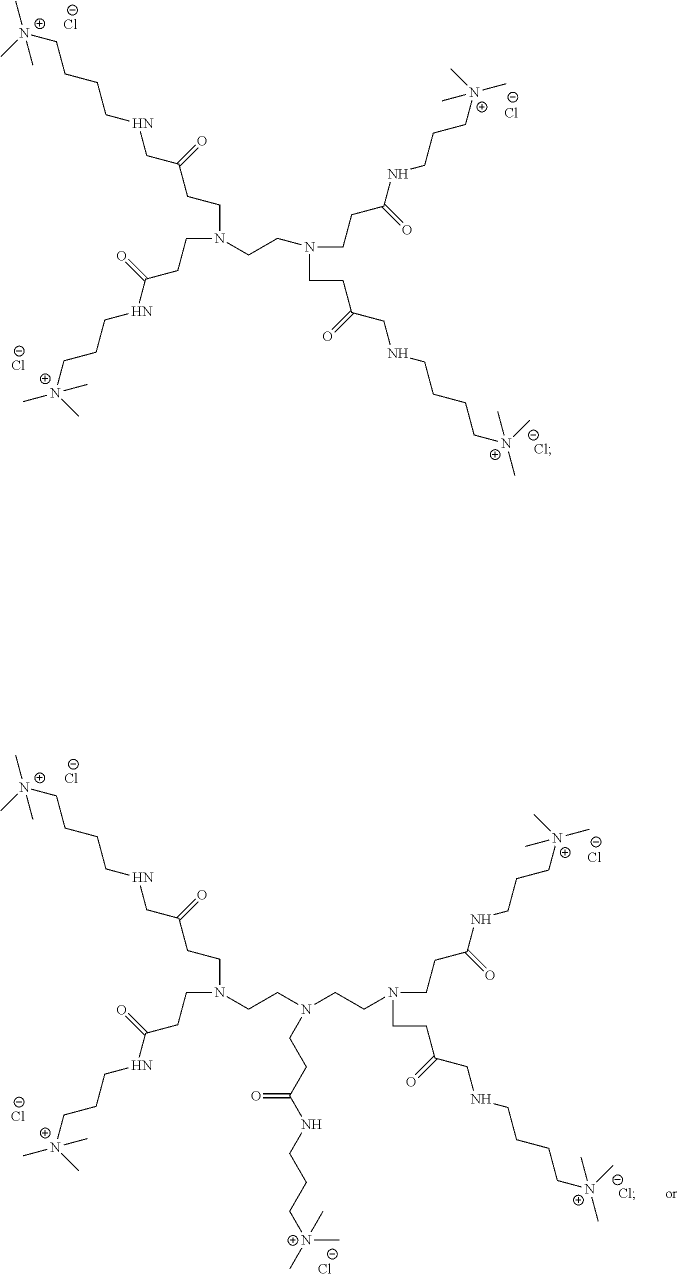

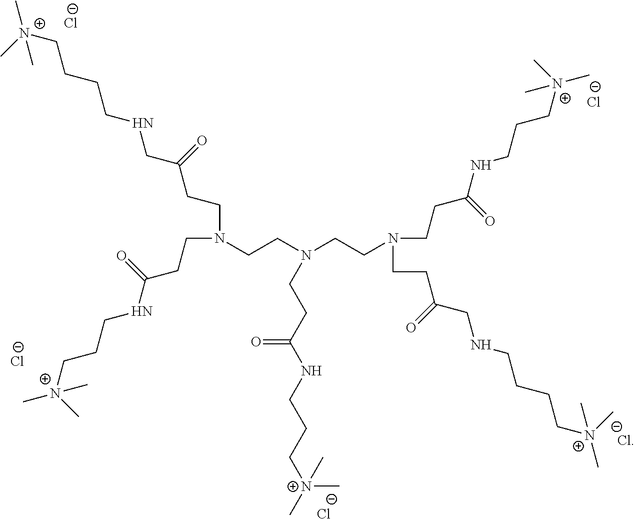

According to some embodiments, the composition further comprises a silicone compound. In an embodiment, the silicone compound is a compound according to the structure:

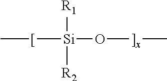

wherein each R₁ and R₂ are independently selected from a C₁-C₁₀ alkyl or alkenyl radical, phenyl, substituted alkyl, substituted phenyl, or units of —[—R₁R₂Si—O—]—; and x is a number from 50 to 300,000.

According to some embodiments, the composition further comprises an amine softening agent. In an embodiment, the amine softening agent is a triamine, an ether diamine, an aliphatic diamine, an ethoxylated amine, a branched amine surfactant, or a combination thereof. In a further embodiment, the amine softening agent is N-(3-aminopropyl)-N-dodecylpropane-1,3-diamine, N-(3-aminopropyl)-N-dodecylpropane-1,3-diamine, N, N-Bis (3-aminopropyl) dodecylamine, N1,N1,N3-tris(3-aminopropyl)-N3-dodecylpropane-1,3-diamine, N1,N1-bis(3-aminopropyl)-N3-dodecylpropane-1,3-diamine, N1-(3-aminopropyl)-N3-dodecylpropane-1,3-diamine, N-dodecylpropane-1,3-diamine, or a combination thereof.

In some embodiments, the composition further comprises an additional functional ingredient.

In an embodiment, the method of cleaning the textile occurs during a wash cycle. In some embodiments, the wash cycle comprises a pre-soak phase, a wash phase, a rinsing phase, a finishing phase, and an extraction phase. In a further embodiment, the composition is applied to the textile during the pre-soak phase. According to a further embodiment, the composition is applied to the textile during the finishing phase. In a still further embodiment, the composition is combined with a detergent composition and applied to the textile during the wash phase. In some embodiments, the detergent composition comprises an acrylic acid polymer, a stabilizing agent, and an alkalinity source. In a still further embodiment, the multiple charged cationic polymer is on the textile for more than one wash cycle. According to an embodiment, the depositing provides effective soil removal for more than one wash cycle.

Also disclosed herein are textile cleaning compositions comprising: a multiple charged cationic polymer; wherein the multiple charged cationic polymer is a reaction product of a polyamine and a cationic monomer.

In an embodiment, the reaction between the polyamine and the cationic monomer is aza-Michael addition.

In a further embodiment, the polyamine is a linear polyamine according to the structure:

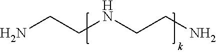

wherein k is an integer between 1 and 100.

In a still further embodiment, the polyamine is tetraethylenepentamine, pentaethylenehexamine, hexaethyleneheptamine, or diethylenetriamine.

According to an embodiment, the polyamine is a branched polyethylenimine according to the structure:

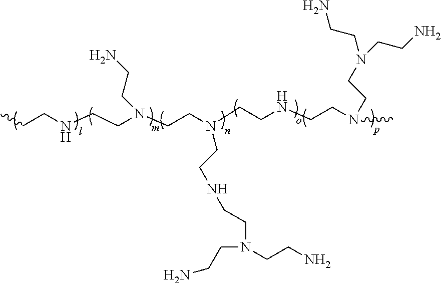

wherein l, m, n, o, or p is an integer of between 1 and 100.

In some embodiments, the cationic monomer is a monomer according to the structure:

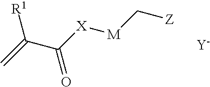

wherein R₁ is H, CH₃, or an unsubstituted, linear, or branched C₂-C₁₀ alkyl group; X is NH or O, M is absent or an unsubstituted, linear C₁-C₃₀ alkylene group; and Z is —NR₄R₅R₆(+) Y(−) wherein R₄, R₅, and R₆ are independently a C₁-C₁₀ alkyl group or a benzyl group, and Y is a halide or a methyl sulfate group.

In an embodiment, the cationic monomer is (3-acrylamidopropyl)trimethylammonium chloride (APTAC), [3-(methacryloylamino)propyl]trimethylammonium chloride (MAPTAC), N,N-dimethylaminoethyl acrylate benzyl chloride quaternary salt (DMAEA-BCQ), 2-(methacryloyloxy)-N,N,N-trimethylethan-1-aminium methyl sulfate (DMAEMA-MSQ), 2-(acryloyloxy)-N,N,N-trimethylethanaminium chloride (DMAEA-MCQ), or a combination thereof.

In a further embodiment, the multiple charged cationic polymer is a compound according to the structure.

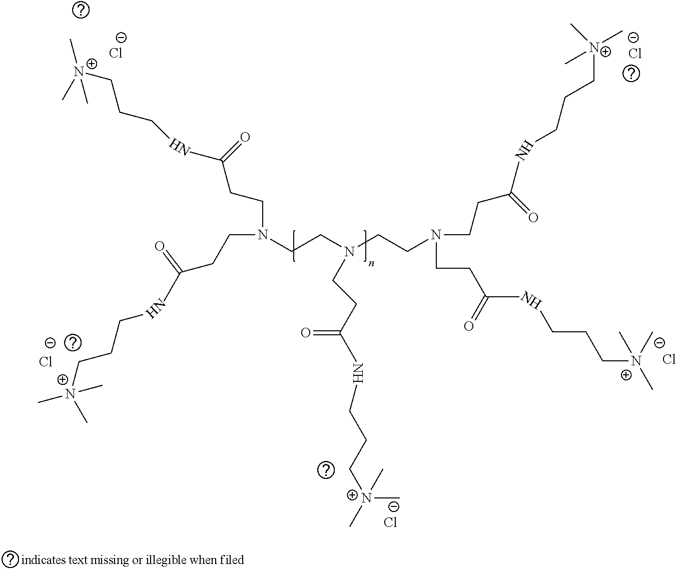

wherein n=0-1000.

In an embodiment, the multiple charged cationic polymer is a compound according to the structures:

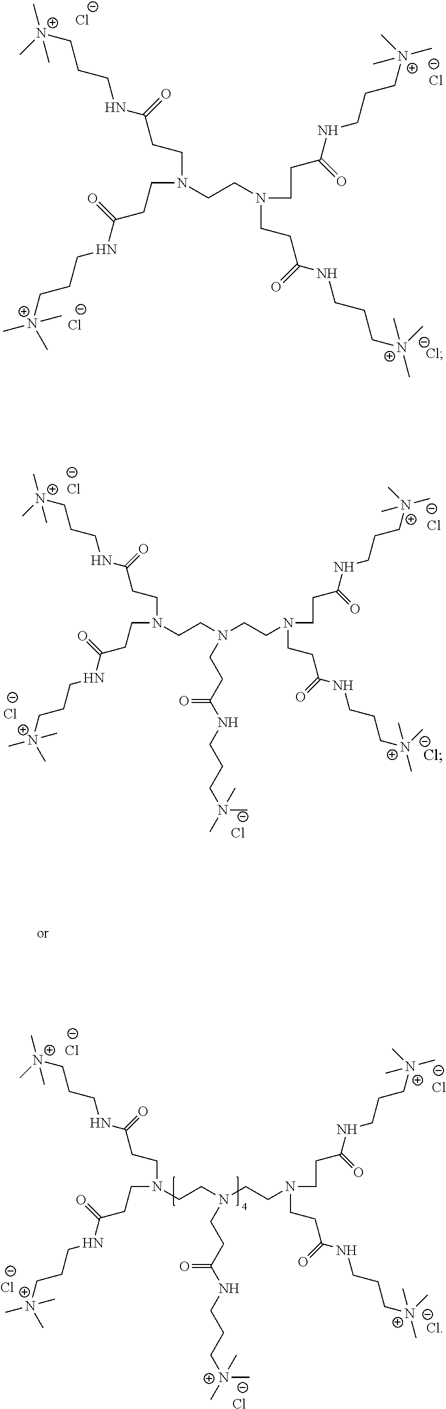

In some embodiments, the composition further comprises an silicone compound. According to an embodiment, the silicone compound is a compound according to the structure.

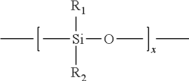

wherein each R₁ and R₂ are independently selected from a C₁-C₁₀ alkyl or alkenyl radical, phenyl, substituted alkyl, substituted phenyl, or units of —[—R₁R₂Si—O—]—; and x is a number from 50 to 300,000.

In some embodiments, the composition further comprises an amine softening agent. In an embodiment, the amine softening agent is a triamine, an ether diamine, an aliphatic diamine, an ethoxylated amine, a branched amine surfactant, or a combination thereof. In a still further embodiment, the amine softening agent is N-(3-aminopropyl)-N-dodecylpropane-1,3-diamine, N-(3-aminopropyl)-N-dodecylpropane-1,3-diamine, N, N-Bis (3-aminopropyl) dodecylamine, N1,N1,N3-tris(3-aminopropyl)-N3-dodecylpropane-1,3-diamine, N1,N1-bis(3-aminopropyl)-N3-dodecylpropane-1,3-diamine, N1-(3-aminopropyl)-N3-dodecylpropane-1,3-diamine, N-dodecylpropane-1,3-diamine, or a combination thereof.

According to some embodiments, the composition further comprises an additional functional ingredient.

Also disclosed herein are multiple charged cationic polymer forming compositions comprising: a first reagent comprising a polyamine; and a second reagent comprising a cationic monomer; wherein the first reagent and the second reagent are contacted to generate a multiple charged cationic polymer.

In an embodiment, the polyamine is a linear polyamine according to the structure:

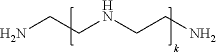

wherein k is an integer between 1 and 100.

According to an embodiment, the polyamine is tetraethylenepentamine, pentaethylenehexamine, hexaethyleneheptamine, or diethylenetriamine.

In some embodiments, the polyamine is a branched polyethylenimine according to the structure:

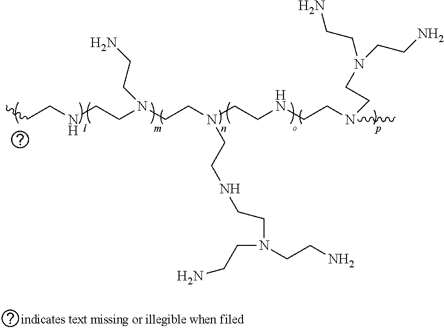

wherein l, m, n, o, or p is an integer of between 1 and 100.

In some embodiments, the cationic monomer is a monomer according to the structure:

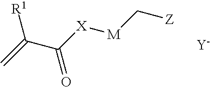

wherein R₁ is H, CH₃, or an unsubstituted, linear, or branched C₂-C₁₀ alkyl group; X is NH or O, M is absent or an unsubstituted, linear C₁-C₃₀ alkylene group; and Z is —NR₄R₅R₆(+) Y(−) wherein R₄, R₅, and R₆ are independently a C₁-C₁₀ alkyl group or a benzyl group, and Y is a halide or a methyl sulfate group.

In an embodiment, the cationic monomer is (3-acrylamidopropyl)trimethylammonium chloride (APTAC), [3-(methacryloylamino)propyl]trimethylammonium chloride (MAPTAC), N,N-dimethylaminoethyl acrylate benzyl chloride quaternary salt (DMAEA-BCQ), 2-(methacryloyloxy)-N,N,N-trimethylethan-1-aminium methyl sulfate (DMAEMA-MSQ), 2-(acryloyloxy)-N,N,N-trimethylethanaminium chloride (DMAEA-MCQ), or a combination thereof.

In a further embodiment, the multiple charged cationic polymer is a compound according to the structure:

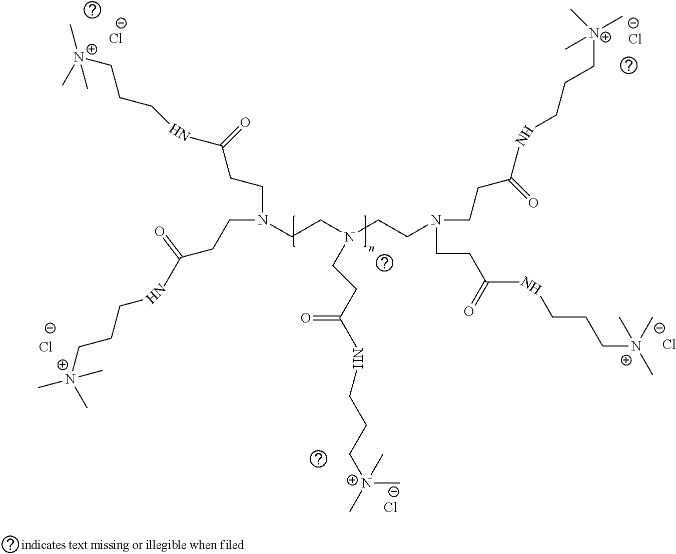

wherein n=0-1000.

In some embodiments, the multiple charged cationic polymer is a compound according to the structures:

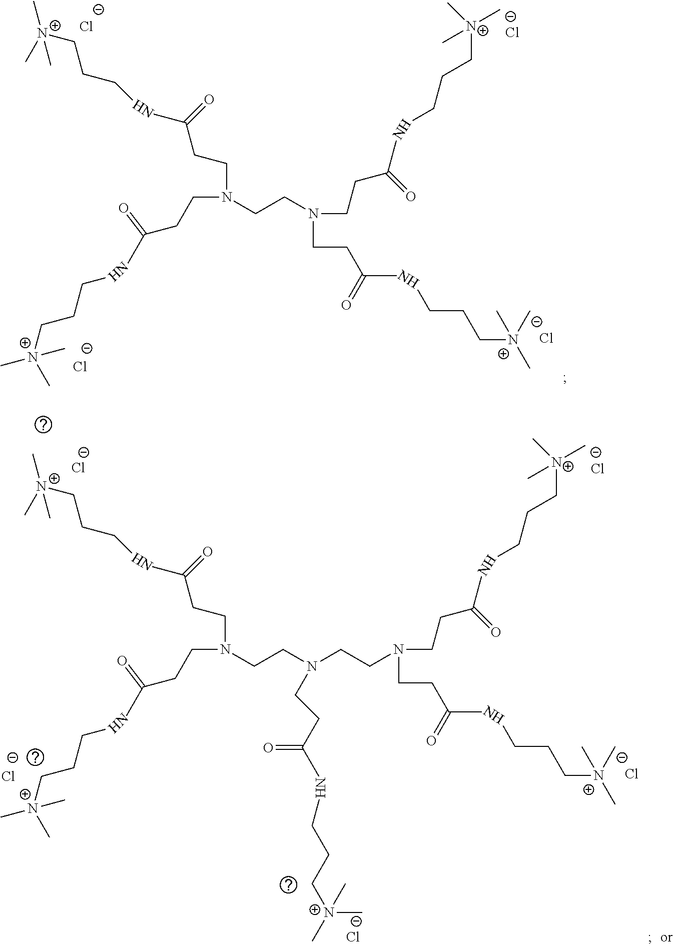

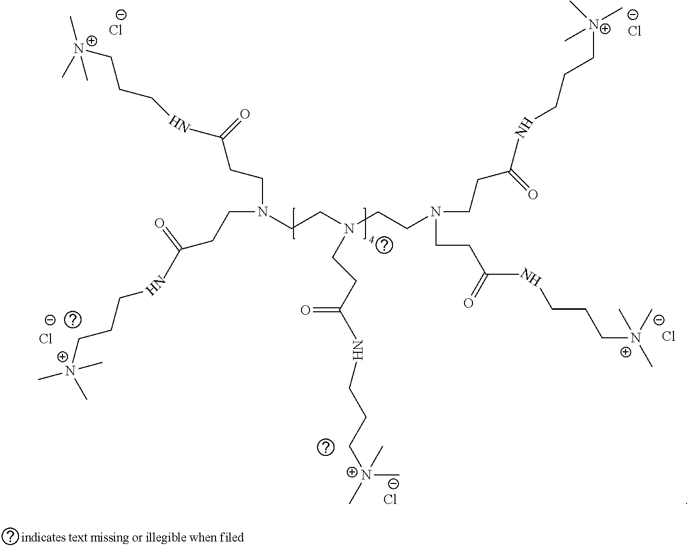

The forgoing summary is illustrative only and is not intended to be in any way limiting. In addition to the illustrative aspects, embodiments and features described above, further aspects, embodiments, and features of the present technology will become apparent to those skilled in the art from the following drawings and the detailed description, which shows and describes illustrative embodiments of the present technology. Accordingly, the figures and detailed description are also to be regarded as illustrative in nature and not in any way limiting.

### BRIEF DESCRIPTION OF DRAWINGS

FIG. 1 shows an exemplary generic reaction scheme to produce a multiple charged cationic polymer by an aza-Michael addition reaction between a linear polyamine and an activated olefin (α, β-unsaturated carbonyl compound) containing cationic group.

FIG. 2 shows an exemplary generic reaction scheme to produce a multiple charged cationic polymer by an aza-Michael addition reaction between a branched polyamine and an activated olefin (α, β-unsaturated carbonyl compound) containing cationic group.

FIG. 3 shows the soil removal efficacy of the multiple charged cationic polymers, both individually and together with a surfactant package.

Various embodiments of the present disclosure will be described in detail with reference to the drawings, wherein like reference numerals represent like parts throughout the several views. Reference to various embodiments does not limit the scope of the disclosure. Figures represented herein are not limitations to the various embodiments according to the disclosure and are presented for exemplary illustration of the disclosure.

### DETAILED DESCRIPTION OF THE PREFERRED EMBODIMENT

The present disclosure relates to compositions and methods for depositing a multiple charged cationic polymer onto the surface of textiles and cleaning said textiles. The cleaning methods and compositions have many advantages over existing deposition agents in cleaning compositions. For example, the depositions agents and compositions as a whole provide improved soil removal of cosmetic and oily soils. Further, the methods and compositions reduce the replacement rate of textiles caused by retained stains. This is beneficial for many reasons. For example, time and money spent seeking to remove the retained stains is reduced. Further, money is saved by reducing the necessary replacement of textiles. Additionally, it provides an environmental benefit by reducing waste of rejected linens.

The embodiments of this disclosure are not limited to particular types of compositions or methods, which can vary. It is further to be understood that all terminology used herein is for the purpose of describing particular embodiments only and is not intended to be limiting in any manner or scope. For example, as used in this specification and the appended claims, the singular forms “a,” “an” and “the” can include plural referents unless the content clearly indicates otherwise. Unless indicated otherwise, “or” can mean any one alone or any combination thereof, e.g., “A, B, or C” means the same as any of A alone, B alone, C alone, “A and B,” “A and C,” “B and C” or “A, B, and C.” Further, all units, prefixes, and symbols may be denoted in its SI accepted form.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure.

Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾ This applies regardless of the breadth of the range.

So that the present disclosure may be more readily understood, certain terms are first defined. Unless defined otherwise, all technical and scientific terms used herein have the same meaning as commonly understood by one of ordinary skill in the art to which embodiments of the disclosure pertain. Many methods and materials similar, modified, or equivalent to those described herein can be used in the practice of the embodiments of the present disclosure without undue experimentation, the preferred materials and methods are described herein. In describing and claiming the embodiments of the present disclosure, the following terminology will be used in accordance with the definitions set out below.

The term “about,” as used herein, refers to variation in the numerical quantity that can occur, for example, through typical measuring techniques and equipment, with respect to any quantifiable variable, including, but not limited to, mass, volume, time, temperature, pH, reflectance, whiteness, etc. Further, given solid and liquid handling procedures used in the real world, there is certain inadvertent error and variation that is likely through differences in the manufacture, source, or purity of the ingredients used to make the compositions or carry out the methods and the like. The term “about” also encompasses amounts that differ due to different equilibrium conditions for a composition resulting from a particular initial mixture. The term “about” also encompasses these variations. Whether or not modified by the term “about,” the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts.

The terms “dimensional stability” and “dimensionally stable” as used herein, refer to a solid composition having a growth exponent of less than about 3% in any dimension.

As used herein, the term “textile” refers to both unprocessed and processed fibers, strands, yarns, woven or knit fabrics, non-woven fabrics, garments, linens, laundry articles, and the like. Non-limiting examples of textile materials that can be treated with the compositions include absorbent towels, cloths, or wipes; laundry articles; linens; nylon; polyesters; leathers and the like. Textiles can include textiles for personal care products, industrial or cleaning applications and the like. Textiles may be re-usable or disposable.

The term “paper” as used herein refers to tissues, such as facial tissues and toilet tissues; papers, especially disposable papers including disposable napkins, paper towels, and personal care papers. Papers can be re-usable or disposable.

The term “laundry” refers to items or articles that are cleaned in a washing machine. In general, laundry refers to any item or article made from or including textiles such as woven fabrics, non-woven fabrics, and knitted fabrics. Frequently, the textile materials contain cotton fibers. The textile materials can comprise natural or synthetic fibers. Further, the textile materials can comprise additional non-cotton fibers such as silk fibers, linen fibers, polyester fibers, polyamide fibers including nylon, acrylic fibers, acetate fibers, and blends thereof including, but not limited, cotton and polyester blends. The fibers can be treated or untreated. Exemplary treated fibers include those treated for flame retardancy. It should be understood that the term “linen” is often used to describe certain types of laundry items including bed sheets, pillowcases, towels, table linen, tablecloth, bar mops and uniforms.

As used herein, the term “polymer” generally includes, but is not limited to, homopolymers, copolymers, such as for example, block, graft, random and alternating copolymers, terpolymers, and higher “x” mers, further including their derivatives, combinations, and blends thereof. Furthermore, unless otherwise specifically limited, the term “polymer” shall include all possible isomeric configurations of the molecule, including, but are not limited to isotactic, syndiotactic and random symmetries, and combinations thereof. Furthermore, unless otherwise specifically limited, the term “polymer” shall include all possible geometrical configurations of the molecule.

As used herein, a solid cleaning composition refers to a cleaning composition in the form of a solid such as a powder, a particle, an agglomerate, a flake, a granule, a pellet, a tablet, a lozenge, a puck, a briquette, a brick, a solid block, a unit dose, or another solid form known to those of skill in the art. The term “solid” refers to the state of the cleaning composition under the expected conditions of storage and use of the solid cleaning composition. In general, it is expected that the cleaning composition will remain in solid form when exposed to temperatures of up to about 100° F. and greater than about 120° F. A cast, pressed, or extruded “solid” may take any form including a block. When referring to a cast, pressed, or extruded solid it is meant that the hardened composition will not flow perceptibly and will substantially retain its shape under moderate stress or pressure or mere gravity, as for example, the shape of a mold when removed from the mold, the shape of an article as formed upon extrusion from an extruder, and the like. The degree of hardness of the solid cast composition can range from that of a fused solid block, which is relatively dense and hard, for example, like concrete, to a consistency characterized as being malleable and sponge-like, similar to caulking material. In embodiments of the disclosure, the solid compositions can be further diluted to prepare a use solution or added directly to a cleaning application, including, for example, a laundry machine.

As used herein, the term “substantially free” refers to compositions completely lacking the component or having such a small amount of the component that the component does not affect the performance of the composition. The component may be present as an impurity or as a contaminant and shall be less than 0.5 wt. %. In another embodiment, the amount of the component is less than 0.1 wt. % and in yet another embodiment, the amount of component is less than 0.01 wt. %.

As used herein the terms “use solution,” “ready to use,” or variations thereof refer to a composition that is diluted, for example, with water, to form a use composition having the desired components of active ingredients for cleaning. For reasons of economics, a concentrate can be marketed, and an end user can dilute the concentrate with water or an aqueous diluent to a use solution.

The term “weight percent,” “wt. %,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt. %,” etc.

As used herein, the term “antiredeposition” or “antiredeposition agent” refers to a compound that helps keep soil suspended in water instead of redepositing onto the article being cleaned. Antiredeposition agents are useful in reducing redepositing of the removed soil onto the surface being cleaned.

As used herein, the term “cleaning” refers to a method used to facilitate, or a composition used in, soil removal, bleaching, microbial population reduction, rinsing, pre-treating, post-treating, or any combination thereof.

The term “multiple charged cationic polymer composition” is used herein to refer to a composition comprising only one or more multiple charged cationic polymers and one or more additional function ingredients; and also, compositions comprising one or more multiple charged cationic polymers, a detergent composition, and one or more additional functional ingredients.

As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism.

The term “substantially similar cleaning performance” refers generally to achievement by a substitute cleaning product or substitute cleaning system of generally the same degree (or at least not a significantly lesser degree) of cleanliness or with generally the same expenditure (or at least not a significantly lesser expenditure) of effort, or both.

The term “commercially acceptable cleaning performance” refers generally to the degree of cleanliness, extent of effort, or both that a typical consumer would expect to achieve or expend when using a cleaning product or cleaning system to address a typical soiling condition on a typical substrate. This degree of cleanliness may, depending on the particular cleaning product and particular substrate, correspond to a general absence of visible soils, or to some lesser degree of cleanliness. Cleanliness may be evaluated in a variety of ways depending on the particular cleaning product being used (e.g., textile detergent) and the particular hard or soft surface being cleaned (e.g., textile, fabric, and the like), and normally may be determined using generally agreed industry standard tests or localized variations of such tests. In the absence of such agreed industry standard tests, cleanliness may be evaluated using the test or tests already employed by a manufacturer or seller to evaluate the cleaning performance of its phosphorus-containing cleaning products sold in association with its brand.

As used herein, the term “soil” refers to polar or non-polar organic or inorganic substances including, but not limited to carbohydrates, proteins, fats, oils and the like which may or may not contain particulate matter such as mineral clays, sand, natural mineral matter, carbon black, graphite, kaolin, environmental dust, colorant, dyes, polymers, and oils. These substances may be present in their organic state or complexed to a metal to form an inorganic complex. The terms “soil” and “stain” include, but are not limited to, cosmetic and oil-based stains.

As used herein, “substituted” refers to an organic group as defined below (e.g., an alkyl group) in which one or more bonds to a hydrogen atom contained therein are replaced by a bond to non-hydrogen or non-carbon atoms. Substituted groups also include groups in which one or more bonds to carbon(s) or hydrogen(s) atom replaced by one or more bonds, including double or triple bonds, to a heteroatom. Thus, a substituted group is substituted with one or more substituents, unless otherwise specified. A substituted group can be substituted with 1, 2, 3, 4, 5, or 6 substituents.

Substituted ring groups include rings and ring systems in which a bond to a hydrogen atom is replaced with a bond to a carbon atom. Therefore, substituted cycloalkyl, aryl, heterocyclic, and heteroaryl groups may also be substituted with substituted or unsubstituted alkyl, alkenyl, and alkynyl groups are defined herein.

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups).

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

Alkenyl groups or alkenes are straight chain, branched, or cyclic alkyl groups having two to about 30 carbon atoms, and further including at least one double bond. In some embodiments, an alkenyl group has from 2 to about 30 carbon atoms, or typically, from 2 to 10 carbon atoms. Alkenyl groups may be substituted or unsubstituted. For a double bond in an alkenyl group, the configuration for the double bond can be a trans or cis configuration. Alkenyl groups may be substituted similarly to alkyl groups.

Alkynyl groups are straight chain, branched, or cyclic alkyl groups having two to about 30 carbon atoms, and further including at least one triple bond. In some embodiments, an alkynyl group has from 2 to about 30 carbon atoms, or typically, from 2 to 10 carbon atoms. Alkynyl groups may be substituted or unsubstituted. Alkynyl groups may be substituted similarly to alkyl or alkenyl groups.

As used herein, the terms “alkylene”, “cycloalkylene”, “alkynylides”, and “alkenylene”, alone or as part of another substituent, refer to a divalent radical derived from an alkyl, cycloalkyl, or alkenyl group, respectively, as exemplified by —CH₂CH₂CH₂—. For alkylene, cycloalkylene, alkynylene, and alkenylene groups, no orientation of the linking group is implied.

The term “ester” as used herein refers to —R³⁰COOR³¹ group. R³⁰ is absent, a substituted or unsubstituted alkylene, cycloalkylene, alkenylene, alkynylene, arylene, aralkylene, heterocyclylalkylene, or heterocyclylene group as defined herein. R³¹ is a substituted or unsubstituted alkyl, cycloalkyl, alkenyl, alkynyl, aryl, aralkyl, heterocyclylalkyl, or heterocyclyl group as defined herein.

The term “amine” (or “amino”) as used herein refers to —R³²NR³³R³⁴ groups. R³² is absent, a substituted or unsubstituted alkylene, cycloalkylene, alkenylene, alkynylene, arylene, aralkylene, heterocyclylalkylene, or heterocyclylene group as defined herein. R³³ and R³⁴ are independently hydrogen, or a substituted or unsubstituted alkyl, cycloalkyl, alkenyl, alkynyl, aryl, aralkyl, heterocyclylalkyl, or heterocyclyl group as defined herein.

The term “amine” as used herein also refers to an independent compound. When an amine is a compound, it can be represented by a formula of R^{32′}NR^{33′}R^{34′} groups, wherein R^{32′}, R^{33′}, and R³⁴ are independently hydrogen, or a substituted or unsubstituted alkyl, cycloalkyl, alkenyl, alkynyl, aryl, aralkyl, heterocyclylalkyl, or heterocyclyl group as defined herein.

The term “alcohol” as used herein refers to —R³⁵OH groups. R³⁵ is absent, a substituted or unsubstituted alkylene, cycloalkylene, alkenylene, alkynylene, arylene, aralkylene, heterocyclylalkylene, or heterocyclylene group as defined herein.

The term “carboxylic acid” as used herein refers to —R³⁶COOH groups. R³⁶ is absent, a substituted or unsubstituted alkylene, cycloalkylene, alkenylene, alkynylene, arylene, aralkylene, heterocyclylalkylene, or heterocyclylene group as defined herein.

The term “ether” as used herein refers to —R³⁷OR³⁸ groups. R³⁷ is absent, a substituted or unsubstituted alkylene, cycloalkylene, alkenylene, alkynylene, arylene, aralkylene, heterocyclylalkylene, or heterocyclylene group as defined herein. R³⁸ is a substituted or unsubstituted alkyl, cycloalkyl, alkenyl, alkynyl, aryl, aralkyl, heterocyclylalkyl, or heterocyclyl group as defined herein.

The term “solvent” as used herein refers to any inorganic or organic solvent. Solvents are useful in the disclosed method or composition as reaction solvents or carrier solvents. Suitable solvents include, but are not limited to, oxygenated solvents such as lower alkanols, lower alkyl ethers, glycols, aryl glycol ethers and lower alkyl glycol ethers. Examples of other solvents include, but are not limited to, methanol, ethanol, propanol, isopropanol and butanol, isobutanol, ethylene glycol, diethylene glycol, triethylene glycol, propylene glycol, dipropylene glycol, glycol ethers, mixed ethylene-propylene glycol ethers, ethylene glycol phenyl ether, and propylene glycol phenyl ether. Water is a solvent too. The solvent used herein can be of a single solvent or a mixture of many different solvents.

Glycol ethers include, but are not limited to, diethylene glycol n-butyl ether, diethylene glycol n-propyl ether, diethylene glycol ethyl ether, diethylene glycol methyl ether, diethylene glycol t-butyl ether, dipropylene glycol n-butyl ether, dipropylene glycol methyl ether, dipropylene glycol ethyl ether, dipropylene glycol propyl ether, dipropylene glycol tert-butyl ether, ethylene glycol butyl ether, ethylene glycol propyl ether, ethylene glycol ethyl ether, ethylene glycol methyl ether, ethylene glycol methyl ether acetate, propylene glycol n-butyl ether, propylene glycol ethyl ether, propylene glycol methyl ether, propylene glycol n-propyl ether, tripropylene glycol methyl ether and tripropylene glycol n-butyl ether, ethylene glycol phenyl ether, propylene glycol phenyl ether, and the like, or a combination thereof.

The methods, systems, apparatuses, and compositions disclosed herein may comprise, consist essentially of, or consist of the components and ingredients described herein as well as other ingredients not described herein. As used herein, “consisting essentially of” means that the methods, systems, apparatuses and compositions may include additional steps, components or ingredients, but only if the additional steps, components or ingredients do not materially alter the basic and novel characteristics of the claimed methods, systems, apparatuses, and compositions.

It should also be noted that, as used in this specification and the appended claims, the term “configured” describes a system, apparatus, or other structure that is constructed or configured to perform a particular task or adopt a particular configuration. The term “configured” can be used interchangeably with other similar phrases such as arranged and configured, constructed and arranged, adapted and configured, adapted, constructed, manufactured and arranged, and the like.

Compositions

Exemplary ranges of the compositions are shown in Table 1 below in weight percentage of the solid or liquid compositions, including both concentrate and ready-to-use compositions.

TABLE 1
Multiple Charged Cationic Polymer and Surfactant Package

| | First | Second | Third | Fourth |
|---|---|---|---|---|
| | Exemplary | Exemplary | Exemplary | Exemplary |
| | Range | Range | Range | Range |
| Material | wt. % | wt. % | wt. % | wt. % |
| Multiple Charged | 0.0001-25 | 0.05-10 | 0.05-5 | 0.1-2 |
| Cationic Polymer | | | | |
| Silicone Compound | 0-99 | 0-80 | 0-60 | 0-20 |
| Cationic Amine | 0-50 | 0-30 | 0-20 | 0-10 |
| One or More | 5-99 | 15-90 | 45-90 | 55-80 |
| Surfactants | | | | |
| Additional Functional | 0-25 | 0-20 | 0-10 | 0-5 |
| Ingredients | | | | |

In some instances, the multiple charged cationic polymer compositions of Table 1 are combined with a cleaning composition, for example a textile detergent. This base detergent composition will generally include one or more alkalinity sources and surfactants to facilitate soil removal and optionally one or more builders or chelating agents to prevent scale formation or combat hard water conditions. An example of a suitable base detergent composition is provided in Table 2 below. The multiple charged cationic polymer composition, when combined with a detergent, is generally referred to herein as a “cleaning composition,” a “textile cleaning composition” or a “detergent composition.”

TABLE 2
Detergent Composition

| | First | Second | Third |
|---|---|---|---|
| | Exemplary | Exemplary | Exemplary |
| Material | Range wt. % | Range wt. % | Range wt. % |
| Acrylic Acid | 0.1-15 | 0.1-10 | 1-10 |
| Polymer | | | |
| One or More | 10-99 | 20-90 | 50-90 |
| Surfactants | | | |
| Additional | 0.1-15 | 1-10 | 1-5 |
| Polymer(s) | | | |
| Stabilizing Agents | 1-50 | 5-50 | 10-50 |
| (e.g., solvents) | | | |
| Alkalinity Source | 0-99 | 0-95 | 0-90 |

The compositions can be provided in liquid, solid, paste, or gel forms used as part of a prewash, main wash, souring step, or other step(s). The liquid compositions or may be diluted to form use compositions, as well as ready-to-use compositions. In general, a concentrate refers to a composition that is intended to be diluted with water to provide a use solution that contacts an object to provide the desired cleaning, rinsing, or the like. The cleaning composition that contacts the articles to be washed can be referred to as a concentrate or a use composition (or use solution) dependent upon the formulation employed in methods. It should be understood that the concentration of the cationic amine compound and other components will vary depending on whether the cleaning composition is provided as a concentrate or as a use solution.

A use solution may be prepared from the concentrate by diluting the concentrate with water at a dilution ratio that provides a use solution having desired detersive properties. The water that is used to dilute the concentrate to form the use composition can be referred to as water of dilution or a diluent and can vary from one location to another. The typical dilution factor is between approximately 1 and approximately 10,000 but will depend on factors including water hardness, the amount of soil to be removed and the like. In an embodiment, the concentrate is diluted at a ratio of between about 1:10 and about 1:10,000 concentrate to water, inclusive of all integers with this range, e.g., 1:50, 1:100, 1:1,000, and the like. Particularly, the concentrate is diluted at a ratio of between about 1:100 and about 1:5,000 concentrate to water.

If the textile cleaning composition is a solid, it may be in various forms including, but not limited to, a powder, a flake, a granule, a pellet, a tablet, a lozenge, a puck, a briquette, a brick, a solid block, or a unit dose. Moreover, the methods can include one or more of the following: a prewash cleaning composition, a main wash cleaning composition, pretreatment compositions (including but not limited to soaks and sprays.

As described above, the potential cleaning steps employed in the methods described herein can comprise a variety of ingredients. Those ingredients can be formulated into liquid or solid cleaning compositions or individually dosed. Those ingredients can include, but are not limited to, an alkalinity source, a builder/chelating agent, defoamer, enzyme, enzyme stabilizing agent, polymer, surfactant, and whitening agent. The cleaning compositions can further include the colorants, fragrances, solidification agents, and water as described above. It should be understood that the compositions shown in Tables 1-3 are only exemplary and that the methods and compositions disclosed herein can be used in conjunction with any cleaning compositions.

Polyamines/Polyethylenimines

A polyamine can have, but is limited to, a generic formula of NH₂—[R^{10′}]ₙ—NH₂, (RNH)ₙ—RNH₂, H₂N—(RNH)ₙ—RNH₂, or H₂N—(RN(R′))ₙ—RNH₂, wherein R^{10′} is a linear or branched, unsubstituted or substituted C₂-C₁₀ alkylene group, or combination thereof; R is —CH₂—, —CH₂CH₂—, —CH₂CH₂CH₂—, —CH(CH₃)CH₂—, a linear or branched, unsubstituted or substituted C₄-C₁₀ alkylene group, or combination thereof, R′ is —CH₂—, —CH₂CH₂—, —CH₂CH₂CH₂—, —CH(CH₃)CH₂—, a linear or branched, unsubstituted or substituted C₄-C₁₀ alkyl group, RNH₂, RNHRNH₂, or RN(RNH₂)₂; and n can be from 2 to 1,000,000. The monomer in a polyamine, e.g., the R or R′ group, can be the same or different. In this disclosure, a polyamine refers to both small molecule polyamine when n is from 1 to 9 and polymeric polyamine when n is from 10 to 1,000,000.

Small molecule polyamines include, but are not limited to ethylenediamine, diethylenetriamine, triethylenetetramine, tetraethylenepentamine, pentaethylenehexamine, hexaethyleneheptamine, and tris(2-aminoethyl)amine.

Other possible polyamines include JEFFAMINE® monoamines, diamines, and triamines by Huntsman. These highly versatile products contain primary amino groups attached to the end of a polyether backbone normally based on propylene oxide (PO), ethylene oxide (EO), or a mixture of both oxides. JEFFAMINE® amines include a polyetheramine family consisted of monoamines, diamines and triamines based on the core polyether backbone structure. JEFFAMINE® amines also include high-conversion, and polytetramethylene glycol (PTMEG) based polyetheramines. These JEFFAMINE® amines have an average molecular weight (M_{w}) of from about 130 to about 4,000.

A polyamine used in this disclosure can a polyamine derivative or modified polyamine, in which one or more of the NH protons, but not all, in the polyamine is substituted by an unsubstituted or substituted group. For example, an alkyl polyamine that contains one or more alkyl group connected to the nitrogen atom can be used to produce the multiple charged cationic polymers disclosed herein. In these PEI derivatives, only some of primary NH₂ or secondary NH protons are replaced by other non-proton groups and the remaining NH₂ or NH protons can still react with a Michael acceptor, such as an activated olefin containing a hydrophilic (ionic) group, by an aza-Michael Addition reaction.

One class of the polymeric polyamine includes polyethylenimine (PEI) and its derivatives. Polyethylenimine (PEI) or polyaziridine is a polymer with a repeating unit of CH₂CH₂NH and has a general formulation of NH₂(CH₂CH₂NH)ₙ—CH₂CH₂NH₂, wherein n can be from 2 to 10⁵. The repeating monomer in PEI has a molecular weight of 43.07 and a nitrogen to carbon ratio of 1:2.

PEIs and their derivatives can linear, branched, or dendric. Linear polyethylenimines contain all secondary amines, in contrast to branched PEIs which contain primary, secondary and tertiary amino groups. Totally branched, dendrimeric forms also exist and contain primary and tertiary amino groups. Drawings for unmodified linear, branched, and dendrimeric PEI are shown below

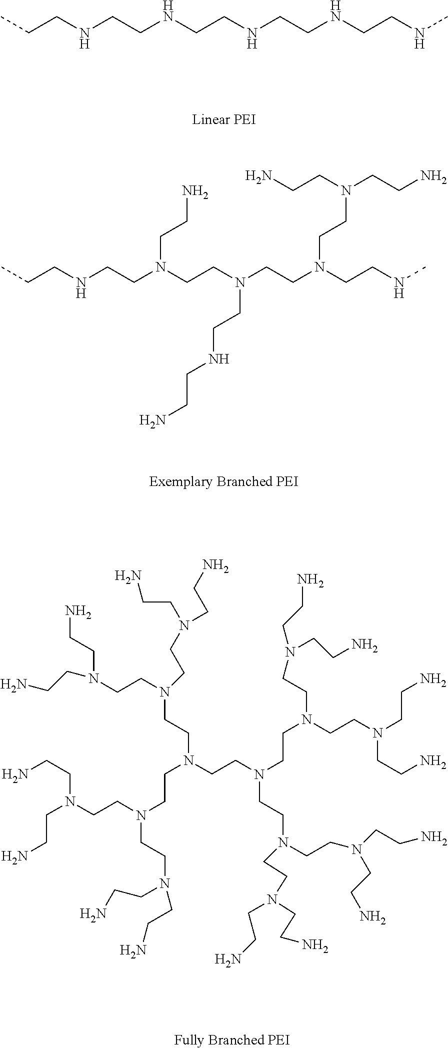

PEI derivatives are usually obtained by substituting proton(s) on the nitrogen atoms with different group. One such PEI derivative is ethoxylated and propoxylated PEI, wherein the polyethylenimines are derivatized with ethylene oxide (EO) or propylene oxide (PO) side chains. Ethoxylation of PEIs can increase the solubility of PEIs.

PEI is produced on industrial scale. Various commercial polyethylenimines are available, including for example those sold under the tradename Lupasol® (BASF), including for example Lupasol® FG, Lupasol® G, Lupasol® PR 8515, Lupasol® WF, Lupasol® G 20/35/100, Lupasol® HF, Lupasol® P, Lupasol® PS, Lupasol® PO 100, Lupasol® PN 50/60, and Lupasol® SK. These PEIs have average molecular weights (M_{w}) of about 800, about 1,300, about 2,000, about 5,000, about 25,000, about 1,300/2,000/5,000, about 25,000, about 750,000, about 750,000, about 1,000,000, and about 2,000,000, respectively.

Two commonly used averages for molecular weight of a polymer are number average molecular weight (Ma) and weight average molecular weight (M_{w}). The polydispersity index (D) represents the molecular weight distribution of the polymers. Mn=(ΣnᵢMᵢ)/Σnᵢ, M_{w}=(ΣnᵢMᵢ²)/ΣnᵢMᵢ, and D=M_{w}/Mₙ, wherein the index number, i, represents the number of different molecular weights present in the sample and nᵢ is the total number of moles with the molar mass of Mᵢ. For a polymer, Mₙ and M_{w} are usually different. For example, a PEI compound can have a Mₙ of about 10,000 by GPC and M_{w} of about 25,000 by LS.

Light Scattering (LS) can be used to measure M_{w} of a polymer sample. Another easy way to measure molecular weight of a sample or product is gel permeation chromatography (GPC). GPC is an analytical technique that separates molecules in polymers by size and provides the molecular weight distribution of a material. GPC is also sometimes known as size exclusion chromatography (SEC). This technique is often used for the analysis of polymers for their both Mₙ and M_{w}.

These commercially available and exemplary polyethylenimines are soluble in water and available as anhydrous polyethylenimines or modified polyethylenimines provided in aqueous solutions or methoxy propanol (as for Lupasol® PO 100).

Suitable polyethylenimine useful in the present disclosure may contain a mixture of primary, secondary, and tertiary amine substituents or mixture of different average molecular weights. The mixture of primary, secondary, and tertiary amine substituents may be in any ratio, including for example in the ratio of about 1:1:1 to about 1:2:1 with branching every 3 to 3.5 nitrogen atoms along a chain segment. Alternatively, suitable polyethylenimine compounds may be primarily one of primary, secondary or tertiary amine substituents.

The polyamine that can be used to make the multiple charged cationic polymers disclosed herein can have a wide range of its average molecular weight. Different multiple charged cationic polymers with their characteristic average molecular weights can be produced by selecting different starting small molecule polyamines, polymeric PEIs, or a combination thereof. Controlling the size of polyamines or PEI and extent of modification by the activated olefin containing ionic groups, one can produce the multiple charged cationic polymers with a similar average molecular weight and multiple cationic charges or multiple anionic charges. Because of this character, one can produce and use different multiple charged cationic polymers for a wider range of applications that are using unmodified polyamine or PEIs.

Specifically, the polyamines that can be used to make the multiple charged cationic polymers disclosed here have an average molecular weight (M_{w}) of about 60-200, about 100-400, about 100-600, about 600-5,000, about 600-800, about 800-2,000, about 800-5,000, about 100-2,000,000, about 100-25,000, about 600-25,000, about 800-25,000, about 600-750,000, about 800-750,000, about 25,000-750,000, about 750,000-2,000,000, about 100, about 200, about 300, about 400, about 500, about 600, about 700, about 800, about 1,000, about 1,500, about 2,000, about 3,000, about 5,000, about 8,000, about 10,000, about 15,000, about 20,000, about 50,000, about 100,000, about 250,000, about 500,000, about 1,000,000, 2,000,000, or any value there between.

Activated Olefins

As used herein, an “activated olefin” refers to a substituted alkene in which at least one of the double-bond carbon has a conjugated electron withdrawing group. More broadly, it is a compound containing at least one carbon-carbon double bond, wherein the double bond is activated by some reaction, e.g., Wacker process, olefin metathesis, olefin hydroformylation, and the like, such that there is an electron-withdrawing group (EWG) directly attached to the double bond. Activated olefins are a preferred Michael Acceptor, although examples of suitable Michael acceptors include, but are not restricted to, acrylate esters, alkyl methacrylates, acrylonitrile, acrylamides, maleimides, cyanoacrylates and vinyl sulfones, vinyl ketones, nitro ethylenes, α, β-unsaturated aldehydes, vinyl phosphonates, acrylonitrile, vinyl pyridines, azo compounds, beta-keto acetylenes and acetylene esters.

In an embodiment, the activated olefin may have an ionic group according to the following formulas:

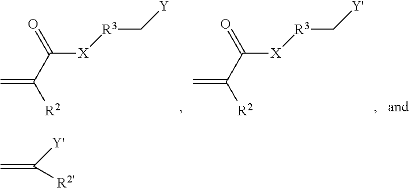

wherein X is NH or O; R² is H, CH₃, or an unsubstituted, linear or branched C₂-C₁₀ alkyl, alkenyl, or alkynyl group; R^{2′} is H, CH₃, or an unsubstituted or substituted, linear or branched C₁-C₁₀ alkyl, alkenyl, alkynyl group, —COOH, —CH₂COOH, Y′, or —(CH₂)ₘ—Y′; m is an integer of 2 to 4; R³ is absent or an unsubstituted, linear or branched C₁-C₃₀ alkylene group; Y is —NR₄R₅R₆⁽⁺⁾, Y′ is —COOH, —SO₃H, —PO₃H, —OSO₃H, —OPO₃H, or a salt thereof, and R⁴, R⁵, and R⁶ are independently a C₁-C₁₀ alkyl group; wherein the polyamine and the activated olefin undergo aza-Michael addition reaction; and the compound is a multiple charged cationic polymer having 2 or more positive charges or multiple charged anionic compound having 2 or more negative charges.

In some embodiments of the disclosed methods, the polyamine is a NH₂—[R^{10′}]ₙ—NH₂, (RNH)ₙ—RNH₂, H₂N—(RNH)ₙ—RNH₂, H₂N—(RN(R′))ₙ—RNH₂, or a combination thereof, wherein R^{10′} is a linear or branched, unsubstituted or substituted C₂-C₁₀ alkylene group, or combination thereof, R is —CH₂—, —CH₂CH₂—, —CH₂CH₂CH₂—, —CH(CH₃)CH₂—, a linear or branched, unsubstituted or substituted C₄-C₁₀ alkylene group, or combination thereof, R′ is —CH₂—, —CH₂CH₂—, —CH₂CH₂CH₂—, —CH(CH₃)CH₂—, a linear or branched, unsubstituted or substituted C₄-C₁₀ alkyl group, RNH₂, RNHRNH₂, or RN(RNH₂)₂ and n can be from 2 to 1,000,000.

In other embodiments, the activated olefin is

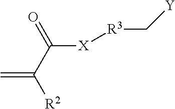

wherein X is NH or O; R² is H, CH₃, or an unsubstituted, linear or branched C₂-C₁₀ alkyl, alkenyl, or alkynyl group; R³ is absent or an unsubstituted, linear or branched C₁-C₃₀ alkylene group; Y is —NR₄R₅R₆⁽⁺⁾, and R⁴, R⁵, and R⁶ are independently a C₁-C₁₀ alkyl group

In some embodiments, the activated olefin activated olefin is (3-acrylamidopropyl)trimethylammonium chloride (APTAC), [3-(methacryloylamino)propyl]trimethylammonium chloride (MAPTAC), N,N-dimethylaminoethyl acrylate benzyl chloride quaternary salt (DMAEA-BCQ), 2-(methacryloyloxy)-N,N,N-trimethylethan-1-aminium methyl sulfate (DMAEMA-MSQ), 2-(acryloyloxy)-N,N,N-trimethylethanaminium chloride (DMAEA-MCQ), or a combination thereof.

In some embodiments, Y is —NR₄R₅R₆⁽⁺⁾ and the counter ion for Y any negative charged ion or species. In some other embodiments, the counter ion for Y is chloride, bromide, fluoride, iodide, acetate, aluminate, cyanate, cyanide, dihydrogen phosphate, dihydrogen phosphite, formate, carbonate, hydrogen carbonate, hydrogen oxalate, hydrogen sulfate, hydroxide, nitrate, nitrite, thiocyanate, or a combination thereof.

In some embodiments of the disclosed methods, the activated olefin is

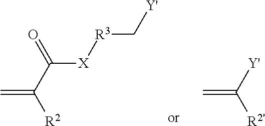

wherein X is NH or O; R² is H, CH₃, or an unsubstituted, linear or branched C₂-C₁₀ alkyl, alkenyl, or alkynyl group; R^{2′} is H, CH₃, or an unsubstituted or substituted, linear or branched C₁-C₁₀ alkyl, alkenyl, alkynyl group, —COOH, —CH₂COOH, Y′, or —(CH₂)ₘ—Y′; m is an integer of 2 to 4; R³ is absent or an unsubstituted, linear or branched C₁-C₃₀ alkylene group; Y′ is —COOH, —SO₃H, —PO₃H, —OSO₃H, —OPO₃H, or a salt thereof, and R⁴, R⁵, and R⁶ are independently a C₁-C₁₀ alkyl group.

In some embodiments, the activated olefin is acrylic acid, methacrylic acid, itaconic acid, maleic acid, vinylsulfonic acid, vinylphosphonic acid, or a combination thereof.

In some other embodiments, the activated olefin is 2-acrylamido-2-methylpropane sulfonic acid (AMPS), 3-(allyloxy)-2-hydroxypropane-1-sulfonate, or a combination thereof.

In yet some other embodiments, when the activated olefin contains anionic group that can bear negative charge at an alkaline pH, the counter positive ions for the negative charges include, but are not limited to, alkali metal ions, Li⁺, Na⁺, K⁺, NH₄⁺, a quaternary ammonium ion, etc.

Further examples of suitable activated olefins include, but not limited to, α, β-unsaturated carbonyl compounds (such as CH₂═CHCO—NH—CH₃, alkyl-CH═CH—CO-alkyl, CH₂═CH₂C(O)—O—CH₃), CH₂═CH—COOH, CH₂═CH(CH₃)—COOH, CH₂═CH—SO₃H, and like. Preferably, the activated olefin is a α, β-unsaturated carbonyl compound containing substituted alkyl trialkyl quaternary ammonium salts.

More particularly, in some embodiments, the activated olefin is (3-acrylamidopropyl)trimethylammonium chloride (APTAC), [3-(methacryloylamino)propyl]trimethylammonium chloride (MAPTAC), N,N-dimethylaminoethyl acrylate benzyl chloride quaternary salt (DMAEA-BCQ), 2-(methacryloyloxy)-N,N,N-trimethylethan-1-aminium methyl sulfate (DMAEMA-MSQ), or 2-(acryloyloxy)-N,N,N-trimethylethanaminium chloride (DMAEA-MCQ).

In other embodiments, the activated olefin is (3-acrylamidopropyl)trimethylammonium chloride (APTAC), [3-(methacryloylamino)propyl]trimethylammonium chloride (MAPTAC), or a combination thereof.

In still other embodiments, the activated olefin is N,N-dimethylaminoethyl acrylate benzyl chloride quaternary salt (DMAEA-BCQ), 2-(methacryloyloxy)-N,N,N-trimethylethan-1-aminium methyl sulfate (DMAEMA-MSQ), 2-(acryloyloxy)-N,N,N-trimethylethanaminium chloride (DMAEA-MCQ), or a combination thereof.

In further embodiments, the activated olefin is acrylic acid, methacrylic acid, itaconic acid, maleic acid, vinylsulfonic acid, vinylphosphonic acid, or a combination thereof.

In some other embodiments, the activated olefin is 2-acrylamido-2-methylpropane sulfonic acid (AMPS), 3-(allyloxy)-2-hydroxypropane-1-sulfonate, or a combination thereof.

In some other embodiments, the activated olefin is vinylsulfonic acid, vinylphosphonic acid, or a combination thereof.

In yet some other embodiments, when the activated olefin contains anionic group that can bear negative charge at an alkaline pH, the counter positive ions for the negative charges include, but are not limited to, alkali metal ions, Li⁺, Na⁺, K⁺, NH₄⁺, a quaternary ammonium ion, etc.

Derivative of an Aza-Michael Addition Reaction

Disclosed are multiple cationic polymers derived from an aza-Michael Addition Reaction between a polyamine (Michael donor) and an activated olefin (Michael acceptor) having an ionic group according to one of the following formulas

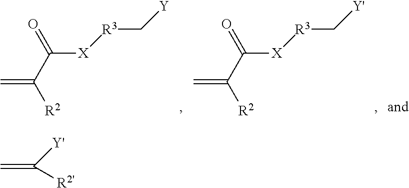

wherein X is NH or O; R² is H, CH₃, or an unsubstituted, linear or branched C₂-C₁₀ alkyl, alkenyl, or alkynyl group; R^{2′} is H, CH₃, or an unsubstituted or substituted, linear or branched C₁-C₁₀ alkyl, alkenyl, alkynyl group, —COOH, —CH₂COOH, Y′, or —(CH₂)ₘ—Y′; m is an integer of 2 to 4; R³ is absent or an unsubstituted, linear or branched C₁-C₃₀ alkylene group; Y is —NR₄R₅R₆⁽⁺⁾, Y′ is —COOH, —SO₃H, —PO₃H, —OSO₃H, —OPO₃H, or a salt thereof, and R⁴, R⁵, and R⁶ are independently a C₁-C₁₀ alkyl group; wherein the compound is a multiple charged cationic polymer having 2 or more positive charges or multiple charged anionic compound having 2 or more negative charges.

In some embodiments, the polyamine is NH₂—[R^{10′}]ₙ—NH₂, (RNH)ₙ—RNH₂, H₂N—(RNH)ₙ—RNH₂, or H₂N—(RN(R′))ₙ—RNH₂, wherein R^{10′} is a linear or branched, unsubstituted or substituted C₂-C₁₀ alkylene group, or combination thereof, R is —CH₂—, —CH₂CH₂—, —CH₂CH₂CH₂—, —CH(CH₃)CH₂—, a linear or branched, unsubstituted or substituted C₄-C₁₀ alkylene group, or combination thereof, R′ is —CH₂—, —CH₂CH₂—, —CH₂CH₂CH₂—, —CH(CH₃)CH₂—, a linear or branched, unsubstituted or substituted C₄-C₁₀ alkyl group, RNH₂, RNHRNH₂, or RN(RNH₂)₂; and n can be from 2 to 1,000,000.

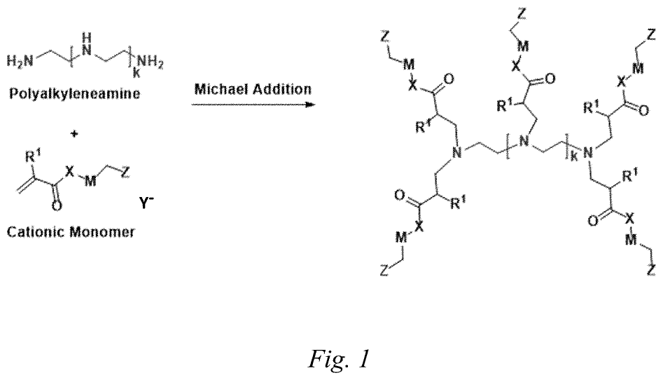

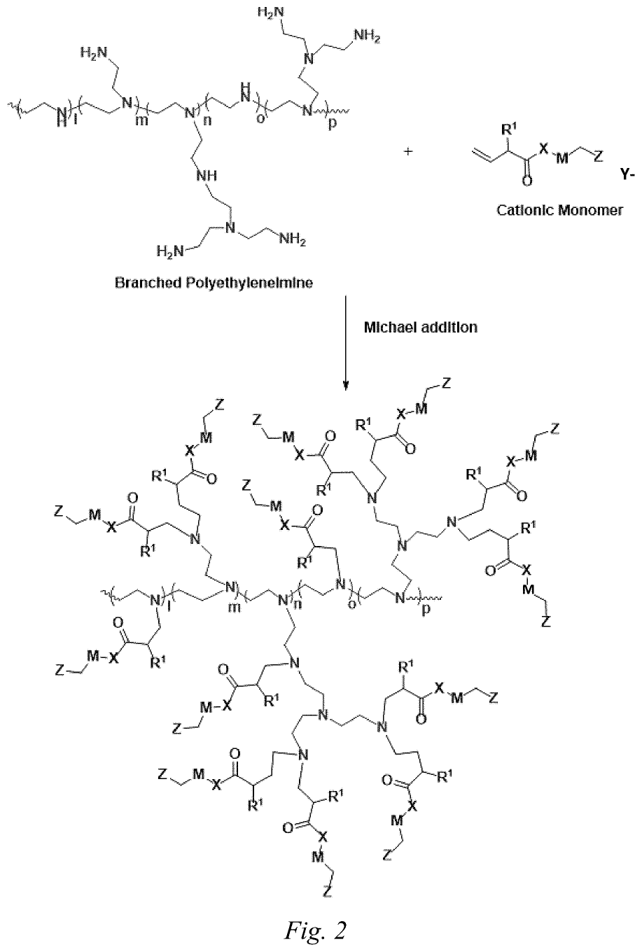

As a non-limiting example, structures of and the reactions leading to multiple charged cationic polymers using a linear polyethylenimine are shown in FIG. 1. A non-limiting example of a method of preparing, and a reaction product for, multiple charged cationic polymers derived from a branched polyethylenimine is shown in FIG. 2.

In FIG. 1 and FIG. 2, k, l, m, n, o, or p is an integer of 1-100; X is NH or O; R¹ is H, CH₃, or an unsubstituted, linear or branched C₂-C₁₀ alkyl group; M is absent or an unsubstituted, linear or branched C₁-C₃₀ alkylene group; Z is —NR⁴R⁵R⁶⁽⁺⁾Y⁽⁻⁾; R⁴, R⁵, and R⁶ are independently a C₁-C₁₀ alkyl group or benzyl group, and Y is a halide or a methyl sulfate group.

In FIG. 1 and FIG. 2 the secondary and primary amines in the polyethylenimine react with the activated olefins so that no secondary amines remain. It is possible that in the disclosed multiple charged cationic polymers, some secondary or primary amine groups do not react completely with the activated olefins and remain as primary or secondary amines in multiple charged cationic polymers or their salts.

In other words, in some embodiments, the multiple charged cationic polymers have one of the generic formula of NA₂-[R^{10′}]ₙ-NA₂, (RNA)ₙ-RNA₂, A₂N—(RNA)ₙ-RNA₂, or A₂N—(RN(R′))ₙ—RNA₂, wherein R^{10′} is a linear or branched, unsubstituted or substituted C₂-C₁₀ alkylene group, or combination thereof, R is —CH₂—, —CH₂CH₂—, —CH₂CH₂CH₂—, —CH(CH₃)CH₂—, a linear or branched, unsubstituted or substituted C₄-C₁₀ alkylene group, or combination thereof, R′ is —CH₂—, —CH₂CH₂—, —CH₂CH₂CH₂—, —CH(CH₃)CH₂—, a linear or branched, unsubstituted or substituted C₄-C₁₀ alkyl group, RNA₂, RNARNA₂, or RN(RNA₂)₂; n can be from 2 to 1,000,000; A is H or

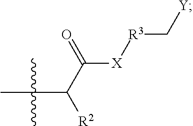

### or one of H,

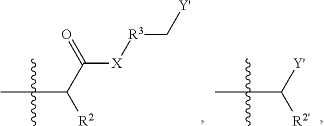

or a combination thereof, each of the compounds contain at least 2 non-proton and cationic or anionic A groups, at least 3 non-proton and cationic or anionic A groups, at least 4 non-proton and cationic or anionic A groups, at least 5 non-proton and cationic or anionic A groups, or more than 6 and cationic or anionic A groups. In some embodiments, A is H or positively charged

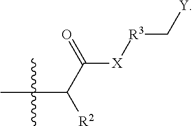

In some other embodiments, A is H or negatively charged

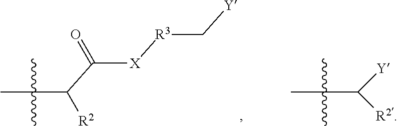

In some embodiments, at least two of the primary NH₂ protons are

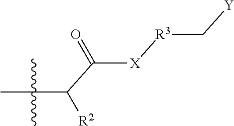

and the rest of primary NH₂ protons remains. In some embodiments, at least two of the primary NH₂ protons are

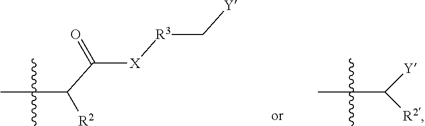

and the rest of primary NH₂ protons remains. In some other embodiments, all of the primary NH₂ protons are replaced by

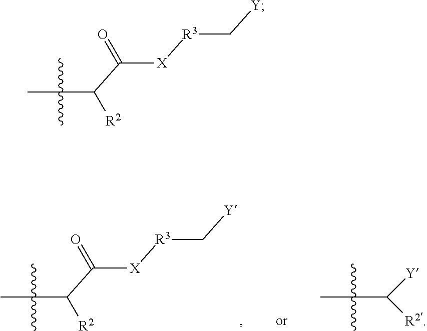

In some embodiments, some of primary NH₂ and secondary NH proton are replaced by

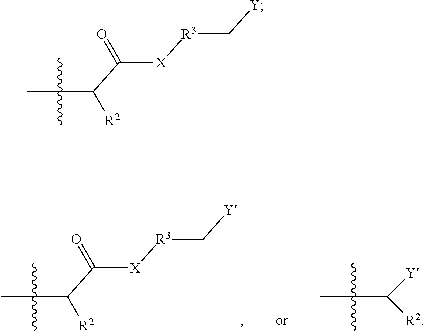

In some embodiments, all of primary NH₂ and some of secondary NH proton are replaced by

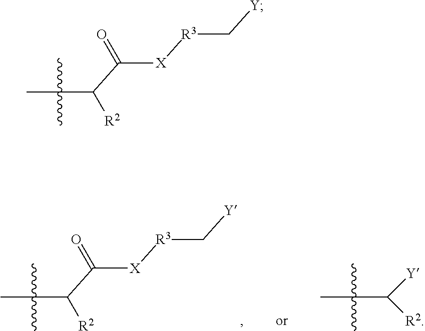

In some embodiments of the disclosed compounds herein, X is NH. In some other embodiments, X is O.

In some embodiments, R² is H. In some embodiments, R² is CH₃. In yet some other embodiments, R² is CH₃CH₃, CH₂CH₂CH₃, or CH(CH₃)₂.

In some embodiments, Y is —NR₄R₅R₆⁽⁺⁾. In some other embodiments, Y is —NR₄R₅R₆⁽⁺⁾, and R⁴, R⁵, and R⁶ are independently CH₃. In yet some other embodiments, Y is —NR₄R₅R₆⁽⁺⁾, and R⁴ and R⁵, independently CH₃, and R⁶ is a C₂-C₁₂ aromatic alkyl. In some other embodiments, Y is —NR₄R₅R₆⁽⁺⁾, and R⁴ and R⁵, independently CH₃, and R⁶ is —CH₂—C₆H₆.

In some embodiments, Y is —NR₄R₅R₆⁽⁺⁾ and the counter ion for Y any negative charged ion or species. In some other embodiments, the counter ion for Y is chloride, bromide, fluoride, iodide, acetate, aluminate, cyanate, cyanide, dihydrogen phosphate, dihydrogen phosphite, formate, carbonate, hydrogen carbonate, hydrogen oxalate, hydrogen sulfate, hydroxide, nitrate, nitrite, thiocyanate, or a combination thereof.

In some embodiments, Y′ is —COOH or salt thereof. In some other embodiments, Y′ is —SO₃H, —OSO₃H or salt thereof. In yet some other embodiments, Y′ is —OPO₃H, —PO₃H, or salt thereof. In some other embodiments, Y′ is an acidic species or salt thereof.

In some embodiments, R³ is CH₂. In some other embodiments, R³ is CH₂CH₂. In other embodiments, R³ is C(CH₃)₂. In yet some other embodiments, R³ is an unsubstituted, linear, and saturated C₁-C₁₀ alkylene group. In some embodiments, R³ is an unsubstituted, linear, and unsaturated C₁-C₁₀ alkylene group.

In some embodiments, R³ is a linear C₈-C₁₈ alkyl, alkenyl, or alkynyl group. In some other embodiments, R³ is a branched C₈-C₂₀ alkyl, alkenyl, or alkynyl group.

In some embodiments, the polyamine is a linear, branched, or dendrimer polyamine with a general formula of —[RNH]ₙ—, wherein R is —CH₂CH₂—, —CH₂CH₂CH₂—, —CH(CH₃)CH₂—, a linear or branched, unsubstituted or substituted C₄-C₁₀ alkylene group, or combination thereof and n is an integer of 3, 4, 5, 6, 7-9, or 10 to 1,000,000.

In some embodiments, the polyamine is a linear, branched, or dendrimer polyamine with a general formula of (RNH)ₙ—RNH₂, wherein R is —CH₂—, —CH₂CH₂—, —CH₂CH₂CH₂—, —CH(CH₃)CH₂—, a linear or branched, unsubstituted or substituted C₄-C₁₀ alkylene group, or combination thereof and n can be from 2 to 1,000,000. In some embodiments, R is the same in each monomer. In some other embodiments, R can be different from one monomer to another monomer.

In some other embodiments, the polyamine is a linear, branched, or dendrimer polyamine with a general formula of H₂N—(RNH)ₙ—RNH₂, wherein R is —CH₂—, —CH₂CH₂—, —CH₂CH₂CH₂—, —CH(CH₃)CH₂—, a linear or branched, unsubstituted or substituted C₄-C₁₀ alkylene group, or combination thereof and n can be from 2 to 1,000,000. In some embodiments, R is the same in each monomer. In some other embodiments, R can be different from one monomer to another monomer.

In yet some other embodiments, the polyamine is a linear, branched, or dendrimer polyamine with a general formula of H₂N—(RN(R′))ₙ—RNH₂, wherein R is —CH₂—, —CH₂CH₂—, —CH₂CH₂CH₂—, —CH(CH₃)CH₂—, a linear or branched, unsubstituted or substituted C₄-C₁₀ alkylene group, or combination thereof; R′ is —CH₂—, —CH₂CH₂—, —CH₂CH₂CH₂—, —CH(CH₃)CH₂—, a linear or branched, unsubstituted or substituted C₄-C₁₀ alkyl group, RNH₂, RNHRNH₂, or RN(RNH₂)₂; and n can be from 2 to 1,000,000. In some embodiments, R or R′ is the same in each monomer. In some other embodiments, R or R′ can be different from one monomer to another monomer.

In some embodiments, the polyamine is one with a general formula of NH₂—[R^{10′}]ₙ—NH₂, wherein R^{10′} is a linear or branched, unsubstituted or substituted C₄-C₁₀ alkylene group, or combination thereof and n is an integer of 3, 4, 5, 6, 7-9, or 10 to 1,000,000. In some other embodiments, R^{10′} can be different from one monomer to another monomer.

In some embodiments, the polyamine is one or more of polyamines under JEFFAMINE® by Huntsman.

In some embodiments, the polyamine comprises an alkyleneamine, the alkyleneamine comprising ethylenediamine, diethylenetriamine, triethylenetetramine, tetraethylenepentamine, pentaethylenehexamine, hexaethyleneheptamine, polyethylenimine, tris(2-aminoethyl)amine, or a combination thereof.

In some other embodiments, the polyamine is a mixture of monoamine, diamine, and triamine with a polyether backbone or with a polyether backbone based on propylene oxide (PO), ethylene oxide (EO), or a mixture of both oxides.

In some embodiments, the polyamine is an unmodified polyamine. In some other embodiments, the polyamine is a modified polyamine. As used herein, a “modified polyamine” refers to a polyamine in which one or more NH protons is substituted by a non-proton group, such as an alkyl.

In yet some embodiments, the polyamine is an ethoxylated polyamine, propylated polyamine, polyamine with polyquat, polyamine with polyglycerol, or combination thereof.

In some embodiments, the polyamine is diamine or triamine having an average molecular weight (M_{w}) of from about 130 to about 4,000.

In yet some other embodiments, the polyamine is a linear, branched, or dendrimer polyethylenimine. In some other embodiments, the polyamine comprises only primary and secondary amine groups. In some embodiments, the polyamine comprises only primary, secondary, and tertiary amine groups. In some other embodiments, the polyamine comprises only primary and tertiary amine groups.

In some embodiments, the polyamine is a single compound. In some other embodiments, the polyamine is a mixture of two or more different polyamines, wherein the different polyamines have different molecular weight, different structure, or both.

In some embodiments, the polyamine has an average molecular weight (M_{w}) of from about 130 to about 2,000,000 Da. In some other embodiments, the polyamine has an average molecular weight (M_{w}) of from about 130 to about 5,000 Da. In yet some other embodiments, the polyamine has an average molecular weight (M_{w}) of from about 130 to about 25,000 Da.

In some embodiments, the polyamine has an average molecular weight (M_{w}) of about 60-200, about 100-400, about 100-600, about 600-5,000, about 600-800, about 800-2,000, about 800-5,000, about 100-2,000,000, about 100-25,000, about 600-25,000, about 800-25,000, about 600-750,000, about 800-750,000, about 25,000-750,000, about 750,000-2,000,000, about 100, about 200, about 300, about 400, about 500, about 600, about 700, about 800, about 1,000, about 1,500, about 2,000, about 3,000, about 5,000, about 8,000, about 10,000, about 15,000, about 20,000, about 50,000, about 100,000, about 250,000, about 500,000, about 1,000,000, about 2,000,000, or any value there between.

In some embodiments, the compound is a mixture derived from a linear polyethylenimine and (3-acrylamidopropyl)trimethylammonium chloride (APTAC). In some other embodiments, the compound is a mixture derived from a linear polyethylenimine and [3-(methacryloylamino)propyl]trimethylammonium chloride (MAPTAC).

In some other embodiments, the multiple charged cationic polymer is a mixture derived from a branched polyethylenimine and (3-acrylamidopropyl)trimethylammonium chloride (APTAC). In some other embodiments, the compound is a mixture derived from a linear polyethylenimine and [3-(methacryloylamino)propyl]trimethylammonium chloride (MAPTAC).

In some embodiments, the activated olefin is (3-acrylamidopropyl)trimethylammonium chloride (APTAC), [3-(methacryloylamino)propyl]trimethylammonium chloride (MAPTAC), N,N-dimethylaminoethyl acrylate benzyl chloride quaternary salt (DMAEA-BCQ), 2-(methacryloyloxy)-N,N,N-trimethylethan-1-aminium methyl sulfate (DMAEMA-MSQ), or 2-(acryloyloxy)-N,N,N-trimethylethanaminium chloride (DMAEA-MCQ).

In some other embodiments, the activated olefin is (3-acrylamidopropyl)trimethylammonium chloride (APTAC), [3-(methacryloylamino)propyl]trimethylammonium chloride (MAPTAC), or a combination thereof.

In some other embodiments, the activated olefin is N,N-dimethylaminoethyl acrylate benzyl chloride quaternary salt (DMAEA-BCQ), 2-(methacryloyloxy)-N,N,N-trimethylethan-1-aminium methyl sulfate (DMAEMA-MSQ), 2-(acryloyloxy)-N,N,N-trimethylethanaminium chloride (DMAEA-MCQ), or a combination thereof.

In some embodiments, the activated olefin is acrylic acid, methacrylic acid, itaconic acid, maleic acid, vinylsulfonic acid, vinylphosphonic acid, or a combination thereof.

In some other embodiments, the activated olefin is 2-acrylamido-2-methylpropane sulfonic acid (AMPS), 3-(allyloxy)-2-hydroxypropane-1-sulfonate, or a combination thereof.

In some other embodiments, wherein the activated olefin is vinylsulfonic acid, vinylphosphonic acid, or a combination thereof.

In yet some other embodiments, when the activated olefin contains anionic group that can bear negative charge at an alkaline pH, the counter positive ions for the negative charges include, but are not limited to, alkali metal ions, Li⁺, Na⁺, K⁺, NH₄⁺, a quaternary ammonium ion, etc.

In some embodiments, the compound is an aza-Michael Addition reaction product of (3-acrylamidopropyl) trimethylammonium chloride (APTAC) and tetraethylenepentamine, E-100 (a mixture of tetraethylenepentamine (TEPA), pentaethylenehexamine (PEHA), and hexaethyleneheptamine (HEHA)), Pentaethylenehexamine (PEHA), or diethylenetriamine (DETA), respectively.

In some embodiments, the compound is an aza-Michael Addition reaction product of (3-acrylamidopropyl) trimethylammonium chloride (APTAC) and a polyethylenimine with an average molecular weight (M_{w}) of about 1,300, a polyethylenimine with an average molecular weight (M_{w}) of about 5,000, a polyethylenimine with an average molecular weight (M_{w}) of about 25,000, or a polyethylenimine with an average molecular weight (M_{w}) of about 750,000, respectively.

In some embodiments, the compound is

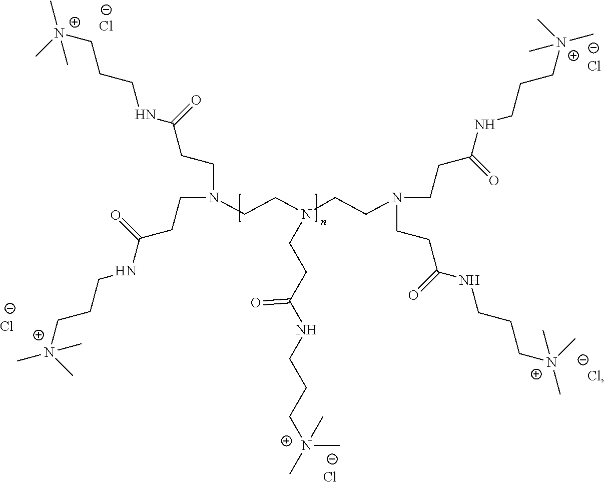

wherein n=0-1000. It should be understood that when n is greater than 2, the compound can be a mixture of more than two cationic compounds, which differ from each other by the exact locations of NH replacements.

In some other embodiments, wherein the compound is

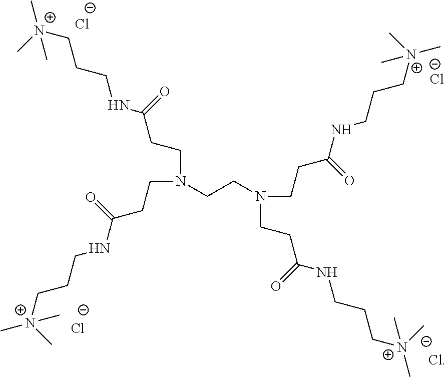

In some other embodiments, the compound is

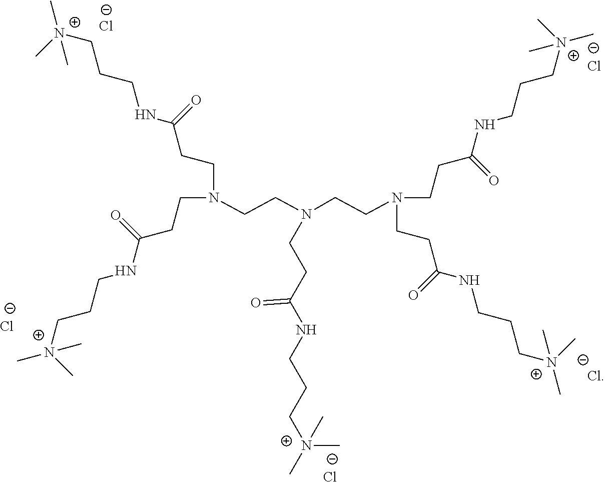

In some other embodiments the compound is

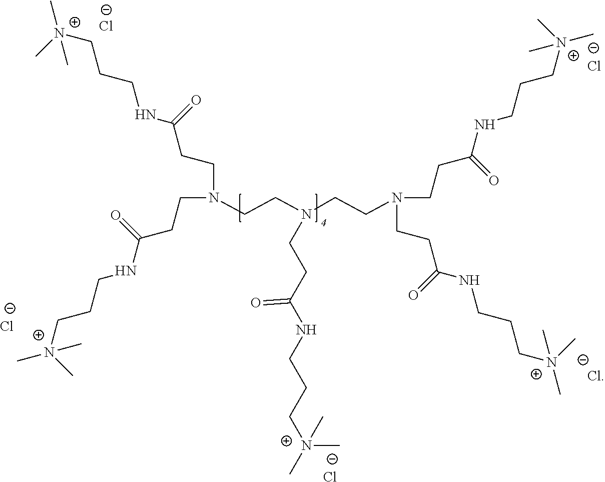

In some embodiments the multiple charged cationic polymer has an average molecular weight (M_{w}) of from about 100 to about 2,000,000 Da. In some other embodiments, the multiple charged cationic polymer has an average molecular weight (M_{w}) of from about 100 to about 50,000 Da. In yet some other embodiments, the multiple charged cationic polymer has an average molecular weight (M_{w}) of from about 100 Da to about 600 Da, from about 100 Da to about 1,000 Da, from about 100 Da to about 1,400 Da, from about 100 Da to about 3,000 Da, from about 100 Da to about 5,500 Da, or from about 100 Da to about 10,000 Da, from about 100 Da to about 20,000 Da, from about 100 Da to about 30,000 Da, or from about 100 Da to about 40,000 Da.

In some embodiments, the multiple charged cationic polymer has at least 2, at least 3, at least 4, at least 5, at least 6, at least 7, at least 8, at least 9, or at least 10 positive charges. In some other embodiments, the compound has from 10 to 1,000 positive charges, or any value there between positive charges.

In some embodiments, the multiple charged cationic polymer has at least 2, at least 3, at least 4, at least 5, at least 6, at least 7, at least 8, at least 9, or at least 10 negative charges. In some other embodiments, the compound has from 10 to 1,000 positive charges, or any value there between negative charges.

In some embodiments, the compound is soluble or dispersible in water.

Surfactants

In some embodiments, the cleaning compositions comprise a surfactant. Surfactants suitable for use in the methods and the cleaning compositions can include, but are not limited to, nonionic, anionic, cationic, amphoteric, and zwitterionic surfactants. In a preferred embodiment the cleaning compositions include at least one nonionic surfactant and at least one cationic surfactant. In a still further preferred embodiment, the compositions comprise at least one nonionic surfactant, at least one semi-polar nonionic surfactant, and at least one cationic surfactant. In a preferred embodiment, the nonionic surfactant comprises a fatty alcohol polyglycol ether, the semi-polar nonionic surfactant comprises dodecyl dimethyl amine oxide, and the cationic surfactant comprises N,N-Diethoxylated-N-coco-N-methylammonium chloride. The class, identity, and number of surfactant(s) selected for use in the compositions and methods may be altered and selected based on the other components in the compositions and methods and based on the types of soils targeted for removal.

In an aspect, the compositions include from about 10 wt. % to about 99 wt. % surfactants, from about 20 wt. % to about 90 wt. % surfactants, from about 40 wt. % to about 80 wt. % surfactants, from about 50 wt. % to about 90 wt. % surfactants, preferably from about 50 wt. % to about 80 wt. % surfactants, inclusive of all integers within these ranges.

Nonionic Surfactants

Useful nonionic surfactants are generally characterized by the presence of an organic hydrophobic group and an organic hydrophilic group and are typically produced by the condensation of an organic aliphatic, alkyl aromatic or polyoxyalkylene hydrophobic compound with a hydrophilic alkaline oxide moiety which in common practice is ethylene oxide or a polyhydration product thereof, polyethylene glycol. Practically any hydrophobic compound having a hydroxyl, carboxyl, amino, or amido group with a reactive hydrogen atom can be condensed with ethylene oxide, or its polyhydration adducts, or its mixtures with alkoxylenes such as propylene oxide to form a nonionic surface-active agent. The length of the hydrophilic polyoxyalkylene moiety which is condensed with any particular hydrophobic compound can be readily adjusted to yield a water dispersible or water-soluble compound having the desired degree of balance between hydrophilic and hydrophobic properties. Particularly preferred nonionic surfactants include ethoxylated tridecyl alcohols, such as those sold under the trade name TDA, e.g., TDA 9; C12-C14 alcohol ethoxylates having 5-9 mole EO, such as those sold under the trade name Surfonic L24-7; and polyoxyethylene castor oil ether, commercially available as EL-20. Useful nonionic surfactants include:

(1) Block polyoxypropylene-polyoxyethylene polymeric compounds based upon propylene glycol, ethylene glycol, glycerol, trimethylolpropane, and ethylenediamine as the initiator reactive hydrogen compound. Examples of polymeric compounds made from a sequential p propoxylation and ethoxylation of initiator are commercially available from BASF Corp. One class of compounds are difunctional (two reactive hydrogens) compounds formed by condensing ethylene oxide with a hydrophobic base formed by the addition of propylene oxide to the two hydroxyl groups of propylene glycol. This hydrophobic portion of the molecule weighs from about 1,000 to about 4,000. Ethylene oxide is then added to sandwich this hydrophobe between hydrophilic groups, controlled by length to constitute from about 10% by weight to about 80% by weight of the final molecule. Another class of compounds are tetra-functional block copolymers derived from the sequential addition of propylene oxide and ethylene oxide to ethylenediamine. The molecular weight of the propylene oxide ranges from about 500 to about 7,000; and the hydrophile, ethylene oxide, is added to constitute from about 10% by weight to about 80% by weight of the molecule.

(2) Condensation products of one mole of alkyl phenol wherein the alkyl chain, of straight chain or branched chain configuration, or of single or dual alkyl constituent, contains from about 8 to about 18 carbon atoms with from about 3 to about 50 moles of ethylene oxide. The alkyl group can, for example, be represented by diisobutylene, di-amyl, polymerized propylene, iso-octyl, nonyl, and di-nonyl. These surfactants can be polyethylene, polypropylene, and polybutylene oxide condensates of alkyl phenols. Examples of commercial compounds of this chemistry are available on the market under the trade names Igepal® manufactured by Rhone-Poulenc and Triton® manufactured by Union Carbide.

(3) Condensation products of one mole of a saturated or unsaturated, straight or branched chain alcohol having from about 6 to about 24 carbon atoms with from about 3 to about 50 moles of ethylene oxide. The alcohol moiety can consist of mixtures of alcohols in the above delineated carbon range or it can consist of an alcohol having a specific number of carbon atoms within this range. Examples of like commercial surfactant are available under the trade names Lutensol™, Dehydol™ manufactured by BASF, Neodol™ manufactured by Shell Chemical Co. and Alfonic™ manufactured by Vista Chemical Co.

(4) Condensation products of one mole of saturated or unsaturated, straight or branched chain carboxylic acid having from about 8 to about 18 carbon atoms with from about 6 to about 50 moles of ethylene oxide. The acid moiety can consist of mixtures of acids in the above defined carbon atoms range or it can consist of an acid having a specific number of carbon atoms within the range. Examples of commercial compounds of this chemistry are available on the market under the trade names Disponil or Agnique manufactured by BASF and Lipopeg™ manufactured by Lipo Chemicals, Inc.

In addition to ethoxylated carboxylic acids, commonly called polyethylene glycol esters, other alkanoic acid esters formed by reaction with glycerides, glycerin, and polyhydric (saccharide or sorbitan/sorbitol) alcohols have application in this disclosure for specialized embodiments, particularly indirect food additive applications. All of these ester moieties have one or more reactive hydrogen sites on their molecule which can undergo further acylation or ethylene oxide (alkoxide) addition to control the hydrophilicity of these substances. Care must be exercised when adding these fatty esters or acylated carbohydrates to compositions of the present disclosure containing amylase or lipase enzymes because of potential incompatibility.

Examples of nonionic low foaming surfactants include:

(5) Compounds from (1) which are modified, essentially reversed, by adding ethylene oxide to ethylene glycol to provide a hydrophile of designated molecular weight; and, then adding propylene oxide to obtain hydrophobic blocks on the outside (ends) of the molecule. The hydrophobic portion of the molecule weighs from about 1,000 to about 3,100 with the central hydrophile including 10% by weight to about 80% by weight of the final molecule. These reverse Pluronics™ are manufactured by BASF Corporation under the trade name Pluronic™ R surfactants. Likewise, the Tetronic™ R surfactants are produced by BASF Corporation by the sequential addition of ethylene oxide and propylene oxide to ethylenediamine. The hydrophobic portion of the molecule weighs from about 2,100 to about 6,700 with the central hydrophile including 10% by weight to 80% by weight of the final molecule.

(6) Compounds from groups (1), (2), (3) and (4) which are modified by “capping” or “end blocking” the terminal hydroxy group or groups (of multi-functional moieties) to reduce foaming by reaction with a small hydrophobic molecule such as propylene oxide, butylene oxide, benzyl chloride; and short chain fatty acids, alcohols or alkyl halides containing from 1 to about 5 carbon atoms; and mixtures thereof. Also included are reactants such as thionyl chloride which convert terminal hydroxy groups to a chloride group. Such modifications to the terminal hydroxy group may lead to all-block, block-heteric, heteric-block or all-heteric nonionics.

Additional examples of effective low foaming nonionics include:

(7) The alkylphenoxypolyethoxyalkanols of U.S. Pat. No. 2,903,486 issued Sep. 8, 1959, to Brown et al. and represented by the formula

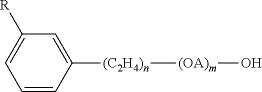

in which R is an alkyl group of 8 to 9 carbon atoms, A is an alkylene chain of 3 to 4 carbon atoms, n is an integer of 7 to 16, and m is an integer of 1 to 10.

The polyalkylene glycol condensates of U.S. Pat. No. 3,048,548 issued Aug. 7, 1962, to Martin et al. having alternating hydrophilic oxyethylene chains and hydrophobic oxypropylene chains where the weight of the terminal hydrophobic chains, the weight of the middle hydrophobic unit and the weight of the linking hydrophilic units each represent about one-third of the condensate.

The defoaming nonionic surfactants disclosed in U.S. Pat. No. 3,382,178 issued May 7, 1968, to Lissant et al. having the general formula Z[(OR)ₙOH]_{z} wherein Z is alkoxylatable material, R is a radical derived from an alkylene oxide which can be ethylene and propylene and n is an integer from, for example, 10 to 2,000 or more and z is an integer determined by the number of reactive oxyalkylatable groups.

The conjugated polyoxyalkylene compounds described in U.S. Pat. No. 2,677,700, issued May 4, 1954, to Jackson et al. corresponding to the formula Y(C₃H₆O)ₙ(C₂H₄O)ₘH wherein Y is the residue of organic compound having from about 1 to 6 carbon atoms and one reactive hydrogen atom, n has an average value of at least about 6.4, as determined by hydroxyl number and m has a value such that the oxyethylene portion constitutes about 10% to about 90% by weight of the molecule.

The conjugated polyoxyalkylene compounds described in U.S. Pat. No. 2,674,619, issued Apr. 6, 1954 to Lundsted et al. having the formula Y[(C₃H₄O)ₘH]ₓ wherein Y is the residue of an organic compound having from about 2 to 6 carbon atoms and containing x reactive hydrogen atoms in which x has a value of at least about 2, n has a value such that the molecular weight of the polyoxypropylene hydrophobic base is at least about 900 and m has value such that the oxyethylene content of the molecule is from about 10% to about 90% by weight. Compounds falling within the scope of the definition for Y include, for example, propylene glycol, glycerin, pentaerythritol, trimethylolpropane, ethylenediamine and the like. The oxypropylene chains optionally, but advantageously, contain small amounts of ethylene oxide and the oxyethylene chains also optionally, but advantageously, contain small amounts of propylene oxide.

Additional conjugated polyoxyalkylene surface-active agents which are advantageously used in the compositions of this disclosure correspond to the formula: P[(C₃H₆O)ₙ (C₂H₄O)ₘH]ₓ wherein P is the residue of an organic compound having from about 8 to 18 carbon atoms and containing x reactive hydrogen atoms in which x has a value of 1 or 2, n has a value such that the molecular weight of the polyoxyethylene portion is at least about 44 and m has a value such that the oxypropylene content of the molecule is from about 10% to about 90% by weight. In either case the oxypropylene chains may contain optionally, but advantageously, small amounts of ethylene oxide and the oxyethylene chains may contain also optionally, but advantageously, small amounts of propylene oxide.

(8) Polyhydroxy fatty acid amide surfactants suitable for use in the present compositions include those having the structural formula R₂CON_{R1}Z in which: R1 is H, C₁-C₄ hydrocarbyl, 2-hydroxy ethyl, 2-hydroxy propyl, ethoxy, propoxy group, or a mixture thereof; R² is a C₅-C₃₁ hydrocarbyl, which can be straight-chain; and Z is a polyhydroxy hydrocarbyl having a linear hydrocarbyl chain with at least 3 hydroxyls directly connected to the chain, or an alkoxylated derivative (preferably ethoxylated or propoxylated) thereof. Z can be derived from a reducing sugar in a reductive amination reaction; such as a glycityl moiety.

(9) The alkyl ethoxylate condensation products of aliphatic alcohols with from about 0 to about 25 moles of ethylene oxide are suitable for use in the present compositions. The alkyl chain of the aliphatic alcohol can either be straight or branched, primary or secondary, and generally contains from 6 to 22 carbon atoms.

(10) Fatty alcohol nonionic surfactants, including ethoxylated C₆-C₁₈ fatty alcohols and C₆-C₁₈ mixed ethoxylated and propoxylated fatty alcohols and fatty alcohol polyglycol ethers. Suitable ethoxylated fatty alcohols include the C₆-C₁₈ ethoxylated fatty alcohols with a degree of ethoxylation of from 3 to 50.

(11) Suitable nonionic alkylpolysaccharide surfactants, particularly for use in the present compositions include those disclosed in U.S. Pat. No. 4,565,647, Llenado, issued Jan. 21, 1986. These surfactants include a hydrophobic group containing from about 6 to about 30 carbon atoms and a polysaccharide, e.g., a polyglycoside, hydrophilic group containing from about 1.3 to about 10 saccharide units. Any reducing saccharide containing 5 or 6 carbon atoms can be used, e.g., glucose, galactose and galactosyl moieties can be substituted for the glucosyl moieties. (Optionally the hydrophobic group is attached at the 2-, 3-, 4-, etc. positions thus giving a glucose or galactose as opposed to a glucoside or galactoside.) The intersaccharide bonds can be, e.g., between the one position of the additional saccharide units and the 2-, 3-, 4-, or 6-positions on the preceding saccharide units.

(12) Fatty acid amide surfactants suitable for use the present compositions include those having the formula: R₆CON(R₇)₂ in which R₆ is an alkyl group containing from 7 to 21 carbon atoms and each R₇ is independently hydrogen, C₁-C₄ alkyl, C₁-C₄ hydroxyalkyl, or —(C₂H₄O)_{X}H, where x is in the range of from 1 to 3.

(13) A useful class of non-ionic surfactants include the class defined as alkoxylated amines or, most particularly, alcohol alkoxylated/aminated/alkoxylated surfactants. These non-ionic surfactants may be at least in part represented by the general formulae: R²⁰—(PO)_{S}N-(EO)ₜH, R²⁰—(PO)_{S}N-(EO)ₜH(EO)ₜH, and R²⁰—N(EO)ₜH; in which R²⁰ is an alkyl, alkenyl or other aliphatic group, or an alkyl-aryl group of from 8 to 20, preferably 12 to 14 carbon atoms, EO is oxyethylene, PO is oxypropylene, s is 1 to 20, preferably 2-5, t is 1-10, preferably 2-5, and u is 1-10, preferably 2-5. Other variations on the scope of these compounds may be represented by the alternative formula: R²⁰—(PO)_{V}—N[(EO)_{w}H][(EO)_{z}H] in which R²⁰ is as defined above, v is 1 to 20 (e.g., 1, 2, 3, or 4 (preferably 2)), and w and z are independently 1-10, preferably 2-5. These compounds are represented commercially by a line of products sold by Huntsman Chemicals as nonionic surfactants. A preferred chemical of this class includes Surfonic™ PEA 25 Amine Alkoxylate. Preferred nonionic surfactants for the compositions of the disclosure include alcohol alkoxylates, EO/PO block copolymers, alkylphenol alkoxylates, and the like.

The treatise Nonionic Surfactants, edited by Schick, M. J., Vol. 1 of the Surfactant Science Series, Marcel Dekker, Inc., New York, 1983 is an excellent reference on the wide variety of nonionic compounds generally employed in the practice of the present disclosure. A typical listing of nonionic classes, and species of these surfactants, is given in U.S. Pat. No. 3,929,678 issued to Laughlin and Heuring on Dec. 30, 1975. Further examples are given in “Surface Active Agents and detergents” (Vol. I and II by Schwartz, Perry and Berch).

Semi-Polar Nonionic Surfactants

The semi-polar type of nonionic surface-active agents are another class of nonionic surfactant useful in compositions of the present disclosure. Generally, semi-polar nonionics are high foaming and foam stabilizers, which can limit their application in CIP systems. However, within compositional embodiments of this disclosure designed for high foam cleaning methodology, semi-polar nonionics would have immediate utility. The semi-polar nonionic surfactants include the amine oxides, phosphine oxides, sulfoxides and their alkoxylated derivatives.

(14) Amine oxides are tertiary amine oxides corresponding to the general formula:

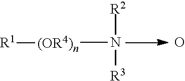

wherein the arrow is a conventional representation of a semi-polar bond; and R¹, R², and R³ may be aliphatic, aromatic, heterocyclic, alicyclic, or combinations thereof. Generally, for amine oxides of detergent interest, R¹ is an alkyl radical of from about 8 to about 24 carbon atoms; R² and R³ are alkyl or hydroxyalkyl of 1-3 carbon atoms or a mixture thereof, R² and R³ can be attached to each other, e.g., through an oxygen or nitrogen atom, to form a ring structure; R⁴ is an alkaline or a hydroxyalkylene group containing 2 to 3 carbon atoms; and n ranges from 0 to about 20.

Useful water soluble amine oxide surfactants are selected from the coconut or tallow alkyl di-(lower alkyl) amine oxides, specific examples of which are dodecyldimethylamine oxide, tridecyldimethylamine oxide, tetradecyldimethylamine oxide, pentadecyldimethylamine oxide, hexadecyldimethylamine oxide, heptadecyldimethylamine oxide, octadecyldimethylaine oxide, dodecyldipropylamine oxide, tetradecyldipropylamine oxide, hexadecyldipropylamine oxide, tetradecyldibutylamine oxide, octadecyldibutylamine oxide, bis(2-hydroxyethyl)dodecylamine oxide, bis(2-hydroxyethyl)-3-dodecoxy-1-hydroxypropylamine oxide, dimethyl-(2-hydroxydodecyl)amine oxide, 3,6,9-trioctadecyldimethylamine oxide and 3-dodecoxy-2-hydroxypropyldi-(2-hydroxyethyl)amine oxide. Useful semi-polar nonionic surfactants also include the water-soluble phosphine oxides having the following structure:

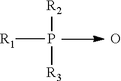

wherein the arrow is a conventional representation of a semi-polar bond; and R¹ is an alkyl, alkenyl or hydroxyalkyl moiety ranging from 10 to about 24 carbon atoms in chain length; and R² and R³ are each alkyl moieties separately selected from alkyl or hydroxyalkyl groups containing 1 to 3 carbon atoms.

Examples of useful phosphine oxides include dimethyldecylphosphine oxide, dimethyltetradecylphosphine oxide, methylethyltetradecylphosphone oxide, dimethyl hexadecyl phosphine oxide, diethyl-2-hydroxyoctyldecylphosphine oxide, bis(2-hydroxyethyl)dodecyl phosphine oxide, and bis(hydroxymethyl)tetradecyl phosphine oxide.

Semi-polar nonionic surfactants useful herein also include the water-soluble sulfoxide compounds which have the structure:

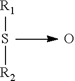

wherein the arrow is a conventional representation of a semi-polar bond; and R¹ is an alkyl or hydroxyalkyl moiety of about 8 to about 28 carbon atoms, from 0 to about 5 ether linkages and from 0 to about 2 hydroxyl substituents; and R² is an alkyl moiety consisting of alkyl and hydroxyalkyl groups having 1 to 3 carbon atoms.

Useful examples of these sulfoxides include dodecyl methyl sulfoxide; 3-hydroxy tridecyl methyl sulfoxide; 3-methoxy tridecyl methyl sulfoxide; and 3-hydroxy-4-dodecoxybutyl methyl sulfoxide.

Semi-polar nonionic surfactants for the compositions of the disclosure include dimethyl amine oxides, such as lauryl dimethyl amine oxide, myristyl dimethyl amine oxide, cetyl dimethyl amine oxide, combinations thereof, and the like. Useful water soluble amine oxide surfactants are selected from the octyl, decyl, dodecyl, isododecyl, coconut, or tallow alkyl di-(lower alkyl) amine oxides, specific examples of which are octyl dimethyl amine oxide, nonyl dimethyl amine oxide, decyl dimethyl amine oxide, undecyl dimethyl amine oxide, dodecyldimethyl amine oxide, iso-dodecyldimethyl amine oxide, lauryl dimethyl amine oxide (sold commercially as Barlox 12), tridecyldimethylamine oxide, tetradecyldimethylamine oxide, pentadecyldimethylamine oxide, hexadecyldimethylamine oxide, heptadecyldimethylamine oxide, octadecyldimethylaine oxide, dodecyldipropylamine oxide, tetradecyldipropylamine oxide, hexadecyldipropylamine oxide, tetradecyldibutylamine oxide, octadecyldibutylamine oxide, bis(2-hydroxyethyl)dodecylamine oxide, bis(2-hydroxyethyl)-3-dodecoxy-1-hydroxypropylamine oxide, dimethyl-(2-hydroxydodecyl)amine oxide, 3,6,9-trioctadecyldimethylamine oxide and 3-dodecoxy-2-hydroxypropyldi-(2-hydroxyethyl)amine oxide.

Suitable nonionic surfactants suitable for use with the compositions of the present disclosure include alkoxylated surfactants. Suitable alkoxylated surfactants include EO/PO copolymers, capped EO/PO copolymers, alcohol alkoxylates, capped alcohol alkoxylates, mixtures thereof, or the like. Suitable alkoxylated surfactants for use as solvents include EO/PO block copolymers, such as the Pluronic and reverse Pluronic surfactants; alcohol alkoxylates, such as Dehypon LS-54 (R-(EO)₅(PO)₄) and Dehypon LS-36 (R-(EO)₃(PO)₆); and capped alcohol alkoxylates, such as Plurafac LF221 and Tegoten EC11; mixtures thereof, or the like.

Anionic Surfactants

Also useful in the present disclosure are surface active substances which are categorized as anionics because the charge on the hydrophobe is negative; or surfactants in which the hydrophobic section of the molecule carries no charge unless the pH is elevated to neutrality or above (e.g., carboxylic acids). Carboxylate, sulfonate, sulfate and phosphate are the polar (hydrophilic) solubilizing groups found in anionic surfactants. Of the cations (counter ions) associated with these polar groups, sodium, lithium and potassium impart water solubility; ammonium and substituted ammonium ions provide both water and oil solubility; and calcium, barium, and magnesium promote oil solubility. As those skilled in the art understand, anionics are excellent detersive surfactants and are therefore favored additions to heavy duty cleaning compositions.

Anionic sulfate surfactants suitable for use in the present compositions include alkyl ether sulfates, alkyl sulfates, the linear and branched primary and secondary alkyl sulfates, alkyl ethoxysulfates, fatty oleyl glycerol sulfates, alkyl phenol ethylene oxide ether sulfates, the C₅-C₁₇ acyl-N—(C₁-C₄ alkyl) and —N—(C₁-C₂ hydroxyalkyl) glucamine sulfates, and sulfates of alkylpolysaccharides such as the sulfates of alkylpolyglucoside, and the like. Also included are the alkyl sulfates, alkyl poly(ethyleneoxy) ether sulfates and aromatic poly(ethyleneoxy) sulfates such as the sulfates or condensation products of ethylene oxide and nonyl phenol (usually having 1 to 6 oxyethylene groups per molecule).

Anionic sulfonate surfactants suitable for use in the present compositions also include alkyl sulfonates, the linear and branched primary and secondary alkyl sulfonates, and the aromatic sulfonates with or without substituents.

Anionic carboxylate surfactants suitable for use in the present compositions include carboxylic acids (and salts), such as alkanoic acids (and alkanoates), ester carboxylic acids (e.g., alkyl succinates), ether carboxylic acids, sulfonated fatty acids, such as sulfonated oleic acid, and the like. Such carboxylates include alkyl ethoxy carboxylates, alkyl aryl ethoxy carboxylates, alkyl polyethoxy polycarboxylate surfactants and soaps (e.g., alkyl carboxyls). Secondary carboxylates useful in the present compositions include those which contain a carboxyl unit connected to a secondary carbon. The secondary carbon can be in a ring structure, e.g., as in p-octyl benzoic acid, or as in alkyl-substituted cyclohexyl carboxylates. The secondary carboxylate surfactants typically contain no ether linkages, no ester linkages and no hydroxyl groups. Further, they typically lack nitrogen atoms in the head-group (amphiphilic portion). Suitable secondary soap surfactants typically contain 11-13 total carbon atoms, although more carbons atoms (e.g., up to 16) can be present. Suitable carboxylates also include acylamino acids (and salts), such as acylgluamates, acyl peptides, sarcosinates (e.g., N-acyl sarcosinates), taurates (e.g., N-acyl taurates and fatty acid amides of methyl tauride), and the like.

Suitable anionic surfactants include alkyl or alkylaryl ethoxy carboxylates of the following formula:

R—O—(CH₂CH₂O)ₙ(CH₂)ₘ—CO₂X (3)

in which R is a C₈ to C₂₂ alkyl group or

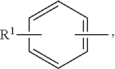

in which R¹ is a C₄-C₁₆ alkyl group; n is an integer of 1-20; m is an integer of 1-3; and X is a counter ion, such as hydrogen, sodium, potassium, lithium, ammonium, or an amine salt such as monoethanolamine, diethanolamine or triethanolamine. In some embodiments, n is an integer of 4 to 10 and m is 1. In some embodiments, R is a C₈-C₁₆ alkyl group. In some embodiments, R is a C₁₂-C₁₄ alkyl group, n is 4, and m is 1.

In other embodiments, R is

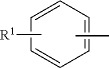

and R¹ is a C₆-C₁₂ alkyl group. In still yet other embodiments, R¹ is a C₉ alkyl group, n is 10 and m is 1.

Such alkyl and alkylaryl ethoxy carboxylates are commercially available. These ethoxy carboxylates are typically available as the acid forms, which can be readily converted to the anionic or salt form. Commercially available carboxylates include, Neodox 23-4, a C₁₂₋₁₃ alkyl polyethoxy (4) carboxylic acid (Shell Chemical), and Emcol CNP-110, a C₉ alkylaryl polyethoxy (10) carboxylic acid (Witco Chemical). Carboxylates are also available from Clariant, e.g., the product Sandopan® DTC, a C₁₃ alkyl polyethoxy (7) carboxylic acid.

Cationic Surfactants

Surface active substances are classified as cationic if the charge on the hydrotrope portion of the molecule is positive. Surfactants in which the hydrotrope carries no charge unless the pH is lowered close to neutrality or lower, but which are then cationic (e.g., alkyl amines), are also included in this group. In theory, cationic surfactants may be synthesized from any combination of elements containing an “onium” structure RnX+Y— and could include compounds other than nitrogen (ammonium) such as phosphorus (phosphonium) and sulfur (sulfonium). In practice, the cationic surfactant field is dominated by nitrogen containing compounds, probably because synthetic routes to nitrogenous cationics are simple and straightforward and give high yields of product, which can make them less expensive.

Cationic surfactants preferably include, more preferably refer to, compounds containing at least one long carbon chain hydrophobic group and at least one positively charged nitrogen. The long carbon chain group may be attached directly to the nitrogen atom by simple substitution; or more preferably indirectly by a bridging functional group or groups in so-called interrupted alkylamines and amido amines. Such functional groups can make the molecule more hydrophilic or more water dispersible, more easily water solubilized by co-surfactant mixtures, or water soluble. For increased water solubility, additional primary, secondary or tertiary amino groups can be introduced, or the amino nitrogen can be quaternized with low molecular weight alkyl groups. Further, the nitrogen can be a part of branched or straight chain moiety of varying degrees of unsaturation or of a saturated or unsaturated heterocyclic ring. In addition, cationic surfactants may contain complex linkages having more than one cationic nitrogen atom.

The surfactant compounds classified as amine oxides, amphoterics and zwitterions are themselves typically cationic in near neutral to acidic pH solutions and can overlap surfactant classifications. Polyoxyethylated cationic surfactants generally behave like nonionic surfactants in alkaline solution and like cationic surfactants in acidic solution.

The simplest cationic amines, amine salts and quaternary ammonium compounds can be schematically drawn thus:

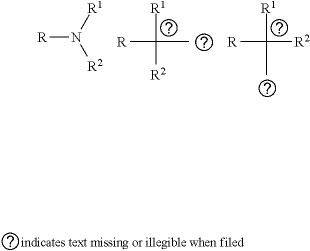

in which R represents an alkyl chain, R′, R″, and R′″ may be either alkyl chains or aryl groups or hydrogen and X represents an anion. The amine salts and quaternary ammonium compounds are preferred for practical use in this disclosure due to their high degree of water solubility.

The majority of large volume commercial cationic surfactants can be subdivided into four major classes and additional sub-groups known to those or skill in the art and described in “Surfactant Encyclopedia,” Cosmetics & Toiletries, Vol. 104 (2) 86-96 (1989). The first class includes alkylamines and their salts. The second class includes alkyl imidazolines. The third class includes ethoxylated amines. The fourth class includes quaternaries, such as alkyl benzyl dimethyl ammonium salts, alkyl benzene salts, heterocyclic ammonium salts, tetra alkylammonium salts, and the like. Cationic surfactants are known to have a variety of properties that can be beneficial in the present compositions. These desirable properties can include detergency in compositions of or below neutral pH, antimicrobial efficacy, thickening or gelling in cooperation with other agents, and the like.

Cationic surfactants useful in the compositions of the present disclosure include those having the formula R¹ₘR²ₓY_{L}Z wherein each R¹ is an organic group containing a straight or branched alkyl or alkenyl group optionally substituted with up to three phenyl or hydroxy groups and optionally interrupted by up to four of the following structures:

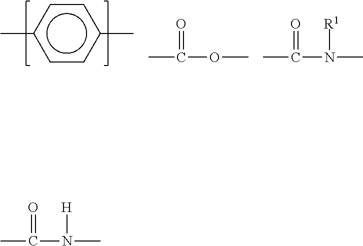

or an isomer or mixture of these structures, and which contains from about 8 to 22 carbon atoms. The R¹ groups can additionally contain up to 12 ethoxy groups. m is a number from 1 to 3. Preferably, no more than one R¹ group in a molecule has 16 or more carbon atoms when m is 2 or more than 12 carbon atoms when m is 3. Each R² is an alkyl or hydroxyalkyl group containing from 1 to 4 carbon atoms or a benzyl group with no more than one R² in a molecule being benzyl, and x is a number from 0 to 11, preferably from 0 to 6.

The remainder of any carbon atom positions on the Y group are filled by hydrogens.

Y is a group including, but not limited to:

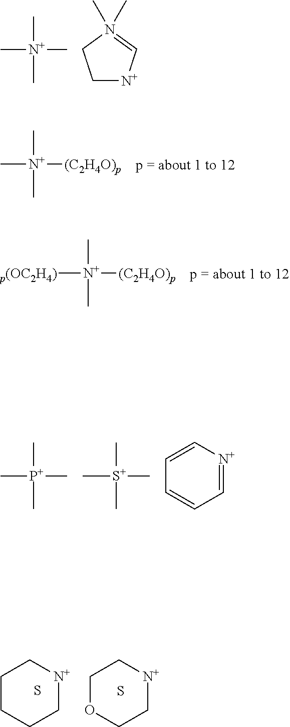

or a mixture thereof. Preferably, L is 1 or 2, with the Y groups being separated by a moiety selected from R¹ and R² analogs (preferably alkylene or alkenylene) having from 1 to about 22 carbon atoms and two free carbon single bonds when L is 2. Z is a water-soluble anion, such as a halide, sulfate, methylsulfate, hydroxide, or nitrate anion, particularly preferred being chloride, bromide, iodide, sulfate or methyl sulfate anions, in a number to give electrical neutrality of the cationic component.

Additional suitable cationic surfactants include those derived from coconut products such as coconut oil or coconut fatty acid. Additional suitable coconut derived surfactants include, for example, complex fatty tertiary amines with cationic surfactant properties, both as free amines and in the salt form. Such surfactants include, but are not limited to N,N-Diethoxylated-N-coco-N-methylammonium chloride (also sometimes referred to as Coconut oil alkyl)bis(2-hydroxyethyl, ethoxylated)methylammonium Chloride) Such surfactants are commercially available under the trade names Ameenex™ specifically Ameenix™ 1154 and Rewoquat, specifically Rewoquat CQ 100 G.

Amphoteric Surfactants

Amphoteric, or ampholytic, surfactants contain both a basic and an acidic hydrophilic group and an organic hydrophobic group. These ionic entities may be any of anionic or cationic groups described herein for other types of surfactants. A basic nitrogen and an acidic carboxylate group are the typical functional groups employed as the basic and acidic hydrophilic groups. In a few surfactants, sulfonate, sulfate, phosphonate or phosphate provide the negative charge.

Amphoteric surfactants can be broadly described as derivatives of aliphatic secondary and tertiary amines, in which the aliphatic radical may be straight chain or branched and wherein one of the aliphatic substituents contains from about 8 to 18 carbon atoms and one contains an anionic water solubilizing group, e.g., carboxy, sulfo, sulfato, phosphato, or phosphono. Amphoteric surfactants are subdivided into two major classes known to those of skill in the art and described in “Surfactant Encyclopedia” Cosmetics & Toiletries, Vol. 104 (2) 69-71 (1989), which is herein incorporated by reference in its entirety. The first class includes acyl/dialkyl ethylenediamine derivatives (e.g., 2-alkyl hydroxyethyl imidazoline derivatives) and their salts. The second class includes N-alkylamino acids and their salts. Some amphoteric surfactants can be envisioned as fitting into both classes.

Amphoteric surfactants can be synthesized by methods known to those of skill in the art. For example, 2-alkyl hydroxyethyl imidazoline is synthesized by condensation and ring closure of a long chain carboxylic acid (or a derivative) with dialkyl ethylenediamine. Commercial amphoteric surfactants are derivatized by subsequent hydrolysis and ring-opening of the imidazoline ring by alkylation—for example with chloroacetic acid or ethyl acetate. During alkylation, one or two carboxy-alkyl groups react to form a tertiary amine and an ether linkage with differing alkylating agents yielding different tertiary amines.

Long chain imidazole derivatives having application in the present disclosure generally have the general formula:

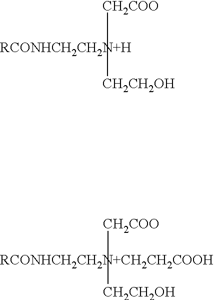

(Mono)acetate (Di)Proprionate

Neutral pH Zwitterion

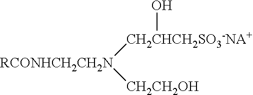

Amphoteric Sulfonate

wherein R is an acyclic hydrophobic group containing from about 8 to 18 carbon atoms and M is a cation to neutralize the charge of the anion, generally sodium. Commercially prominent imidazoline-derived amphoterics that can be employed in the present compositions include for example: Cocoamphopropionate, Cocoamphocarboxy-propionate, Cocoamphoglycinate, Cocoamphocarboxy-glycinate, Cocoamphopropyl-sulfonate, and Cocoamphocarboxy-propionic acid. A particularly preferred amphoteric is disodium cocoamphodipropionate, commercially available as Mackam 2CSF. Amphocarboxylic acids can be produced from fatty imidazolines in which the dicarboxylic acid functionality of the amphodicarboxylic acid is diacetic acid or dipropionic acid.

The carboxymethylated compounds (glycinates) described herein above frequently are called betaines. Betaines are a special class of amphoteric discussed herein below in the section entitled, Zwitterion Surfactants.

Long chain N-alkylamino acids are readily prepared by reaction RNH₂, in which R═C₈-C₁₈ straight or branched chain alkyl, fatty amines with halogenated carboxylic acids. Alkylation of the primary amino groups of an amino acid leads to secondary and tertiary amines. Alkyl substituents may have additional amino groups that provide more than one reactive nitrogen center. Most commercial N-alkylamine acids are alkyl derivatives of beta-alanine or beta-N(2-carboxyethyl) alanine. Examples of commercial N-alkylamino acid ampholytes having application in this disclosure include alkyl beta-amino dipropionates, RN(C₂H₄COOM)₂ and RNHC₂H₄COOM. In an embodiment, R can be an acyclic hydrophobic group containing from about 8 to about 18 carbon atoms, and M is a cation to neutralize the charge of the anion.

Suitable amphoteric surfactants include those derived from coconut products such as coconut oil or coconut fatty acid. Additional suitable coconut derived surfactants include as part of their structure an ethylenediamine moiety, an alkanolamide moiety, an amino acid moiety, e.g., glycine, or a combination thereof; and an aliphatic substituent of from about 8 to 18 (e.g., 12) carbon atoms. Such a surfactant can also be considered an alkyl amphodicarboxylic acid. These amphoteric surfactants can include chemical structures represented as: C₁₂-alkyl-C(O)—NH—CH₂—CH₂—N+(CH₂—CH₂—CO₂Na)₂—CH₂—CH₂—OH or C₁₂-alkyl-C(O)—N(H)—CH₂—CH₂—N+(CH₂—CO₂Na)₂—CH₂—CH₂—OH. Disodium cocoampho dipropionate is one suitable amphoteric surfactant and is commercially available under the tradename Miranol™ FBS from Rhodia Inc., Cranbury, N.J. Another suitable coconut derived amphoteric surfactant with the chemical name disodium cocoampho diacetate is sold under the tradename Mirataine™ JCHA, also from Rhodia Inc., Cranbury, N.J.

A typical listing of amphoteric classes, and species of these surfactants, is given in U.S. Pat. No. 3,929,678 issued to Laughlin and Heuring on Dec. 30, 1975. Further examples are given in “Surface Active Agents and Detergents” (Vol. I and II by Schwartz, Perry and Berch). Each of these references are herein incorporated by reference in their entirety.

Zwitterionic Surfactants

Zwitterionic surfactants can be thought of as a subset of the amphoteric surfactants and can include an anionic charge. Zwitterionic surfactants can be broadly described as derivatives of secondary and tertiary amines, derivatives of heterocyclic secondary and tertiary amines, or derivatives of quaternary ammonium, quaternary phosphonium or tertiary sulfonium compounds. Typically, a zwitterionic surfactant includes a positive charged quaternary ammonium or, in some cases, a sulfonium or phosphonium ion; a negative charged carboxyl group; and an alkyl group. Zwitterionics generally contain cationic and anionic groups which ionize to a nearly equal degree in the isoelectric region of the molecule and which can develop strong “inner-salt” attraction between positive-negative charge centers. Examples of such zwitterionic synthetic surfactants include derivatives of aliphatic quaternary ammonium, phosphonium, and sulfonium compounds, in which the aliphatic radicals can be straight chain or branched, and wherein one of the aliphatic substituents contains from 8 to 18 carbon atoms and one contains an anionic water solubilizing group, e.g., carboxy, sulfonate, sulfate, phosphate, or phosphonate.

Betaine and sultaine surfactants are exemplary zwitterionic surfactants for use herein. A general formula for these compounds is:

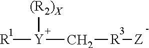

wherein R¹ contains an alkyl, alkenyl, or hydroxyalkyl radical of from 8 to 18 carbon atoms having from 0 to 10 ethylene oxide moieties and from 0 to 1 glyceryl moiety; Y is selected from the group consisting of nitrogen, phosphorus, and sulfur atoms; R² is an alkyl or monohydroxy alkyl group containing 1 to 3 carbon atoms; x is 1 when Y is a sulfur atom and 2 when Y is a nitrogen or phosphorus atom, R³ is an alkylene or hydroxy alkylene or hydroxy alkylene of from 1 to 4 carbon atoms and Z is a radical selected from the group consisting of carboxylate, sulfonate, sulfate, phosphonate, and phosphate groups.

Examples of zwitterionic surfactants having the structures listed above include: 4-[N,N-di(2-hydroxyethyl)-N-octadecylammonio]-butane-1-carboxylate; 5-[S-3-hydroxypropyl-S-hexadecylsulfonio]-3-hydroxypentane-1-sulfate; 3-[P,P-diethyl-P-3,6,9-trioxatetracosanephosphonio]-2-hydroxypropane-1-phosphate; 3-[N,N-dipropyl-N-3-dodecoxy-2-hydroxypropyl-ammonio]-propane-1-phosphonate; 3-(N,N-dimethyl-N-hexadecylammonio)-propane-1-sulfonate; 3-(N,N-dimethyl-N-hexadecylammonio)-2-hydroxy-propane-1-sulfonate; 4-[N,N-di(2(2-hydroxyethyl)-N(2-hydroxydodecyl)ammonio]-butane-1-carboxylate; 3-[S-ethyl-S-(3-dodecoxy-2-hydroxypropyl)sulfonio]-propane-1-phosphate; 3-[P,P-dimethyl-P-dodecylphosphonio]-propane-1-phosphonate; and S[N,N-di(3-hydroxypropyl)-N-hexadecylammonio]-2-hydroxy-pentane-1-sulfate. The alkyl groups contained in said detergent surfactants can be straight or branched and saturated or unsaturated.

The zwitterionic surfactant suitable for use in the present compositions includes a betaine of the general structure:

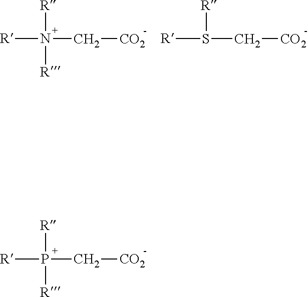

These surfactant betaines typically do not exhibit strong cationic or anionic characters at pH extremes, nor do they show reduced water solubility in their isoelectric range. Unlike “external” quaternary ammonium salts, betaines are compatible with anionics. Examples of suitable betaines include coconut acylamidopropyldimethyl betaine; hexadecyl dimethyl betaine; C₁₂₋₁₄ acylamidopropylbetaine; C₈₋₁₄ acylamidohexyldiethyl betaine; 4-C₁₄₋₁₆ acylmethylamidodiethylammonio-1-carboxybutane; C₁₆₋₁₈ acylamidodimethylbetaine; C₁₂₋₁₆ acylamidopentanediethylbetaine; and C₁₂₋₁₆ acylmethylamidodimethylbetaine.

Sultaines useful in the present disclosure include those compounds having the formula (R(R¹)₂N⁺R²SO³⁻, in which R is a C₆-C₁₈ hydrocarbyl group, each R¹ is typically independently C₁-C₃ alkyl, e.g., methyl, and R² is a C₁-C₆ hydrocarbyl group, e.g., a C₁-C₃ alkylene or hydroxyalkylene group.

A typical listing of zwitterionic classes, and species of these surfactants, is given in U.S. Pat. No. 3,929,678 issued to Laughlin and Heuring on Dec. 30, 1975. Further examples are given in “Surface Active Agents and Detergents” (Vol. I and II by Schwartz, Perry and Berch). Each of these references are herein incorporated in their entirety.

Amine Softening Agent

The compositions can optionally include one or more cationic amine softening agents. In an embodiment, the one or more of the cationic amine softening agents are included in the composition in an amount of from about 0 wt. % to about 80 wt. %, 10 wt. % to about 80 wt. %, 15 wt. % to about 80 wt. %, from about 15 wt. % to about 60 wt. %, from about 25 wt. % to about 60 wt. %, from about 25 wt. % to about 55 wt. % by weight based on the total weight of the solid laundry softening composition. In an embodiment, the compositions are free of quaternary ammonium compounds or amine softening agents.

Suitable cationic amines include but are not limited to N-(3-aminopropyl)-N-dodecylpropane-1,3-diamine, N-(3-aminopropyl)-N-dodecylpropane-1,3-diamine, N, N-Bis (3-aminopropyl) dodecylamine, N1,N1,N3-tris(3-aminopropyl)-N3-dodecylpropane-1,3-diamine, N1,N1-bis(3-aminopropyl)-N3-dodecylpropane-1,3-diamine, N1-(3-aminopropyl)-N3-dodecylpropane-1,3-diamine, N-dodecylpropane-1,3-diamine, among others. Suitable cationic amine compounds are available by the trade names Lonzabac 12, Lonzabac 12.30, Cotilps 739, Tomamine DA-17, Tomamine DA-14, Tomamine DA-1618, Tomamine DA-1214, and the like.

More particularly, suitable triamines include N,N-bis(3-aminopropyl)-octylamine, N,N-bis(3-aminopropyl)-dodecylamine, 4-aminomethyl-1,8-octanediamine, 1,3,5-tris-(aminomethyl)-benzene, 1,3,5-tris-(aminomethyl)-cyclohexane, tris-(2-aminoethyl)-amine, tris-(2-aminopropyl)-amine, tris-(3 aminopropyl)-amine, or a combination thereof.

Suitable ether diamines include, but are not limited to hexyloxypropyl amine, 2-Ethylhexyloxypropyl amine, octyl/decyloxypropyl amine, isodecyloxypropyl amine, dodecyl/tetradecyloxypropyl amine, isotridecyloxypropyl amine, tetradecyl/dodecyloxypropyl amine, linear alkyloxypropyl amines, or a combination thereof.

Suitable aliphatic diamines include but are not limited to bis (2-aminoethyl) ether, 3,6-dioxoctane-1,8-diamine, 4,7-dioxadecane-1,10-diamine, 4,7-dioxadecane-2, 9-diamine, 4,9-dioxadodecane-1,12-diamine, 5,8-dioxadodecane-3,10-diamine, 4,7,10-trioxatridecane-1,13-diamine and higher oligomers of these diamines, bis-(3-aminopropyl) polytetrahydrofurans and other polytetrahydrofuran-diamines, as well as polyoxyalkylene-diamines. Suitable ether diamines include, but are not limited to isotridecyloxypropyl-1,3-diaminopropane, octyl/decyloxypropyl-1,3-diaminopropane, isodecyloxypropyl-1,3-diaminopropane, dodecyl/tetradecyloxypropyl-1, 3-diaminopropane, or a combination thereof.

Suitable ethoxylated amines include but are not limited to bis-(2-hydroxyethyl) isodecyloxypropylamine, poly (5) oxyethylene isodecyloxypropylamine, bis-(2-hydroxyethyl) isotridecyloxypropylamine, poly (5) oxyethylene isotridecyloxypropylamine, bis-(2-hydroxyethyl) tallow amine (including 5 and 15-mole adducts), N-tallow-poly (3) oxyethylene-1,3-diaminopropane, or a combination thereof.

Preferred cationic multi-branched amine surfactants include, but are not limited to: N, N-Bis (3-aminopropyl) dodecylamine; N1,N1,N3-tris(3-aminopropyl)-N3-dodecylpropane-1,3-diamine; N1,N1-bis(3-aminopropyl)-N3-dodecylpropane-1,3-diamine; N1-(3-aminopropyl)-N3-dodecylpropane-1,3-diamine; N-dodecylpropane-1,3-diamine; isotridecyloxypropyl-1,3-diaminopropane; dimethyltetradecylamine oxide, lauramine oxide, or a mixture thereof.

Silicone Compound

The compositions may optionally include a silicone compound. When present, the silicone compound comprises a volatile silicone, a curable silicone, or a mixture thereof. In a preferred embodiment, the silicone is hydrophobic. When present, the one or more silicone compounds may be present in an amount of between about 0 wt. % to about 99 wt. %, between about 0.005 wt. % to about 95 wt. %, between about 0.01 wt. % to about 90 wt. %, or between about 0.015 wt. % to about 90 wt. %, inclusive of all integers within these ranges.

Suitable silicones include those according to the general formula

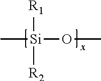

wherein, each R₁ and R₂ in each repeating unit, —(Si(R₁)(R₂)O)—, are independently selected from a C₁-C₁₀ alkyl or alkenyl radicals, phenyl, substituted alkyl, substituted phenyl, or units of —[—R₁R₂Si—O—]—; x is a number from 50 to 300,000, preferably from 100 to 100,000, more preferably from 200 to 50,000, wherein, the substituted alkyl or substituted phenyl are typically substituted with halogen, amino, hydroxyl groups, quaternary ammonium groups, polyalkoxy groups, carboxyl groups, or nitro groups, and wherein the silicone polymer is terminated by a hydroxyl group, hydrogen or —SiR₃, wherein, R₃ is hydroxyl, hydrogen, methyl or a functional group.

Preferably, the silicone is polydimethylsiloxane (PDMS) or an emulsion thereof. The silicone typically has an average molecular weight, as measured by viscosity, of from 5,000 cst to 5,000,000 cst, or from 7,500 cst to 1,000,000 cst or even from 10,000 cst to 600,000 cst. Silicones particularly suitable for textile softening and cleaning are described in WO 03/097778, which is herein incorporated by reference in its entirety.

The silicone may be a cationic silicone polymer, such as those described in WO 02/18528, amino-silicones, such as those described in U.S. Pat. Nos. 4,891,166, 5,593,611 and 4,800,026; quaternary-silicones, such as those described in U.S. Pat. No. 4,448,810; high-viscosity silicones, such as those described in WO 00/71806 and WO 00/71807; modified polydimethyl siloxanes; functionalized polydimethyl siloxanes such as those described in U.S. Pat. Nos. 5,668,102 and 6,136,215 including, for example polydimethyl siloxanes comprising a pendant amino functionality; cationic amino-silicones; silicone amino-esters; biodegradable organo-silicones such as those described in WO 01/23394; polyquaternary polysiloxane polymers, cationic silicones comprising repeating N⁺ units; amino-silicones comprising pendant EO/PO and epoxy glucamine side chains; coated amino-silicones; or block copolymers of polydimethyl siloxane and EO/PO units, as described in WO 97/32917. Each of these documents is herein incorporated by reference in their entirety.

In some embodiments, the silicone may also comprise a mixture of two or more different types of silicone. For example, the silicone may be a mixture of a high-viscosity silicone and a low viscosity silicone. The silicone may comprise a mixture of a functionalized silicone and a non-functionalized silicone.

In some embodiments the silicone is provided in the form of an emulsion and has an average primary particle size of from 1 micrometer to 5,000 micrometers, preferably from 1 micrometer to 50 micrometers. Beneficially, such silicone emulsions are easily deposited onto textile surfaces during the laundering process. Commercially available silicone oils that are suitable for use are DC200™ (12,500 cst to 600,000 cst), supplied by Dow Corning. Alternatively, preformed silicone emulsions are also suitable for use. These emulsions may comprise water or other solvents in an effective amount to aid in the emulsion.

Suitable volatile silicones include but are not limited to dimethyl silicone. Preferred curable silicones include, but are not limited to, an aminosilicone, a phenyl silicone, and a hydroxysilicone. Examples of suitable silicones include, but are not limited to, silicones such as dimethyl silicone, glycol polysiloxane, methylphenol polysiloxane, trialkyl or tetralkyl silanes, hydrophobic silica compounds, alkali metal silicates, metal silicates, and combinations thereof can all be used in defoaming applications. Commercial defoamers commonly available include silicones such as ARDEFOAM™ from Armour Industrial Chemical Company which is a silicone bound in an organic emulsion; FOAM KILL™ or KRESSEO™ available from Krusable Chemical Company which are silicone and non-silicone type defoamers as well as silicone esters; and ANTI-FOAM ATM and DC-200 from Dow Corning Corporation which are both food grade type silicones among others.

In some embodiments, the silicone is an amino alkyl functionalized silicone; an amino alkyl functionalized MQ silicone; an unreacted MQ silicone; a siloxane or silicone blend; a silicone polyvinyl acetate; a silicone polyvinyl acetate neutralized with ammonium hydroxide; or a silicone functionalized acrylic. Suitable functionalized silicones include, but are not limited to oil-in-water emulsions of polydimethylsiloxane, polyorganosiloxane diamines, silicone impregnating agents, and the like.

The polydiorganosiloxane diamines of formula HR⁴N—Y¹-Q¹-Y¹—NR⁴H can be formed using methods such as those described, for example, in U.S. Pat. No. 5,314,748, which is herein incorporated by reference in its entirety. Polydiorganosiloxane diamines also are commercially available under the trade names DMS-A11 (molecular weight 850 to 900 Da), DMS-A32 (molecular weight about 30,000 Da), and DMS-A35 (molecular weight about 50,000 Da) and those sold under the trade names WACKER FLUID (e.g., WACKER FLUID NH 130 D (molecular weight 9,500 to 12,000 Da), NH 30 D (molecular weight 2400 to 3400 Da), and NH 15 D (950 to 1200 Da)), including Wacker® HC 303, Wacker® HC 321, Wacker® HC 401, Wacker® MQ-RESIN POWDER 803 TF, Wacker® HC 103, and Wacker® HC 130. Other suitable silicones include those sold under the trade names DOWSIL™ MQ-1640 Flake Resin; DOWSIL™ FA 4002 ID Silicone Acrylate; TEGOTOP® 210; and BELSIL® P 1101.

Alkalinity Source

The compositions disclosed herein may include an alkalinity source to improve soil removal efficacy. The alkalinity source can include an alkali metal carbonate, an alkali metal hydroxide, alkaline metal silicate, alkaline metal metasilicate, or a combination thereof. Suitable metal carbonates that can be used include, for example, sodium or potassium carbonate, bicarbonate, sesquicarbonate, or a combination thereof. Suitable alkali metal hydroxides that can be used include, for example, sodium, lithium, or potassium hydroxide. Examples ofuseful alkaline metal silicates include sodium or potassium silicate (with M₂O:SiO₂ ratio of 2.4 to 5:1, M representing an alkali metal) or metasilicate. A metasilicate can be made by mixing a hydroxide and silicate. The alkalinity source may also include a metal borate such as sodium or potassium borate, and the like.

The alkalinity source may also include ethanolamines, urea sulfate, amines, amine salts, and quaternary ammonium. The simplest cationic amines, amine salts and quaternary ammonium compounds can be schematically drawn thus:

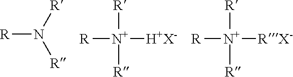

in which, R represents a long alkyl chain, R′, R″, and R′″ may be either long alkyl chains or smaller alkyl or aryl groups or hydrogen and X represents an anion.

In some embodiments, the compositions are free of an alkalinity source.

pH Modifier

The multiple charged cationic polymer composition can further comprise a pH modifier. The composition can comprise from about 0.1 wt. % to about 20 wt. %, from about 0.5 wt. % to about 10 wt. %, or from about 0.5 wt. % to about 5 wt. % of a pH modifier, based on total weight of the composition. Suitable pH modifiers include, but are not limited to, alkali hydroxides, alkali carbonates, alkali bicarbonates, alkaline earth metal hydroxides, alkaline earth metal carbonates, alkaline earth metal bicarbonates and mixtures or combinations thereof. Exemplary pH modifiers include sodium hydroxide, potassium hydroxide, calcium hydroxide, calcium oxide, sodium carbonate, potassium carbonate, sodium bicarbonate, potassium bicarbonate, magnesium oxide, and magnesium hydroxide.

Water Conditioning Agent

The cleaning compositions can optionally include a water conditioning agent. Water conditioning agents aid in removing metal compounds and in reducing harmful effects of hardness components in service water. Exemplary water conditioning agents include antiredeposition agents, chelating agents, sequestering agents and inhibitors. Polyvalent metal cations or compounds such as a calcium, a magnesium, an iron, a manganese, a molybdenum, etc. cation or compound, or mixtures thereof, can be present in service water and in complex soils. Such compounds or cations can interfere with the effectiveness of a washing or rinsing compositions during a cleaning application. A water conditioning agent can effectively complex and remove such compounds or cations from soiled surfaces and can reduce or eliminate the inappropriate interaction with active ingredients including the nonionic surfactants and anionic surfactants of the disclosure. Both organic and inorganic water conditioning agents can be used in the cleaning compositions.

Suitable organic water conditioning agents can include both polymeric and small molecule water conditioning agents. Organic small molecule water conditioning agents are typically organocarboxylate compounds or organophosphate water conditioning agents. Polymeric inhibitors commonly comprise polyanionic compositions such as polyacrylic acid compounds. More recently the use of sodium carboxymethyl cellulose as an antiredeposition agent was discovered. This is discussed more extensively in U.S. Pat. No. 8,729,006 to Miralles et al., which is incorporated herein in its entirety.

Small molecule organic water conditioning agents include, but are not limited to: sodium gluconate, sodium glucoheptonate, N-hydroxyethylenediaminetriacetic acid (HEDTA), ethylenediaminetetraacetic acid (EDTA), nitrilotriacetic acid (NTA), diethylenetriaminepentaacetic acid (DTPA), ethylenediaminetetrapropionic acid, triethylenetetraaminehexaacetic acid (TTHA), and the respective alkali metal, ammonium and substituted ammonium salts thereof, ethylenediaminetetraacetic acid tetrasodium salt (EDTA), nitrilotriacetic acid trisodium salt (NTA), ethanol diglycine disodium salt (EDG), dimethanol glycine sodium salt (DEG), and 1,3-propylenediaminetetraacetic acid (PDTA), dicarboxymethyl glutamic acid tetrasodium salt (GLDA), methylglycine-N—N-diacetic acid trisodium salt (MGDA), and iminodisuccinate sodium salt (IDS). All of these are known and commercially available.

Suitable inorganic water conditioning agents include, but are not limited to, sodium tripolyphosphate and other higher linear and cyclic polyphosphates species.

Alkylpolysaccharide

In some embodiments the compositions optionally include one or more alkylpolysaccharides, particularly alkylpolyglucosides. When present, the compositions include an alkylpolysaccharide in an amount of between about 0.01 wt. % to about 15 wt. %, between about 0.5 wt. % to about 12 wt. %, or between about 1 wt. % to about 5 wt. %, inclusive of all integers within these ranges.

Examples of suitable alkyl polysaccharides are alkyl polyglucosides having the formula:

R²O(CH₂ₙO)ₜ(Z)ₓ Formula (II)

wherein Z is derived from glucose, R² is a hydrophobic group such as an alkyl, alkyl phenyl, hydroxyalkyl, hydroxyalkylphenyl group, or a combination thereof, in which said alkyl groups contain from about 10 to about 18, preferably from 12 to 16 carbon atoms; n is 2-6, t is from 0 to about 10; and x is from 0 to about 10, preferably from 1 to 4, most preferably from 1.4.

Preferred alkyl polyglycosides are alkyl polyglycosides having the formula:

R₁O(R₂O)_{b}(Z)ₐ Formula (III)

wherein Z is glucose or a glucose residue and b is zero. Such alkyl polyglycosides are commercially available, for example, as Glucopon® or Plantaren® surfactants from Henkel Corporation. Examples of such surfactants include but are not limited to Glucopon® 225, an alkyl polyglycoside in which the alkyl group contains 8 to 10 carbon atoms and has an average degree of polymerization of 1.7; Glucopon® 425, an alkyl polyglycoside in which the alkyl group contains 8 to 16 carbon atoms and has an average degree of polymerization of 1.6; Glucopon® 625, an alkyl polyglycoside in which the alkyl group contains 12 to 16 carbon atoms and has an average degree of polymerization of 1.6; APG® 325, an alkyl polyglycoside in which the alkyl group contains 9 to 11 carbon atoms and has an average degree of polymerization of 1.6; Glucopon® 600, an alkyl polyglycoside in which the alkyl group contains 12 to 16 carbon atoms and has an average degree of polymerization of 1.4; Plantaren® 2000, a C₈-C₁₈ alkyl polyglycoside in which the alkyl group contains 8 to 16 carbon atoms and has an average degree of polymerization of 1.4; Plantaren® 1300, a C₁₂-C₁₆ alkyl polyglycoside in which the alkyl group contains 12 to 16 carbon atoms and has an average degree of polymerization of 1.6; and combinations thereof.

Builders/Chelating and Sequestering Agents

The compositions can also include effective amounts of chelating/sequestering agents, also referred to as builders. In addition, the cleaning compositions may optionally include one or more additional builders as a functional ingredient. In general, a chelating agent is a molecule capable of coordinating (i.e., binding) the metal ions commonly found in water sources to prevent the metal ions from interfering with the action of the other ingredients of a rinse aid or other cleaning composition. The chelating/sequestering agent may also function as a water conditioning agent when included in an effective amount.

Often, the cleaning composition is also phosphate-free or sulfate-free. In embodiments, the cleaning compositions can be phosphate-free, the additional functional materials, including builders exclude phosphorous-containing compounds such as condensed phosphates and phosphonates.

Suitable additional builders include aminocarboxylates and polycarboxylates. Some examples of aminocarboxylates useful as chelating/sequestering agents, include, N-hydroxyethyliminodiacetic acid, nitrilotriacetic acid (NTA), ethylenediaminetetraacetic acid (EDTA), N-hydroxyethyl-ethylenediaminetriacetic acid (HEDTA), diethylenetriaminepentaacetic acid (DTPA), and the like. Some examples of polymeric polycarboxylates suitable for use as sequestering agents include those having a pendant carboxylate (—CO₂) groups and include, for example, polyacrylic acid, maleic/olefin copolymer, acrylic/maleic copolymer, polymethacrylic acid, acrylic acid-methacrylic acid copolymers, hydrolyzed polyacrylamide, hydrolyzed polymethacrylamide, hydrolyzed polyamide-methacrylamide copolymers, hydrolyzed polyacrylonitrile, hydrolyzed polymethacrylonitrile, hydrolyzed acrylonitrile-methacrylonitrile copolymers, and the like.

In embodiments, the cleaning composition is not phosphate-free and may include added chelating/sequestering agents comprising phosphates, such as a condensed phosphate, a phosphonate, and the like. Some examples of condensed phosphates include sodium and potassium orthophosphate, sodium and potassium pyrophosphate, sodium tripolyphosphate, sodium hexametaphosphate, and the like. A condensed phosphate may also assist, to a limited extent, in solidification of the composition by fixing the free water present in the composition as water of hydration.

In embodiments of the cleaning composition which are not phosphate-free, the composition may include a phosphonate such as 1-hydroxyethane-1,1-diphosphonic acid CH₃C(OH)[PO(OH)₂ ]2; aminotri(methylene phosphonic acid) N[CH₂PO(OH)₂]₃; aminotri(methylene phosphonate), sodium salt

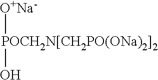

2-hydroxyethyliminobis(methylene phosphonic acid) HOCH₂CH₂N[CH₂PO(OH)₂]₂; diethylenetriamine penta(methylene phosphonic acid) (HO)₂POCH₂N[CH₂N[CH₂PO(OH)₂]₂]₂; diethylenetriamine penta(methylene phosphonate), sodium salt C₉H₍₂₈₋ₓ₎N₃NaₓO₁₅P₅ (x=7); hexamethylenediamine(tetramethylene phosphonate), potassium salt C₁₀H₍₂₈₋ₓ₎N₂KₓO₁₂P₄ (x=6); bis(hexamethylene)triamine(pentamethylene phosphonic acid) (HO₂)POCH₂N[(CH₂)₆N[CH₂PO(OH)₂]₂]₂; and phosphorus acid H₃PO₃. In some embodiments, a phosphonate combination such as ATMP and DTPMP may be used. A neutralized or alkaline phosphonate, or a combination of the phosphonate with an alkali source prior to being added into the mixture such that there is little or no heat or gas generated by a neutralization reaction when the phosphonate is added can be used.

For a further discussion of chelating agents/sequestrants, see Kirk-Othmer, Encyclopedia of Chemical Technology, Third Edition, volume 5, pages 339-366 and volume 23, pages 319-320, the disclosure of which is incorporated by reference herein.

When present, the compositions include from about 0.1 wt. % to about 15 wt. % of one or more chelants, including from about 1 wt. % to about 10 wt. % chelant, from about 1 wt. % to about 5 wt. % chelant, inclusive of all integers within the defined range.

Defoaming Agent

The cleaning compositions employed in some of the cleaning steps can comprise a defoamer. Defoaming agents include a variety of different materials adapted for defoaming a variety of compositions. Defoaming agents can comprise an anionic or nonionic material such as polyethylene glycol, polypropylene glycol, fatty acids and fatty acid derivatives, fatty acid sulfates, phosphate esters, sulfonated materials, silicone-based compositions, and others.

Preferred silicone defoaming agents can include a polydialkylsiloxane, such as polydimethylsiloxane, or a silicone emulsion such as silicone emulsion. In some embodiments, silicone based defoaming agents can be combined with silica, including, for example silica, fumed silica, derivatized silica, and silanized silica.

Preferred fatty acid defoaming agents can comprise simple alkali metal or alkaline earth metal salts of a fatty acid or fatty acid derivatives. Examples of such derivatives include mono, di- and tri-fatty acid esters of polyhydroxy compounds such as ethylene glycol, glycerin, propylene glycol, hexylene glycol, etc. Preferably such defoaming agents comprise a fatty acid monoester of glycerol. Fatty acids useful in such defoaming compositions can include any C₈₋₂₄ saturated or unsaturated, branched or unbranched mono or polymeric fatty acid and salts thereof, including for example myristic acid, palmitic acid, stearic acid, behenic acid, lignoceric acid, palmitoleic acid, oleic acid, linoleic acid, arachidonic acid, and others commonly available.

Other suitable defoaming agents include water insoluble waxes, preferably microcrystalline wax, petroleum wax, synthetic petroleum wax, rice base wax, beeswax having a melting point in the range from about 35° C. to 125° C. with a low saponification value, white oils, etc.

When a defoaming agent is added it can be added in an amount suitable to reduce foam to the desired amount. Thus, the amount of defoaming agent added can depend on the other ingredients in the formulation.

Enzyme

Embodiments of the disclosure can include the use of one or more enzymes. The one or more enzymes can comprise a protease. The one or more enzymes can comprise an amylase. In certain embodiments, the methods employ a protease and an amylase. The enzymes can be included in a cleaning composition in any step of the methods. In some preferred embodiments, the enzymes are in a booster composition used in the pre-wash step or in its own step.

Protease enzymes are particularly advantageous for cleaning soils containing protein, such as blood, cutaneous scales, mucus, grass, food (e.g., egg, milk, spinach, meat residue, tomato sauce), or the like. Additionally, proteases have the ability to retain their activity at elevated temperatures. Protease enzymes are capable of cleaving macromolecular protein links of amino acid residues and convert substrates into small fragments that are readily dissolved or dispersed into the aqueous use solution. Proteases are often referred to as detersive enzymes due to the ability to break soils through the chemical reaction known as hydrolysis. Protease enzymes can be obtained, for example, from Bacillus subtilis, Bacillus lichenformis and Streptomyces griseus. Protease enzymes are also commercially available as serine endoproteases.

Examples of commercially available protease enzymes are available under the following trade names: Esperase, Purafect, Purafect L, Purafect Ox, Everlase, Liquanase, Savinase, Prime L, Prosperase and Blap.

The enzyme compositions can be an independent entity or may be formulated in combination with a cleaning composition. According to an embodiment, an enzyme composition may be formulated into the cleaning compositions in either liquid or solid formulations. In addition, enzyme compositions may be formulated into various delayed or controlled release formulations. For example, a solid molded cleaning composition may be prepared without the addition of heat. As a skilled artisan will appreciate, enzymes tend to become denatured by the application of heat and therefore use of enzymes within cleaning compositions require methods of forming a cleaning composition that does not rely upon heat as a step in the formation process, such as solidification. Enzymes can improve cleaning in cold water wash conditions. Further, cold water wash conditions can ensure the enzymes are not thermally denatured.

The enzyme composition may further be obtained commercially in a solid (i.e., puck, powder, etc.) or liquid formulation. Commercially available enzymes are generally combined with stabilizers, buffers, cofactors and inert vehicles. The actual active enzyme content depends upon the method of manufacture, which is well known to a skilled artisan and such methods of manufacture are not critical to the present disclosure.

Alternatively, the enzyme composition may be provided separate from the cleaning composition, such as added directly to the wash liquor or wash water of a particular application of use, e.g., laundry machine or dishwasher.

Additional description of enzyme compositions suitable for use in the cleaning methods is disclosed for example in U.S. Pat. Nos. 7,670,549, 7,723,281, 7,670,549, 7,553,806, 7,491,362, 6,638,902, 6,624,132, and 6,197,739 and U.S. Patent Publication Nos. 2012/0046211 and 2004/0072714, each of which are herein incorporated by reference in its entirety. In addition, the reference “Industrial Enzymes”, Scott, D., in Kirk-Othmer Encyclopedia of Chemical Technology, 3rd Edition, (editors Grayson, M. and EcKroth, D.) Vol. 9, pp. 173-224, John Wiley & Sons, New York, 1980 is incorporated herein in its entirety.

Enzyme Stabilizer

The cleaning compositions and methods can optionally include enzyme stabilizers (or stabilizing agent(s)) which may be dispensed manually or automatically into a use solution of the cleaning composition or enzyme composition. In the alternative, a stabilizing agent and enzyme may be formulated directly into the cleaning compositions. The formulations of the cleaning compositions or the enzyme composition may vary based upon the particular enzymes or stabilizing agents employed.

In an aspect, the stabilizing agent is a starch, poly sugar, amine, amide, polyamide, or poly amine. In still further aspects, the stabilizing agent may be a combination of any of the aforementioned stabilizing agents. In an embodiment, the stabilizing agent may include a starch and optionally an additional food soil component (e.g., fat or protein). In an aspect, the stabilizing agent is a poly sugar. Beneficially, poly sugars are biodegradable and often classified as Generally Recognized As Safe (GRAS). Exemplary poly sugars include, but are not limited to amylose, amylopectin, pectin, inulin, modified inulin, potato starch, modified potato starch, corn starch, modified corn starch, wheat starch, modified wheat starch, rice starch, modified rice starch, cellulose, modified cellulose, dextrin, dextran, maltodextrin, cyclodextrin, glycogen, oligofructose and other soluble starches. Particularly suitable poly sugars include, but are not limited to inulin, carboxymethyl inulin, potato starch, sodium carboxymethylcellulose, linear sulfonated alpha-(1,4)-linked D-glucose polymers, gamma-cyclodextrin and the like. Combinations of poly sugars may also be used according to embodiments of the disclosure.

The stabilizing agent according to the disclosure may be an independent entity or may be formulated in combination with the cleaning composition or enzyme composition. According to an embodiment of the disclosure, a stabilizing agent may be formulated into the cleaning composition (with or without the enzyme) in either liquid or solid formulations. In addition, stabilizing agent compositions may be formulated into various delayed or controlled release formulations. For example, a solid molded cleaning composition may be prepared without the addition of heat. Alternatively, the stabilizing agent may be provided separate from the detergent or enzyme composition, such as added directly to the wash liquor or wash water of a particular application of use, e.g., dishwasher.

Stabilizing Agent

The compositions may optionally include at least one stabilizing agent, such as a carrier or solvent. Suitable solvents for the detergent compositions include water and other solvents such as lipophilic fluids. Examples of suitable lipophilic fluids include glycol ethers, glycerin derivatives such as glycerin ethers, perfluorinated amines, perfluorinated and hydrofluoroether solvents, low volatility nonfluorinated organic solvents, diol solvents, siloxanes, other silicones, hydrocarbons, other environmentally friendly solvents and mixtures thereof. In some embodiments, the solvent includes water, propylene glycol, or dipropylene glycol methyl ether.

In other aspects, examples of suitable carriers include, but are not limited to organic solvents, such as simple alkyl alcohols, e.g., ethanol, isopropanol, n-propanol, benzyl alcohol, and the like. Polyols are also useful carriers, including glycerol, sorbitol, and the like. Suitable carriers include glycol ethers. Suitable glycol ethers include diethylene glycol n-butyl ether, diethylene glycol n-propyl ether, diethylene glycol ethyl ether, diethylene glycol methyl ether, diethylene glycol t-butyl ether, dipropylene glycol n-butyl ether, dipropylene glycol methyl ether, dipropylene glycol ethyl ether, dipropylene glycol propyl ether, dipropylene glycol tert-butyl ether, ethylene glycol butyl ether, ethylene glycol propyl ether, ethylene glycol ethyl ether, ethylene glycol methyl ether, ethylene glycol methyl ether acetate, propylene glycol n-butyl ether, propylene glycol ethyl ether, propylene glycol methyl ether, propylene glycol n-propyl ether, tripropylene glycol methyl ether and tripropylene glycol n-butyl ether, ethylene glycol phenyl ether, propylene glycol phenyl ether, and the like, or mixtures thereof.

In other aspects, examples of suitable stabilizing agents include, but are not limited to borate, calcium/magnesium ions, and mixtures thereof. The concentrate need not include a stabilizing agent, but when the concentrate includes a stabilizing agent, it can be included in an amount that provides the desired level of stability of the concentrate.

In an aspect, the compositions include from about 1 wt. % to about 50 wt. % solvents or stabilizing agents, from about 5 wt. % to about 50 wt. % solvents or stabilizing agents, from about 10 wt. % to about 50 wt. % solvents or stabilizing agents, and preferably from about 10 wt. % to about 30 wt. % solvents or stabilizing agents, inclusive of all integers within these ranges.

Polycarboxylate Polymer

In some embodiments the compositions include one or more polycarboxylate polymers. A polymer can be beneficial to serve as a binder, improve performance, and inhibit crystal growth thereby preventing precipitation of carbonates. Suitable polycarboxylate polymers include but are not limited to high molecular weight polyacrylates (or polyacrylic acid homopolymers). Suitable high molecular weight polyacrylates can have a molecular weight of at least about 5000. The high molecular weight polyacrylates can contain a polymerization unit derived from the monomer selected from the group consisting of acrylic acid, methacrylic acid, methyl acrylate, methyl methacrylate, ethyl acrylate, ethyl methacrylate, butyl acrylate, butyl methacrylate, iso-butyl acrylate, iso-butyl methacrylate, iso-octyl acrylate, iso-octyl methacrylate, cyclohexyl acrylate, cyclohexyl methacrylate, glycidyl acrylate, glycidyl methacrylate, hydroxyethyl acrylate, hydroxypropyl acrylate, 2-hydroxyethyl acrylate, 2-hydroxyethyl methacrylate, 2-hydroxypropyl acrylate, 2-hydroxypropyl methacrylate and hydroxypropyl methacrylate and a mixture thereof, among which acrylic acid. Methacrylic acid, methyl acrylate, methyl methacrylate, butyl acrylate, butyl methacrylate, iso-butyl acrylate, iso-butyl methacrylate, hydroxyethyl acrylate, 2-hydroxyethyl acrylate, 2-hydroxyethyl methacrylate, 2-hydroxypropyl acrylate, and 2-hydroxypropyl methacrylate, and a mixture thereof are preferred.

The above-mentioned acrylate monomers can be selected from the group consisting of methyl acrylate, methyl methacrylate, butyl acrylate, 2-phenoxy ethyl acrylate, ethoxylated 2-phenoxy ethyl acrylate, 2-(2-ethoxyethoxy)ethyl acrylate, cyclic trimethylolpropane formal acrylate, β-carboxyethyl acrylate, lauryl(meth)acrylate, isooctyl acrylate, stearyl(meth)acrylate, isodecyl acrylate, isobornyl(meth)acrylate, benzyl acrylate, hydroxypivalyl hydroxypivalate diacrylate, ethoxylated 1,6-hexanediol diacrylate, dipropylene glycol diacrylate, ethoxylated dipropylene glycol diacrylate, neopentyl glycol diacrylate, propoxylated neopentyl glycol diacrylate, ethoxylated bisphenol-A di(meth)acrylate, 2-methyl-1,3-propanediol diacrylate, ethoxylated 2-methyl-1,3-propanediol diacrylate, 2-butyl-2-ethyl-1,3-propanediol diacrylate, ethylene glycol dimethacrylate, diethylene glycol dimethacrylate, 2-hydroxyethyl methacrylate phosphate, tris(2-hydroxy ethyl)isocyanurate triacrylate, pentaerythritol triacrylate, ethoxylated trimethylolpropane triacrylate, propoxylated trimethylolpropane triacrylate, trimethylolpropane trimethacrylate, pentaerythritol tetraacrylate, ethoxylated pentaerythritol tetraacrylate, ditrimethylolpropane tetraacrylate, propoxylated pentaerythritol tetraacrylate, pentaerythritol tetraacrylate, dipentaerythritol hexaacrylate, (meth)acrylate, hydroxyethyl acrylate (HEA), 2-hydroxyethyl methacrylate (HEMA), tripropylene glycol di(meth)acrylate-1,4-butanediol di(meth)acrylate, 1,6-hexanediol di(meth)acrylate, allylated cyclohexyl di(meth)acrylate, isocyanurate di(meth)acrylate, ethoxylated trimethylol propane tri(meth)acrylate, propoxylated glycerol tri(meth)acrylate, trimethylol propane tri(meth)acrylate, and tris(acryloxyethyl)isocyanurate, and a mixture thereof.

Preferred are polyacrylic acids, (C₃H₄O₂)ₙ or 2-Propenoic acid homopolymers; Acrylic acid polymer; Poly(acrylic acid); Propenoic acid polymer; PAA have the following structural formula:

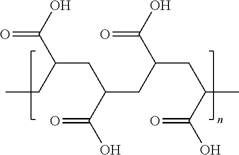

where n is any integer.

One source of commercially available polyacrylates (polyacrylic acid homopolymers) useful for the disclosure includes the Acusol 445 series from The Dow Chemical Company, Wilmington Del., USA, including, for example, Acusol® 445 (acrylic acid polymer, 48% total solids) (4500 MW), Acusol® 445N (sodium acrylate homopolymer, 45% total solids)(4500 MW), and Acusol®445ND (powdered sodium acrylate homopolymer, 93% total solids)(4500 MW) Other polyacrylates (polyacrylic acid homopolymers) commercially available from Dow Chemical Company suitable for the disclosure include, but are not limited to Acusol 929 (10,000 MW) and Acumer 1510. Yet another example of a commercially available polyacrylic acid is AQUATREAT AR-6 (100,000 MW) from AkzoNobel Strawinskylaan 2555 1077 ZZ Amsterdam Postbus 75730 1070 AS Amsterdam. Other suitable polyacrylates (polyacrylic acid homopolymers) for use in the disclosure include, but are not limited to those obtained from additional suppliers such as Aldrich Chemicals, Milwaukee, Wis., and ACROS Organics and Fine Chemicals, Pittsburgh, Pa., BASF Corporation and SNF Inc.

When present, the compositions one or more polycarboxylate polymers in an amount of between about 1 wt. % to about 10 wt. % of the composition, from about 2 wt. % to about 10 wt. % of the composition, from about 4 wt. % to about 7.5 wt. % of the composition, and more preferably about 5 wt. % of the composition, inclusive of all integers within these ranges.

Acrylic Acid Polymer

In addition, or in alternative to the polymers described herein, the compositions may include an acrylic acid polymer. As referred to herein, the acrylic acid polymer refers to a copolymer or terpolymer as disclosed herein. In addition, as used herein the term acrylic refers to acrylic or methacrylic. In an aspect, the compositions include from about 0.1 wt. % to about 15 wt. % acrylic acid polymers, from about 1 wt. % to about 10 wt. % acrylic acid polymer, from about 1 wt. % to about 10 wt. % acrylic acid polymer, preferably from about 1 wt. % to about 5 wt. % acrylic acid polymer. In addition, without being limited according to the disclosure, all ranges recited are inclusive of the numbers defining the range, including for example each integer within the defined range.

The acrylic acid polymer has at least 50 wt. % polymerized residues of acrylic monomers, preferably at least 60 wt. %, preferably at least 70 wt. %, preferably at least 80 wt. %, preferably at least 90 wt. %, or preferably at least 95 wt. %. Acrylic monomers include acrylic acids, methacrylic acids and their C₁-C₂₅ alkyl or hydroxyalkyl esters, including for example monomers of structure H₂C═C(R)CRCO₂(CH₂CH₂O)ₙ(CH(R′)CH₂O)ₘ—R″; crotonic acid, itaconic acid, fumaric acid, maleic acid, maleic anhydride, (meth)acrylamides, (meth)acrylonitrile and alkyl or hydroxyalkyl esters of crotonic acid, itaconic acid, fumaric acid or maleic acid.

The acrylic acid polymer is provided in an aqueous composition with the polymer as discrete particles dispersed therein. The acrylic polymer comprising other polymerized monomer residues, may include for example, non-ionic (meth)acrylate esters, cationic monomers, H₂C═C(R)C₆H₄C(CH₃)₂NHCO₂(CH₂CH₂O)ₙ(CH(R′)CH₂O)ₘR″, H₂C═C(R)C(O)X(CH₂CH₂O)ₙ(CH(R′)CH₂O)ₘR″—, monounsaturated dicarboxylates, vinyl esters, vinyl amides (e.g., N-vinylpyrrolidone), sulfonated acrylic monomers, vinyl sulfonic acid, vinyl halides, phosphorus-containing monomers, heterocyclic monomers, styrene and substituted styrenes. In a preferred aspect, the polymer contains no more than 5 wt. % sulfur- or phosphorus-containing monomers, preferably no more than 3 wt. %, preferably no more than 2 wt. %, preferably no more than 1 wt. %.

The acrylic acid polymer may comprise, consist of or consist essentially of polymerized residues of:

C1-C18 alkyl (meth)acrylates;

C3-C6 carboxylic acid monomers, wherein the monomer is a mono-ethylenically unsaturated compound having one or two carboxylic acid groups. For example, the monomer may include acrylic acid, methacrylic acid, maleic acid, fumaric acid, itaconic acid, maleic anhydride, crotonic acid, etc.; and monomers having the following structures H₂C═C(R)C(O)X(CH₂CH₂O)ₙ(CH(R′)CH₂O)ₘR″ or H₂2C═C(R)C₆H₄C(CH₃)₂NHCO₂(CH₂CH₂O)ₙ(CH(R′)CH₂O)ₘR″; wherein X is O or NH, R is H or CH₃, R′ is C₁-C₂ alkyl; R″ is C₈-C₂₅ alkyl, C₈-C₁₆ alkylphenyl or C₁₃-C₃₆ aralkylphenyl; n is an average number from 6-100 and m is an average number from 0-50, provided that n≥m and m+n is 6-100.

As referred to herein, alkyl groups are saturated hydrocarbyl groups which may be straight or branched. Aralkyl groups are alkyl groups substituted by aryl groups. Examples of aralkyl groups include, for example, benzyl, 2-phenylethyl and 1-phenylethyl. Aralkylphenyl groups are phenyl groups having one or more aralkyl substituents.

In an aspect, the polymer has a weight average molecular weight of at least 25,000, at least 50,000, at least 100,000, at least 150,000, preferably at least 180,000, preferably at least 200,000, preferably at least 300,000. In some cases, including cross-linked polymers, the MW can be as high as 10,000,000. In preferred aspects, the MW is less than 5,000,000, less than 2,000,000, and more preferably less than 1,000,000.

Cross-linked polymers, such as a monomer having two or more non-conjugated ethylenically unsaturated groups, included with the copolymer components during polymerization. Examples of such monomers include, di- or tri-allyl ethers and di- or tri-(meth)acrylic esters of diols or polyols (e.g., trimethylolpropane diallyl ether (TMPDE), ethylene glycol dimethacrylate), di- or tri-allyl esters of di- or tri-acids, allyl (meth)acrylate, divinyl sulfone, triallyl phosphate, divinyl aromatics (e.g., divinylbenzene). In a preferred aspect, the amount of polymerized crosslinker residue in the polymer is less than 0.3 wt. %, less than 0.2 wt. %, less than 0.1 wt. %, less than 0.05 wt. %, or less than 0.01 wt. %.

In a preferred aspect, polymerized residues may include from 40 to 65 wt. % C1-C18 alkyl (meth)acrylates; from 25 to 55 wt. % C3-C6 carboxylic acid monomers; and from 0 to 20 wt. % of monomers having the following structures H₂C═C(R)C(O)X(CH₂CH₂O)ₙ(CH(R′)CH₂O)ₘR″ or H₂2C═C(R)C₆H₄C(CH₃)₂NHCO₂(CH₂CH₂O)ₙ(CH(R′)CH₂O)ₘR″; wherein X is O or NH, R is H or CH₃, R′ is C₁-C₂ alkyl; R″ is C₈-C₂₅ alkyl, C₈-C₁₆ alkylphenyl or C₁₃-C₃₆ aralkylphenyl; n is an average number from 6-100 and m is an average number from 0-50, provided that n≥m and m+n is 6-100.

A commercially available acrylic acid polymer is a methacrylic acid/ethyl acrylate polymer (Acusol 845, Dow Chemical) which beneficially suspends both oils and metals according to the formulated compositions according to the disclosure for industrial laundering. Additional disclosure of suitable embodiments of the acrylic acid polymer is set forth in U.S. Publication Nos. 2012/0165242 and 2012/0015861, which are herein incorporated by reference in their entirety.

Colorant

The finishing composition can optionally comprise a colorant. Preferred colorants include natural and synthetic colorants or dyes. Most preferably the colorant comprises FD&C Blue 1 (Sigma Chemical), FD&C Yellow 5 (Sigma Chemical), Direct Blue 86 (Miles), Fastusol Blue (Mobay Chemical Corp.), Acid Orange 7 (American Cyanamid), Basic Violet 10 (Sandoz), Acid Yellow 23 (GAF), Acid Yellow 17 (Sigma Chemical), Sap Green (Keyston Analine and Chemical), Metanil Yellow (Keystone Analine and Chemical), Acid Blue 9 (Hilton Davis), Sandolan Blue/Acid Blue 182 (Sandoz), Hisol Fast Red (Capitol Color and Chemical), Fluorescein (Capitol Color and Chemical), Acid Green 25 (Ciba-Geigy), or a combination thereof.

In an aspect, the colorant or dye may comprise dyes which are generally recognized as safe. Suitable dyes include, but are not limited to, FDC Blue #1, FDC Blue #2, FDC Green #3, FDC Red #3, FDC Red #4, FDC Red #40, Violet #1, FDC Yellow #5, and FDC Yellow #6.

When present, the colorant may be present in an amount of between about 0.001 wt. % and about 5 wt. %, more preferably between about 0.01 wt. % and about 2 wt. %, most preferably between about 0.1 wt. % and about 1 wt. %, inclusive of all integers within this range.

Fragrance

The finishing composition can optionally comprise a fragrance. Preferred fragrances include natural and synthetic fragrances and perfumes. Most preferably the fragrance comprises terpenoids such as citronellol, aldehydes such as amyl cinnamaldehyde, a jasmine such as C1S-jasmine or jasmal, vanillin, and the like, or a mixture thereof.

Solidification Agent

If it is desirable to prepare compositions as a solid, one or more solidification agents may be included into the composition. In some embodiments, the solidification agent can form or maintain the composition as a solid rinse aid composition. In other embodiments, the solidification agent can solidify the composition without unacceptably detracting from the eventual release of the active ingredients. The solidification agent can include, for example, an organic or inorganic solid compound having a neutral inert character or making a functional, stabilizing or detersive contribution to the present composition. Suitable solidification agents include solid polyethylene glycol (PEG), solid polypropylene glycol, solid EO/PO block copolymer, amide, urea (also known as carbamide), nonionic surfactant (which can be employed with a coupler), anionic surfactant, starch that has been made water-soluble (e.g., through an acid or alkaline treatment process), cellulose that has been made water-soluble, inorganic agent, poly(maleic anhydride/methyl vinyl ether), polymethacrylic acid, other generally functional or inert materials with high melting points, mixtures thereof, and the like.

Suitable glycol solidification agents include a solid polyethylene glycol or a solid polypropylene glycol, which can, for example, have molecular weight of about 1,400 to about 30,000. In certain embodiments, the solidification agent includes or is solid PEG, for example PEG 1500 up to PEG 20,000. In certain embodiments, the PEG includes PEG 1450, PEG 3350, PEG 4500, PEG 8000, PEG 20,000, and the like. Suitable solid polyethylene glycols are commercially available from Union Carbide under the tradename CARBOWAX.

Suitable amide solidification agents include stearic monoethanolamide, lauric diethanolamide, stearic diethanolamide, stearic monoethanol amide, coco diethylene amide, an alkylamide, urea, or a combination thereof.

Suitable inorganic solidification agents include phosphate salt (e.g., alkali metal phosphate), sulfate salt (e.g., magnesium sulfate, sodium sulfate or sodium bisulfate), acetate salt (e.g., anhydrous sodium acetate), Borates (e.g., sodium borate), Silicates (e.g., the precipitated or fumed forms (e.g., Sipernat 50® available from Degussa), carbonate salt (e.g., calcium carbonate or carbonate hydrate), other known hydratable compounds, mixtures thereof, and the like. In an embodiment, the inorganic solidification agent can include organic phosphonate compound and carbonate salt, such as an E-Form composition.

When present, the one or more solidification agents may be present in an amount of between about 1 wt.-% to about 99 wt. %, between about 5 wt. % to about 90 wt. %, or between about 15% to about 70 wt. %, inclusive of all integers within these ranges.

Water

The finishing compositions preferably include water. Water can be added to solid cleaning compositions in sufficient amount for the solidification process and potentially for hydration. In a liquid composition, can be added to achieve the desired concentration or viscosity.

Water may be independently added to the finishing composition or may be provided in as a result of its presence in an aqueous material that is added to the finishing composition. For example, materials added to the finishing composition include water or in a solid embodiment, preferably, may be prepared in an aqueous premix available for reaction with the solidification agent component(s). In a solid embodiment, the water can be introduced into the to provide the finishing composition with a desired powder flow characteristic prior to solidification, and to provide a desired rate of solidification.

In general, it is expected that water may be present as a processing aid and may be removed or become water of hydration. It is expected that water may be present in the solid composition. It is expected that the water will be present in a solid finishing composition in the range of between 0 wt. % and 15 wt. %. The amount of water can be influenced by the ingredients in the particular formulation and by the type of solid the finishing composition is formulated into. For example, in pressed solids, the water may be between 2 wt. % and about 10 wt. %, preferably between about 4 wt. % and about 8 wt. %. In embodiments, the water may be provided as deionized water or as softened water.

The components used to form the solid finishing composition can include water as hydrates or hydrated forms of the binding agent, hydrates or hydrated forms of any of the other ingredients, or added aqueous medium as an aid in processing. It is expected that the aqueous medium will help provide the components with a desired viscosity for processing. In addition, it is expected that the aqueous medium may help in the solidification process when is desired to form the concentrate as a solid.

Bleaching Agent

The methods and cleaning compositions can optionally include a whitening or bleaching agent. Such can be included in a cleaning composition or part of a separate whitening/bleaching step. Suitable whitening agents include halogen-based bleaching agents and oxygen-based bleaching agents. The whitening agent can be added to the cleaning compositions; however, in some embodiments of the disclosure, the whitening agent can be used in the pre-soak or pre-treatment step so that the later laundering step may be free of bleaching agents. This can be beneficial in formulating solid cleaning compositions as there can be difficulties in formulating solid compositions with bleaching agents.

If no enzyme material is present in the compositions, a halogen-based bleach may be effectively used as ingredient in a main wash detergent. Other suitable halogen bleaches are alkali metal salts of di- and tri-chloro and di- and tri-bromo cyanuric acids. Preferred halogen-based bleaches comprise chlorine.

Some examples of classes of compounds that can act as sources of chlorine include a hypochlorite, a chlorinated phosphate, a chlorinated isocyanurate, a chlorinated melamine, a chlorinated amide, and the like, or mixtures of combinations thereof.

Some specific examples of sources of chlorine can include sodium hypochlorite, potassium hypochlorite, calcium hypochlorite, lithium hypochlorite, chlorinated trisodium phosphate, sodium dichloroisocyanurate, potassium dichloroisocyanurate, pentaisocyanurate, trichloromelamine, sulfodichloro-amide, 1,3-dichloro 5,5-dimethyl hydantoin, N-chlorosuccinimide, N,N′-dichloroazodicarbonimide, N,N′-chloroacetyl urea, N,N′-dichloro biuret, trichlorocyanuric acid and hydrates thereof, or combinations or mixtures thereof.

Suitable oxygen-based bleaches include peroxygen bleaches, such as sodium perborate (tetra- or monohydrate), sodium percarbonate or hydrogen peroxide. These are preferably used in conjunction with a bleach activator which allows the liberation of active oxygen species at a lower temperature. Numerous examples of activators of this type, often also referred to as bleach precursors, are known in the art and amply described in the literature such as U.S. Pat. Nos. 3,332,882 and 4,128,494 herein incorporated by reference. Preferred bleach activators are tetraacetyl ethylene diamine (TAED), sodium nonanoyl oxybenzene sulphonate (SNOBS), glucose pentaacetate (GPA), tetraacetylmethylene diamine (TAMD), triacetyl cyanurate, sodium sulphonyl ethyl carbonic acid ester, sodium acetyloxybenzene and the mono long-chain acyl tetraacetyl glucoses as disclosed in WO-91/10719, but other activators, such as choline sulphophenyl carbonate (CSPC), as disclosed in U.S. Pat. Nos. 4,751,015 and 4,818,426 can also be used.

Peroxybenzoic acid precursors are known in the art as described in GB-A-836,988, herein incorporated by reference. Examples of suitable precursors are phenylbenzoate, phenyl p-nitrobenzoate, o-nitrophenyl benzoate, o-carboxyphenyl benzoate, p-bromophenyl benzoate, sodium or potassium benzoyloxy benzene sulfonate and benzoic anhydride.

Preferred peroxygen bleach precursors are sodium p-benzoyloxy-benzene sulfonate, N,N,N,N-tetraacetyl ethylene diamine (TEAD), sodium nonanoyl oxybenzene sulfonate (SNOBS) and choline sulphophenyl carbonate (CSPC).

Optical Brightener

In some embodiments, an optical brightener component may be utilized in the compositions. The optical brightener can include any brightener that is capable of lessening graying and yellowing of textiles. Typically, these substances attach to the fibers and bring about a brightening action by converting invisible ultraviolet radiation into visible longer-wavelength light, the ultraviolet light absorbed from sunlight being irradiated as a pale bluish fluorescence and, together with the yellow shade of the grayed or yellowed laundry, producing pure white.

Fluorescent compounds belonging to the optical brightener family are typically aromatic or aromatic heterocyclic materials often containing condensed ring systems. An important feature of these compounds is the presence of an uninterrupted chain of conjugated double bonds associated with an aromatic ring. The number of such conjugated double bonds is dependent on substituents as well as the planarity of the fluorescent part of the molecule. Most brightener compounds are derivatives of stilbene or 4,4′-diamino stilbene, biphenyl, five membered heterocycles (triazoles, oxazoles, imidazoles, etc.) or six membered heterocycles (cumarins, naphthalamides, triazines, etc.).

Commercial optical brighteners which may be useful in the present disclosure can be classified into subgroups, which include, but are not necessarily limited to, derivatives of stilbene, pyrazoline, coumarin, carboxylic acid, methinecyanines, dibenzothiophene-5,5-dioxide, azoles, 5- and 6-membered-ring heterocycles and other miscellaneous agents. Examples of these types of brighteners are disclosed in “The Production and Application of Fluorescent Brightening Agents,” M. Zahradnik, Published by John Wiley & Sons, New York (1982), the disclosure of which is incorporated herein by reference.

Stilbene derivatives which may be useful in the present disclosure include, but are not necessarily limited to, derivatives of bis(triazinyl)amino stilbene; bisacylamino derivatives of stilbene; triazole derivatives of stilbene; oxadiazole derivatives of stilbene; oxazole derivatives of stilbene; and styryl derivatives of stilbene. In an embodiment, optical brighteners include stilbene derivatives.

In some embodiments, the optical brightener includes Tinopal CBS-X, which is commercially available through BASF Corp.

Additional optical brighteners include, but are not limited to, the classes of substance of 4,4′-diamino-2,2′-stilbenedisulfonic acids (flavonic acids), 4,4′-distyrylbiphenyls, methylumbelliferones, coumarins, dihydroquinolinones, 1,3-diarylpyrazolines, naphthalimides, benzoxazol, benzisoxazol and benzimidazol systems, and pyrene derivatives substituted by heterocycles, and the like. Suitable optical brightener levels include lower levels of from about 0.01, from about 0.05, from about 0.1 or even from about 0.2 wt. % to upper levels of 0.5 or even 0.75 wt. %.

Additional Functional Ingredients

The components of the cleaning composition can further be combined with various functional components suitable for use in laundering applications. In some embodiments, the cleaning composition including the acrylic acid polymers, water, stabilizing agents (chelants) and water conditioning polymers make up a large amount, or even substantially all of the total weight of the cleaning composition. For example, in some embodiments few or no additional functional ingredients are disposed therein.

In other embodiments, additional functional ingredients may be included in the compositions. The functional ingredients provide desired properties and functionalities to the compositions. For the purpose of this application, the term “functional ingredient” includes a material that when dispersed or dissolved in a use or concentrate solution, such as an aqueous solution, provides a beneficial property in a particular use. Some particular examples of functional materials are discussed in more detail below, although the particular materials discussed are given by way of example only, and that a broad variety of other functional ingredients may be used

Additional functional ingredients may include further defoaming agents, bleaching agents or optical brighteners, solubility modifiers, buffering agents, dye transfer inhibiting agents, dispersants, stabilizing agents, sequestrants or chelating agents to coordinate metal ions and control water hardness, fragrances or dyes, rheology modifiers or thickeners, hydrotropes or couplers, buffers, solvents and the like.

In an aspect, the compositions include from about 0 wt. % to about 25 wt. % additional functional ingredients, from about 0 wt. % to about 20 wt. % additional functional ingredients, from about 0 wt. % to about 10 wt. % additional functional ingredients, or from about 0 wt. % to about 5 wt. % additional functional ingredients, inclusive of all integers within these ranges.

### Methods of Making: Aza-Michael Addition Reaction Between a Polyamine or Polyethylenimine and Activated Olefin

Described herein are methods for contacting a polyamine or polyethylenimine with an activated olefin via aza-Michael addition to generate multiple charged cationic polymers. Specifically, the multiple charged cationic polymers disclosed herein are derived from an aza-Michael Addition Reaction between a polyamine or polyethylenimine or a polyalkyleneimine and α, β-unsaturated carbonyl compounds, preferably those containing substituted alkyl trialkyl quaternary ammonium salts.

An aliphatic amine group may undergo an aza-Michael Addition reaction when in contact with an unsaturated hydrocarbon moiety (e.g., carbon-carbon double bond) that is in proximity of an electron withdrawing group such as carbonyl, cyano, or nitro group. Specifically, the Michael addition is a reaction between nucleophiles and activated olefin and alkyne functionalities, wherein the nucleophile adds across a carbon-carbon multiple bond that is adjacent to an electron withdrawing and resonance stabilizing activating group, such as a carbonyl group. The Michael addition nucleophile is known as the “Michael donor”, the activated electrophilic olefin is known as the “Michael acceptor”, and reaction product of the two components is known as the “Michael adduct.” Examples of Michael donors include, but are not restricted to, amines, thiols, phosphines, carbanions, and alkoxides.

It was found that the Aza-Michael addition can be used to synthesize the disclosed compounds without having to use a higher temperature greater than 200° C. and high pressure greater than normal atmosphere pressure and with a high yield (greater than 98%), sometimes within about 24 hours.

Aza-Michael addition reaction can be catalyzed by a strong acid or base. In some cases, some ionic liquids can function both as reaction media and catalyst. The preferred catalyst for the Aza-Michael addition reaction to synthesize the disclosed compounds is a base. Exemplary base catalyst can be hydroxide and amines. Because the reaction to synthesize the disclosed compounds uses a polyamine or polyethylenimine that usually include a polyamine or polyethylenimine group, the primary amine group itself can function as a catalyst for the reaction. In such embodiments, no additional catalyst is necessary, or an additional catalyst is optional. Other preferred catalysts include amidine and guanidine bases.

The use of solvent or diluent for the reaction is optional. When employed, a wide range of non-acidic solvents are suitable, such as, for example, water, ethers (e.g., tetrahydrofuran (THF)), aromatic hydrocarbons (e.g., toluene and xylene), alcohols (e.g., n-butanol), esters (e.g., ethyl 3-ethoxypropionate), and the like. A wide range of solvents can be used for the reaction because the synthesis process is relatively insensitive to solvent. When solvent (or diluent) is employed, loading levels can range from as low as about 10 wt. % up to about 80 wt. % and higher. The solvent loading level can be about 0 wt. %, from about 1 wt. % to about 10 wt. %, from about 10 wt. % to about 20 wt. %, from about 20 wt. % to about 30 wt. %, from about 30 wt. % to about 40 wt. %, from about 40 wt. % to about 50 wt. %, from about 50 wt. % to about 60 wt. %, from about 60 wt. % to about 70 wt. %, from about 70 wt. % to about 80 wt. %, from about 1 wt. % to about 20 wt. %, from about 20 wt. % to about 40 wt. %, from about 40 wt. % to about 60 wt. %, from about 60 wt. % to about 80 wt. %, from about 40 wt. % to about 70 wt. %, at least about 5 wt. %, about 15 wt. %, about 25 wt. %, about 35 wt. %, about 45 wt. %, about 55 wt. %, about 65 wt. %, about 75 wt. %, or any value there between of the final reaction mixture.

Generally, the reaction can be carried out at a temperature over a wide range of temperatures. The reaction temperature can range from about 0° C. to about 150° C., more preferably from about 50° C. to about 80° C. The temperature for contacting the polyamine or polyethylenimine and activated olefin can be from about 10° C. to about 140° C., about 20° C. to about 130° C., about 30° C. to about 120° C., about 40° C. to about 110° C., about 50° C. to about 100° C., about 60° C. to about 90° C., about 70° C. to about 80° C., about 0° C. to about 20° C., about 20° C. to about 40° C., about 40° C. to about 60° C., about 60° C. to about 80° C., about 80° C. to about 100° C., about 100° C. to about 120° C., about 120° C. to about 150° C., about 5° C., about 25° C., about 45° C., about 65° C., about 85° C., about 105° C., about 125° C., about 145° C., or any value there between. The reaction temperature can be about the same from starting of the reaction to end of the reaction or can be changed from one temperature to another while the reaction is going on.

The reaction time for the synthesis of the compounds disclosed herein can vary widely, depending on such factors as the reaction temperature, the efficacy and amount of the catalyst, the presence or absence of diluent (solvent), and the like. The preferred reaction time can be from about 0.5 hours to about 48 hours, from about 1 hour to about 40 hours, from about 2 hours to about 38 hours, from about 4 hours to about 36 hours, from 6 hours to about 34 hours, from about 8 hours to about 32 hours, from about 10 hours to about 30 hours, from about 12 hours to about 28 hours, from about 14 hours to 26 hours, from about 16 hours to 24 hours, from about 18 hours to 20 hours, from about 1 hour to 8 hours, from 8 hours to 16 hours, from 8 hours to about 24 hours, about 2 hours, about 4 hours, about 6 hours, about 8 hours, about 10 hours, about 14 hours, about 16 hours, about 18 hours, about 24 hours, about 30 hours, about 36 hours, or any values there between.

The reaction for the synthesis of the compounds disclosed herein can go to completion when one mole of the polyamine or polyethylenimine and two or more moles of the activated olefin are mixed together for a sufficient of time at a temperature described above.

The progression of the reaction can be typically monitored by ESI-MS or NMR spectroscopy for consumption of the monomer. The reaction products can be purified or separated by HPLC or other methods known by one skilled in the art. For reactions that proceeded to completion, the formed product can be separated by removal of solvent or by precipitation in a non-polar solvent that was the opposite of the reaction media. For the reactions in water, the formed product is precipitated from the aqueous reaction mixture. Higher pressure can speed-up the reaction. In some embodiments, if the reaction is carried out at a room temperature, the reaction can have a product yield of more than 98%, in some embodiments within about 16 hours.

In some embodiments of the disclosed methods, the contacting of the activated olefin and polyamine or polyethylenimine is done in the presence of a reaction solvent. The reaction solvent can be any inorganic or organic solvent commonly used in chemical synthesis. The reaction solvent used in the disclosed method can be introduced into the reaction between the polyamine or polyethylenimine and the activated olefin including a cationic or anionic group by any way known by one skilled in the art. For example, the solvent can be added into the container or vessel for reaction before, at the same, with one or both reactants, or after the polyamine or polyethylenimine, the activated olefin, or both are added.

In some embodiments, the reaction solvent is water, methanol, ethanol, propanol, glycol, PEG, or a combination thereof. In some other embodiments, the reaction solvent is water.

In some other embodiments of the disclosed methods, the contacting step is done in the presence of a catalyst, base, or acid. The catalyst, base, or acid can be introduced into the reaction between the polyamine or polyethylenimine and activated olefin by any way known by one skilled in the art.

In some embodiments, the contacting step is done without the presence of any additional base or alkalinity source. In some other embodiments, the contacting step is done in the presence of an alkalinity source. In some other embodiments, the contacting step is done in the presence of an organic base, such as alkanolamines. In yet some other embodiments, the contacting step is done in the presence of an alkali metal hydroxide, carbonate, imidazole/pyridine base, or combination thereof, such as NaOH, Na₂CO₃, aminoethyl pyridine, aminopropyl imidazole, or a combination thereof. In some other embodiments, the contacting step is done with the presence of benzyl trimethyl ammonium hydroxide. In some embodiments, the catalyst base is an amidine or guanidine base, or a combination thereof. In some other embodiments, the catalyst is an ionic liquid, such as 1,8-diazabicyclo[5.4.0]-undec-7-en-8-ium acetate, for the reaction under a solvent free condition at room temperatures.

In yet some other embodiments of the disclosed methods, the contacting step is done in the presence of an acid. In some other embodiments, the contacting step is done in the presence of a catalyst. The catalyst can any one or more of the catalysts known for the Michael addition reaction by one skilled in the art.

In yet some other embodiments of the disclosed methods, the contacting step is done free of a catalyst, base, or acid. In some other embodiments, the contacting step is done free of an alkali metal hydroxide, carbonate, silicate, metasilicate, imidazole/pyridine-based base, or all thereof. In some embodiments, the contact step is done free of a base.

In yet another aspect, disclosed herein is an article, product, or composition comprising one or more compounds disclosed here or produced by the methods disclosed herein.

In some embodiments, the article, product or composition further comprises a carrier solvent or a carrier. As used herein, a “carrier solvent” or carrier is a solvent or solvent system in which the disclosed compound can be distributed evenly and stable.

As used herein, “stable” means that compounds disclosed herein does not precipitate from or separated from the carrier solvent or other ingredients in the composition in about 1 hour, from about 1 hour to about 12 hours, about 12 hours, about 1 day, about 5 days, about 10 days, about 20 days, about 1 month, from about 1 month to about 1 year, or from about 1 year to about 2 year after the compounds disclosed herein and carrier solvent or any other ingredients are mixed homogenously. In some embodiments, the articles, products, or compositions are solid. In some other embodiments, the articles, products, or compositions are liquid.

In some other embodiments, the carrier is water, an organic solvent, an inorganic solvent, or a combination thereof. In some embodiments, the article, product, or composition further comprises an organic solvent. In some other embodiments, the article, product, or composition further comprises an organic solvent and water.

In some embodiments, the organic solvent is an alcohol, a hydrocarbon, a ketone, an ether, an alkylene glycol, a glycol ether, an amide, a nitrile, a sulfoxide, an ester, or any combination thereof. In some other embodiments, the organic solvent is an alcohol, an alkylene glycol, an alkyleneglycol alkyl ether, or a combination thereof. In yet some embodiments, the organic solvent is methanol, ethanol, propanol, isopropanol, butanol, isobutanol, monoethyleneglycol, ethylene glycol monobutyl ether, or a combination thereof.

In some embodiments, the organic solvent is methanol, ethanol, propanol, isopropanol, butanol, 2-ethylhexanol, hexanol, octanol, decanol, 2-butoxyethanol, methylene glycol, ethylene glycol, 1,2-propylene glycol, 1,3-propylene glycol, diethylene glycol monomethyl ether, diethylene glycol monoethyl ether, ethylene glycol monobutyl ether, ethylene glycol dibutyl ether, pentane, hexane, cyclohexane, methylcyclohexane, heptane, decane, dodecane, diesel, toluene, xylene, heavy aromatic naphtha, cyclohexanone, diisobutylketone, diethyl ether, propylene carbonate, N-methyl pyrrolidinone, N,N-dimethylformamide, a combination thereof with water, or any combination thereof.

Other methods of making multiple charged cationic polymers via aza-Michael addition and reaction products and precursors thereof are discussed in U.S. Pub. No. 2020/0071265, U.S. Pub. No. 2020/0071205, U.S. Pub. No. 2021.0332288 and U.S. Pat. No. 11,084,974, all of which are herein incorporated by reference in their entirety.

### Methods of Making: Detergent Compositions Using Multiple Charged Cationic Polymer

The detergent compositions comprising a multiple charged cationic polymer may be prepared as a laundry finishing composition, or a composition suitable for any stage of the textile wash cycle. The compositions can be provided in the form of solids or liquids.

As an example, the compositions may be provided as a pressed solid. In a pressed solid process, a flowable solid, such as granular solids or other particle solids are combined under pressure. In a pressed solid process, flowable solids of the compositions are placed into a form (e.g., a mold or container). The method can include gently pressing the flowable solid in the form to produce the solid composition. Pressure may be applied by a block machine or a turntable press, or the like. Pressure may be applied at about 1 to about 2000 psi, about 1 to about 300 psi, about 5 psi to about 200 psi, or about 10 psi to about 100 psi.

In certain embodiments, the methods can employ pressures as low as greater than or equal to about 1 psi, greater than or equal to about 2, greater than or equal to about 5 psi, or greater than or equal to about 10 psi. As used herein, the term “psi” or “pounds per square inch” refers to the actual pressure applied to the flowable solid being pressed and does not refer to the gauge or hydraulic pressure measured at a point in the apparatus doing the pressing. The method can include a curing step to produce the solid composition. As referred to herein, an uncured composition including the flowable solid is compressed to provide sufficient surface contact between particles making up the flowable solid that the uncured composition will solidify into a stable solid composition. A sufficient quantity of particles (e.g., granules) in contact with one another provides binding of particles to one another effective for making a stable solid composition. Inclusion of a curing step may include allowing the pressed solid to solidify for a period of time, such as a few hours, or about 1 day (or longer). In additional aspects, the methods could include vibrating the flowable solid in the form or mold, such as the methods disclosed in U.S. Pat. No. 8,889,048, which is herein incorporated by reference in its entirety.

The use of pressed solids provide numerous benefits over conventional solid block or tablet compositions requiring high pressure in a tablet press, or casting requiring the melting of a composition consuming significant amounts of energy, or by extrusion requiring expensive equipment and advanced technical know-how. Pressed solids overcome such various limitations of other solid formulations for which there is a need for making solid compositions. Moreover, pressed solid compositions retain its shape under conditions in which the composition may be stored or handled.

The detergent compositions may also be provided as a cast or extruded composition. The degree of hardness of the solid cast composition or a pressed solid composition may range from that of a fused solid product which is relatively dense and hard, for example, like concrete, to a consistency characterized as being a hardened paste. In addition, the term “solid” refers to the state of the cleaning composition under the expected conditions of storage and use of the solid cleaning composition. In general, it is expected that the cleaning composition will remain in solid form when exposed to temperatures of up to approximately 100° F. and particularly up to approximately 120° F.

The solid compositions can be used as concentrated solid compositions or may be diluted to form use compositions. In general, a concentrate refers to a composition that is intended to be diluted with water to provide a use solution that contacts an object to provide the desired cleaning, rinsing, or the like. The detergent composition that contacts the articles to be washed can be referred to as a concentrate or a use composition (or use solution) dependent upon the formulation employed in methods according to the disclosure. It should be understood that the concentration of the ingredients in the cleaning composition will vary depending on whether the cleaning composition is provided as a concentrate or as a use solution.

A concentrated liquid composition can be prepared by combining and mixing the ingredients as described herein, for example in Tables 1 and 2. If incompatible ingredients are to be formulated, the liquid compositions can be prepared as a multi-part system.

A use solution may be prepared from the concentrate by diluting the concentrate with water at a dilution ratio that provides a use solution having desired detersive properties. The water that is used to dilute the concentrate to form the use composition can be referred to as water of dilution or a diluent and can vary from one location to another. The typical dilution factor is between approximately 1 and approximately 10,000 but will depend on factors including water hardness, the amount of soil to be removed and the like. In an embodiment, the concentrate is diluted at a ratio of between about 1:10 and about 1:10,000 concentrate to water. Particularly, the concentrate is diluted at a ratio of between about 1:100 and about 1:5,000 concentrate to water. More particularly, the concentrate is diluted at a ratio of between about 1:250 and about 1:2,000 concentrate to water.

In an aspect of the disclosure, the detergent composition preferably provides efficacious cleaning at low use dilutions, i.e., require less volume to clean effectively. In an aspect, a concentrated liquid cleaning composition may be diluted in water prior to use at dilutions ranging from about 1/16 oz./gal. to about 2 oz./gal. or more. A detergent concentrate that requires less volume to achieve the same or better cleaning efficacy and provides hardness scale control or other benefits at low use dilutions is desirable.

### Methods of Cleaning Textiles

The methods of cleaning are particularly well suited for removing cosmetic and oily soils. While not wanting to be held to a scientific theory, it is believed that the hydrophobic portion of the cosmetic and oily soils make the soil particularly difficult to remove from textiles. The hydrophobic portion of the cosmetic may be an oil, a viscous solid, or a wax, depending on the desired consistency of the final product. For example, a lip gloss that is rolled onto the lips will tend to be more liquid in consistency than a lip gloss that is applied using a fingertip. Naturally, one would expect the roll-on lip gloss to have a higher oil content than a fingertip lip gloss, which would have more solids or waxes. The hydrophobic component of cosmetics may be natural or synthetic. The following is a list of non-limiting examples of hydrophobic materials that are found in cosmetics: apple (Pyrus malus) peel wax, avocado (Persea gratissima) wax, bayberry (Myrica cerifera) wax, beeswax, candelilla (Euphorbia cerifera) wax, canola oil, carnauba (Copernicia cerifera) wax, castor oil, ceresin, cetyl alcohol, cetyl esters, cocoa (Theobroma cacao) butter, coconut (Cocos nucifera) oil, hydrogenated jojoba oil, hydrogenated jojoba wax, hydrogenated microcrystalline wax, hydrogenated rice bran wax, hydrolyzed beeswax, isostearic acid, jojoba butter, jojoba esters, jojoba wax, lanolin oil, lanolin wax, microcrystalline wax, mineral oil, mink wax, montan acid wax, montan wax, olive (Olea europaea) oil, orange (Citrus aurantium dulcis) peel wax, ouricury wax, oxidized beeswax, oxidized microcrystalline wax, ozokerite, palm kernel wax, paraffin, PEG-6 beeswax, PEG-8 beeswax, PEG-12 beeswax, PEG-20 beeswax, PEG-12 carnauba, petrolatum, petroleum jelly, potassium oxidized microcrystalline wax, rice (Oryza sativa) wax, sesame (Sesamum indicum) oil, shea butter (Butyrospermum parkii), shellac wax, spent grain wax, stearic acid, sulfurized jojoba oil, synthetic beeswax, synthetic candelilla wax, synthetic carnauba, synthetic japan wax, synthetic jojoba oil, synthetic wax, and vegetable oil.

Additional materials found in cosmetics include, for example, silicones, such as dimethicone, along with other pigments, dyes, colorants and fragrances.

It is understood that the compositions disclosed herein are capable of removing cosmetic and oily soils having the hydrophobic and other materials described above as well as those not included in the list above.

The methods are particularly well suited for removing cosmetic and oily soils that accumulate on any type of textiles, namely any item or article made from or including natural fabrics, synthetic fabrics, woven fabrics, non-woven fabrics, and knitted fabrics. The textile materials can include natural or synthetic fibers such as silk fibers, linen fibers, cotton fibers, hemp fibers, angora fibers, bamboo fibers, polyester fibers, polyamide fibers such as nylon, acrylic fibers, acetate fibers, wool, rayon, cashmere, satin, spandex, and blends thereof, including cotton and polyester blends. The fibers can be treated or untreated. Exemplary treated fibers include those treated for flame retardancy. It should be understood that the term “linen” describes a type of material derived from flax plants which is often used in certain types of laundry items including bed sheets, pillowcases, towels, table linen, tablecloth, bar mops and uniforms.

The methods of cleaning include contacting a textile in need of removing cosmetic and oily soils, including for example lipstick, lip stain, lip gloss, lip balm, or chap stick. In an aspect, the textile surface is soiled with a waxy, oily or greasy soil. Any means of contacting can be used to place the textile surface in contact with the cleaning compositions, including for example, soaking, spraying, dripping, wiping, or the like. Included within the scope of contacting described herein, the textile can also be soaked, including a pretreatment, with the non-quaternary cationic amine composition or the full cleaning composition. As a result of the contacting step the textile is washed, and the soils removed.

In certain embodiments a concentrate can be sprayed onto a textile surface or provided in water as part of a pre-treatment. The contacting time may vary about 10 seconds to six hours, for example 1 minute to four hours, 10 minutes to two hours, 15 minutes to an hour, inclusive of all integers within this range. In another aspect the pre-treatment may last as long as several hours (e.g., overnight soak).

In textile cleaning applications, the multiple charged cationic polymer can be added to a separate base detergent composition. Alternatively, a fully formulated detergent composition comprising both the base detergent composition and the multiple charged cationic polymer can be provided. A first step of diluting or creating an aqueous use solution (such as from a solid) can also be included in the methods. An exemplary dilution step includes contacting the liquid or solid composition with water.

Beneficially, the methods of cleaning textiles involves the deposition of a multiple charged cationic polymer and optionally a composition comprising a surfactant package, silicone, amine softening agent, or any other component described herein, wherein at least a portion of the multiple charged cationic polymer remains on the textile. During later use and soiling, at least a portion of the multiple charged cationic polymer remains on the textile. Then, during subsequent wash cycles, particularly during the wash step, soil removal efficacy is substantially enhanced due to the presence and deposition of the polymer.

More particularly, in a typical cleaning method, the washing process comprises a pre-wash or pre-soak where the textiles are wetted, and a pre-soak composition is added. The wash phase follows the pre-soak phase; a detergent is added to the wash tank to facilitate soil removal. In some cases, a bleach phase follows the wash phase in order to remove oxidizable stains and whiten the textiles. Next, the rinsing phase removes all suspended soils. In some cases, a laundry sour is added in a souring or finishing phase to neutralize any residual alkalinity from the detergent composition or complete and post-treatment of the textiles needed. In many cases a fabric softener or other finishing chemical like a starch is also added in the finishing step. Finally, the extraction phase removes as much water from the wash tank and textiles as possible. In some cases, a wash cycle may have two rinse and extraction phases, i.e., a rinse cycle, an intermediate-extract cycle, a final rinse cycle, and a final extraction cycle. After the wash cycle is complete, the resulting wastewater is typically removed and discarded.

As described herein, the multiple charged cationic polymer by itself or as part of a composition comprising a surfactant package, silicone, amine softening agent, or any other component described herein may be applied to a textile as part of a pre-wash or pre-soak phase or as a finishing phase. Additionally, or in the alternative, the multiple charged cationic polymer together with a composition comprising a surfactant package, silicone, amine softening agent, or any other component described herein may form a cleaning composition and may be applied to the textile as part of the wash phase.

In an aspect, the composition will contact the textile to be cleaned for a sufficient amount of time to remove the soils, including from a few seconds to a few hours, including all ranges therebetween. In an embodiment, the composition contacts the textiles for at least about 15 seconds, at least about 30 seconds, at least about 45 seconds, or at least about 60 seconds. In an embodiment, the composition contacts the textiles for at least about 1 minute, at least about 2 minutes, at least about 3 minutes, at least about 4 minutes, or at least about 5 minutes.

Methods of Treating Paper

Softness of tissue paper is an important parameter for tissue manufacturers, which should be maximized to improve the consumer perception of the product. While other parameters of tissue paper (e.g., tensile strength, bulk, etc.) can be easily measured, the evaluation of softness is difficult because it is a complex human perception, influenced by physical and physiological senses. Softness is frequently defined as a combination of bulk softness, being understood as the gentle crumpling, or folding of the tissue, and surface softness, which is assessed by the gently rubbing the fingertips and palms over the tissue surface. Paper softness can be improved through different approaches such as, the use of a better-quality fiber or through mechanical approaches during the tissue making process. However, mechanical approaches are limited by productivity and economic reasons. Another approach to tackle these limitations and improve the softness of the paper, is the addition of a softening compound to the fiber suspension.

Softening compounds can function to improve bulk softness by sterically hindering the fiber-to-fiber bonding, which, on the one hand, leads to a softer paper, while on the other hand, this bond interference lowers the sheet strength. Many traditional softening products comprise cationic surfactants, primarily quaternary ammonium compounds. However, quaternary ammonium compounds have undesirable side effects, such as, toxicity to aquatic organisms and can cause skin and eyes irritation. Therefore, there is the need to develop additional chemistries having less harmful effects to the environment and health.

Tissue paper is softened through any suitable method of applying, saturating, or embedding the compositions of the application on or in tissue paper. The compositions may be applied to individual constituents of tissue paper before manufacturing of the tissue paper (e.g., fibers, such as cellulose fibers) and/or applied to the final tissue product. Examples of suitable methods of applying, saturating, and embedding the compositions include soaking, spraying, de-bonding, and encapsulation, among others.

As an example, when the compositions are applied via spray nozzle, rather than soaking cellulose or other fibers, the final tissue product is sprayed with the compositions, causing a modification of the softness of the exterior surface. The internal structural integrity of the tissue product remains, but the surface of the tissue demonstrates improved softness. As another example, when the compositions are applied via de-bonding, cellulose fibers are prevented from overlapping or cross-linking, and are instead soaked or otherwise saturated with the compositions. When overlapping or other bonding is subsequently allowed, the tissue retains softness but obtains rigidity through by virtue of these bonds. As a still further example, the compositions may be encapsulated into microcapsules that are then made to adhere to the structure of the tissue product or cellulose fibers. Further discussion of both encapsulation and soaking methods is found in EP 2826917, which is herein incorporated by reference in its entirety.

In some embodiments, the disclosure relates to methods of softening a target comprising: (a) dispersing a multiple charged cationic polymer in water to form a use solution; and (b) contacting the target with the use solution; wherein the multiple charged cationic polymer is a reaction product of a polyamine and a cationic monomer as described herein.

For example the polyamine can include a linear polyamine according to the structure:

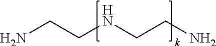

wherein k is an integer between 1 and 100. In an embodiment, the polyamine is tetraethylenepentamine, pentaethylenehexamine, hexaethyleneheptamine, or diethylenetriamine.

In an embodiment, wherein the cationic monomer is a monomer according to the structure:

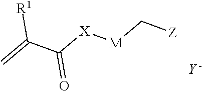

wherein R₁ is H, CH₃, or an unsubstituted, linear, or branched C₂-C₁₀ alkyl group; X is NH or O, M is absent or an unsubstituted, linear C₁-C₃₀ alkylene group; and Z is —NR₄R₅R₆(+)Y(−) wherein R₄, R₅, and R₆ are independently a C₁-C₁₀ alkyl group or a benzyl group, and Y is a halide or a methyl sulfate group. In an embodiment, the cationic monomer is (3-acrylamidopropyl)trimethylammonium chloride (APTAC), [3-(methacryloylamino)propyl]trimethylammonium chloride (MAPTAC), N,N-dimethylaminoethyl acrylate benzyl chloride quaternary salt (DMAEA-BCQ), 2-(methacryloyloxy)-N,N,N-trimethylethan-1-aminium methyl sulfate (DMAEMA-MSQ), 2-(acryloyloxy)-N,N,N-trimethylethanaminium chloride (DMAEA-MCQ), or a combination thereof.

In some embodiments, the target is a textile. In an embodiment, the textile is a fabric used in a hotel, hospital, healthcare facility, restaurant, health club, salon, retail store, or a combination thereof.

In a further embodiment, the target is a pulp. In an embodiment, the pulp comprises eucalyptus, softwood, cellulose fibers, wood fibers, or a combination thereof.

According to some embodiments, the method further includes a step (c) of forming a paper from the pulp. In an embodiment, the paper is a tissue, napkin, or paper

towel.

### EXAMPLES

Embodiments of the present disclosure are further defined in the following non-limiting Examples. These Examples, while indicating certain embodiments of the disclosure, are given by way of illustration only. From the above discussion and these Examples, one skilled in the art can ascertain the essential characteristics of this disclosure, and without departing from the spirit and scope thereof, can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims.

Materials used in the experiments include, for example, the following: Barlox 12: a Cu cocoamine oxide, specifically lauryl dimethyl amine oxide, Tetraethylenepentamine (TEPA), Pentaethylenehexamine (PEHA), Hexaethyleneheptamine (HEHA), Ethyleneamine E-100: a mixture of tetraethylenepentamine (TEPA), pentaethylenehexamine (PEHA), hexaethyleneheptamine (HEHA), and higher molecular weight products. E-100 has a number-average molecular weight of 250-300 g/mole and generally conforms to the formula: H₂NCH₂CH₂(NHCH₂CH₂)ₓNH₂ wherein x=3, 4, 5 and higher; Lupasol® G20: branched polyethylenimine (PEI) polymer, Lupasol® PS: branched polyethylenimine (PEI) polymer, Diethylenetriamine (DETA), also known as 2,2′-Iminodi(ethylamine)), Polyethylenimine with a molecular weight of 25k daltons, and APTAC: 3-acrylamidopropyl)trimethylammonium chloride (APTAC).

### Example 1

Multiple charged cationic polymers were prepared by reacting a polyamine with a α, β-unsaturated carbonyl compound according to aza-Michael addition as shown in the Table below.

TABLE 3

| | Product Chemistry: Polyamine-APTAC adduct | |
|---|---|---|
| | | α, β-unsaturated |
| Product | Polyamine | carbonyl compound |
| Product 1 | Ethyleneamine E-100 | APTAC |
| Product 2 | Pentaethylenehexamine (PEHA) | APTAC |
| Product 3 | Lupasol ® G20 | APTAC |
| Product 4 | Diethylenetriamine (DETA) | APTAC |
| Product 5 | Lupasol ® PS | APTAC |
| Product 6 | Polyethylenimine, Mw = 25K Daltons | APTAC |
| Product 7 | Tetraethylenepentamine | APTAC |

The aza-Michael addition generated multiple cationic compounds according to the following formula:

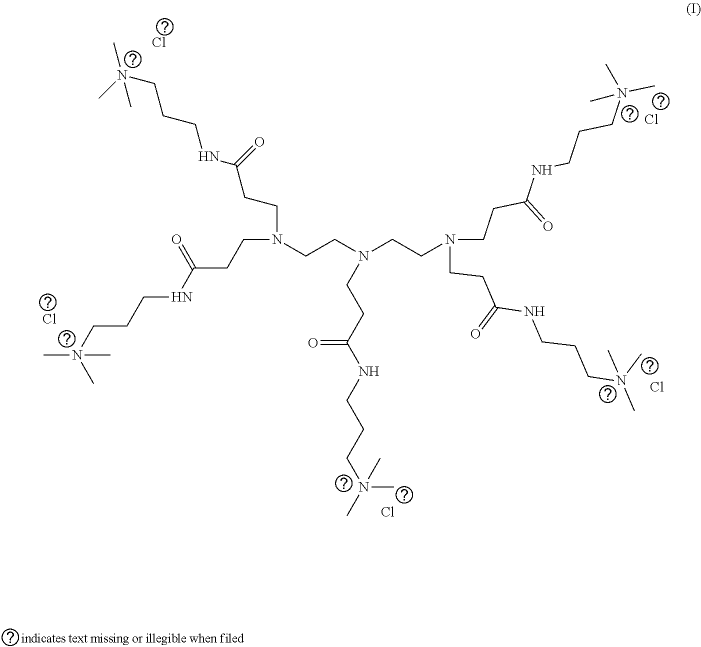

wherein n=0, 1, or 3;

and more specifically comprising one or more of the following formulas:

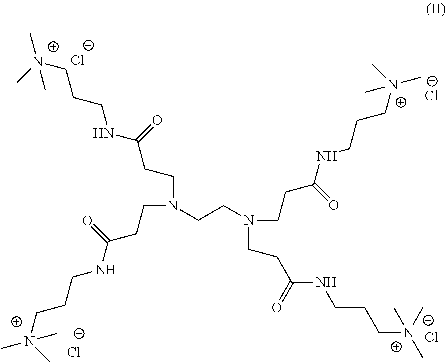

n=0 (Ethylenediamine-APTAC adduct)

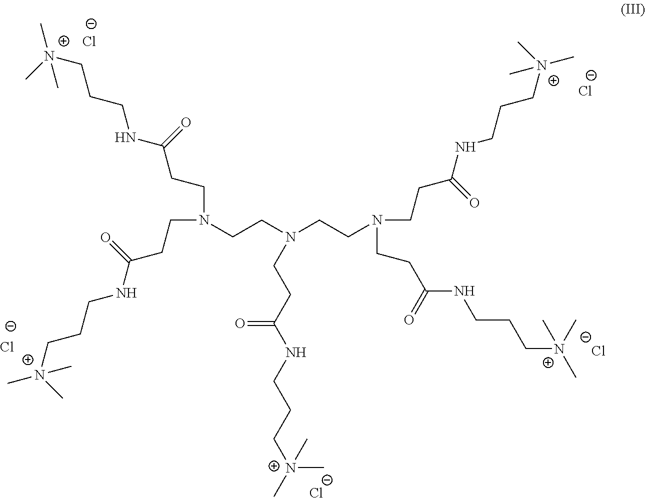

n=1 (DETA-APTAC adduct)

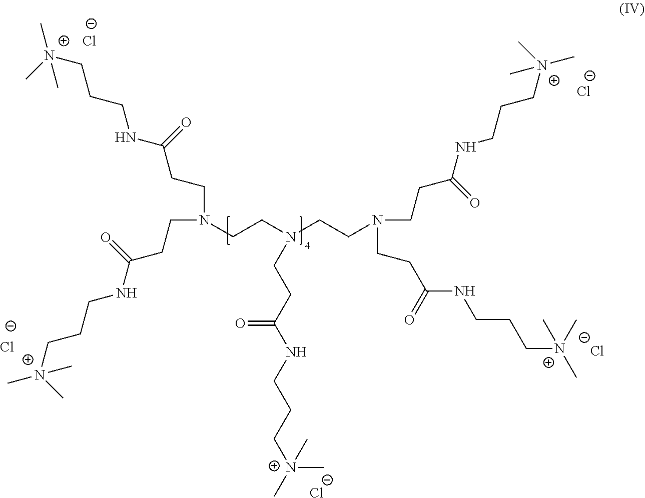

n=3 (PEHA-APTAC adduct)

### Example 2

The multiple charged cationic polymers of Example 1 were tested by themselves as part of a presoak/deposition aid or in combination with an amine oxide surfactant (e.g., lauryl dimethyl amine oxide) for their soil release capability according to the tables below.

TABLE 4

| | | | | | | | | Pot Avg. | |
|---|---|---|---|---|---|---|---|---|---|
| Swatch | Soil | Pre-Soak | Detergent | L*Value | | | % Soil | % Soil | Pot Avg. |
| No. | Type | Conc. | Conc. | Before | Soiled | Cleaned | Removal | Removal | St. Dev. |
| 1 | Covergirl | n/a | 1x | 88 | 69.1 | 79.00 | 52.38 | 54.46 | 2.91 |
| 2 | lipstick | | | 88 | 70.9 | 80.00 | 53.22 | | |
| 3 | | | | 88 | 68.1 | 79.60 | 57.79 | | |
| 4 | Covergirl | n/a | 2x | 88 | 65.9 | 81.70 | 71.49 | 70.47 | 1.25 |
| 5 | lipstick | | | 88 | 68.8 | 82.40 | 70.83 | | |
| 6 | | | | 88 | 68.6 | 82.00 | 69.07 | | |
| 7 | Covergirl | 100 ppm | 1x | 88 | 66.9 | 79.40 | 59.24 | 57.85 | 2.99 |
| 8 | lipstick | amine oxide¹ | | 88 | 66.5 | 78.20 | 54.42 | | |
| 9 | | | | 88 | 69.8 | 80.70 | 59.89 | | |
| 10 | Covergirl | 10 ppm | 1x | 88 | 67.7 | 81.20 | 66.50 | 61.24 | 4.57 |
| 11 | lipstick | Product 1 | | 88 | 68.1 | 79.70 | 58.29 | | |
| 12 | | | | 88 | 69.5 | 80.40 | 58.92 | | |
| 13 | Covergirl | 100 ppm | 1x | 88 | 65.2 | 78.80 | 59.65 | 57.93 | 1.90 |
| 14 | lipstick | Product 1 + | | 88 | 65.1 | 77.90 | 55.90 | | |
| 15 | | 100 ppm | | 88 | 68.6 | 79.90 | 58.23 | | |
| | | amine oxide | | | | | | | |
| 16 | Covergirl | 100 ppm | 1x | 88 | 68.3 | 81.30 | 65.99 | 63.36 | 6.51 |
| 17 | lipstick | Product 2 | | 88 | 67.6 | 81.50 | 68.14 | | |
| 18 | | | | 88 | 67.8 | 79.10 | 55.94 | | |
| 19 | Covergirl | 100 ppm | 1x | 88 | 65.9 | 79.80 | 62.9 | 65.29 | 2.47 |
| 20 | lipstick | Product 2 + | | 88 | 66.2 | 80.40 | 65.14 | | |
| 21 | | 100 ppm | | 88 | 67.8 | 81.50 | 67.82 | | |
| | | amine oxide | | | | | | | |
| 22 | Covergirl | 100 ppm | 1x | 88 | 66.8 | 79.50 | 59.9 | 60.44 | 0.69 |
| 23 | lipstick | Product 7 | | 88 | 68.4 | 80.40 | 61.22 | | |
| 24 | | | | 88 | 66.4 | 79.40 | 60.19 | | |
| 25 | Covergirl | 100 ppm | 1x | 88 | 65.9 | 80.70 | 66.97 | 66.13 | 1.20 |
| 26 | lipstick | Product 7 + | | 88 | 67 | 80.60 | 64.76 | | |
| 27 | | 100 ppm | | 88 | 67.9 | 81.30 | 66.67 | | |
| | | amine oxide | | | | | | | |
| 28 | Covergirl | 100 ppm | 1x | 88 | 66.4 | 76.6 | 47.22 | 47.60 | 1.09 |
| 29 | lipstick | Product 5 | | 88 | 64.9 | 75.7 | 46.75 | | |
| 30 | | | | 88 | 66.5 | 77.00 | 48.84 | | |
| 31 | Covergirl | 100 ppm | 1x | 88 | 67.7 | 77.90 | 50.25 | 50.73 | 1.05 |
| 32 | lipstick | Product 5 + | | 88 | 67.8 | 77.90 | 50.00 | | |
| 33 | | 100 ppm | | 88 | 69.9 | 79.30 | 51.93 | | |
| | | amine oxide | | | | | | | |
| 34 | Covergirl | 100 ppm | 1x | 88 | 65.7 | 76.00 | 46.19 | 53.68 | 6.84 |
| 35 | lipstick | Product 6 | | 88 | 68.7 | 80.20 | 59.59 | | |
| 36 | | | | 88 | 69 | 79.50 | 55.26 | | |
| 37 | Covergirl | 100 ppm | 1x | 88 | 63.6 | 74.30 | 43.85 | 50.20 | 5.57 |
| 38 | lipstick | Product 6 + | | 88 | 63.4 | 76.30 | 52.44 | | |
| 39 | | 100 ppm | | 88 | 69.4 | 79.50 | 54.30 | | |
| | | amine oxide | | | | | | | |
| 40 | Covergirl | 100 ppm | 1x | 88 | 71.2 | 82.70 | 68.45 | 65.03 | 2.97 |
| 41 | lipstick | Product 3 | | 88 | 67.1 | 80.30 | 63.16 | | |
| 42 | | | | 88 | 69.1 | 81.10 | 63.49 | | |
| 43 | Covergirl | 100 ppm | 1x | 88 | 65.8 | 80.60 | 66.67 | 65.20 | 2.95 |
| 44 | lipstick | Product 3 + | | 88 | 62.6 | 78.30 | 61.81 | | |
| 45 | | 100 ppm | | 88 | 66.7 | 81.00 | 67.14 | | |
| | | amine oxide | | | | | | | |

¹e.g., a C₁₂ cocoamine oxide such as lauryl dimethyl amine oxide

TABLE 5

| | Pot Avg. % | Pot. Avg. |
|---|---|---|
| Covergirl Lipstick | Soil Removal | Std. Dev. |
| 1x | 54.46 | 2.91 |
| 2x | 70.47 | 1.25 |
| 100 ppm Barlox 12 | 57.85 | 2.99 |
| 100 ppm Product 1 | 61.24 | 4.57 |
| 100 ppm Product 1 + | 57.93 | 1.90 |
| 100 ppm amine oxide¹ | | |
| 100 ppm Product 2 | 63.36 | 6.51 |
| 100 ppm Product 2 + | 65.29 | 2.47 |
| 100 ppm amine oxide | | |
| 100 ppm Product 7 | 62.44 | 0.69 |
| 100 ppm Product 7 + | 66.13 | 1.20 |
| 100 ppm amine oxide | | |
| 100 ppm Product 5 | 47.60 | 1.09 |
| 100 ppm Product 5 + | 50.73 | 1.05 |
| 100 ppm amine oxide | | |
| 100 ppm Product 6 | 56.68 | 6.84 |
| 100 ppm Product 6 + | 50.20 | 5.57 |
| 100 ppm amine oxide | | |
| 100 ppm Product 3 | 65.03 | 2.97 |
| 100 ppm Product 3 + | 65.20 | 2.95 |
| 100 ppm amine oxide | | |

¹e.g., a C₁₂ cocoamine oxide such as lauryl dimethyl amine oxide

The multiple charged cationic polymer compositions were also compared to negative and positive controls: 1× comprised 500 ppm of Aquanomic 2.0 Low Temp Detergent and 2000 ppm Aquanomic 2.0 Low Temp Builder, commercially available products. 2× comprised two times the concentration of 1×. The solutions were stirred and heated to about 38° C. Once adequately stirred, cotton terry cloth swatches were soaked in the use solutions for 10 minutes. The swatches were removed from the use solutions and dried. After drying the swatches were soiled with relevant cosmetic soil.

After soiling the swatches, they were read on the camera-based multispectral color measurement instrument for an initial reflectance value. Then the swatches were washed in traditional wash cycles. Control swatches were also tested. Stain removal was evaluated according to detergency testing methods using a tergotometer. The tergotometer contains six pots filled with 0.5 L of water sitting in a temperature-controlled water bath. A Mach5 color instrument was used to determine the lightness or darkness of each swatch, as measured by the L* value, prior to washing. After completion of the wash cycles, the swatches were removed, rinsed with cold water, and squeezed to remove the excess water. After drying, the swatches were again read on the color instrument to determine the post-wash L* value. The % stain removal is calculated from the difference between the initial (before washing) L* value and the final L* value (after washing).

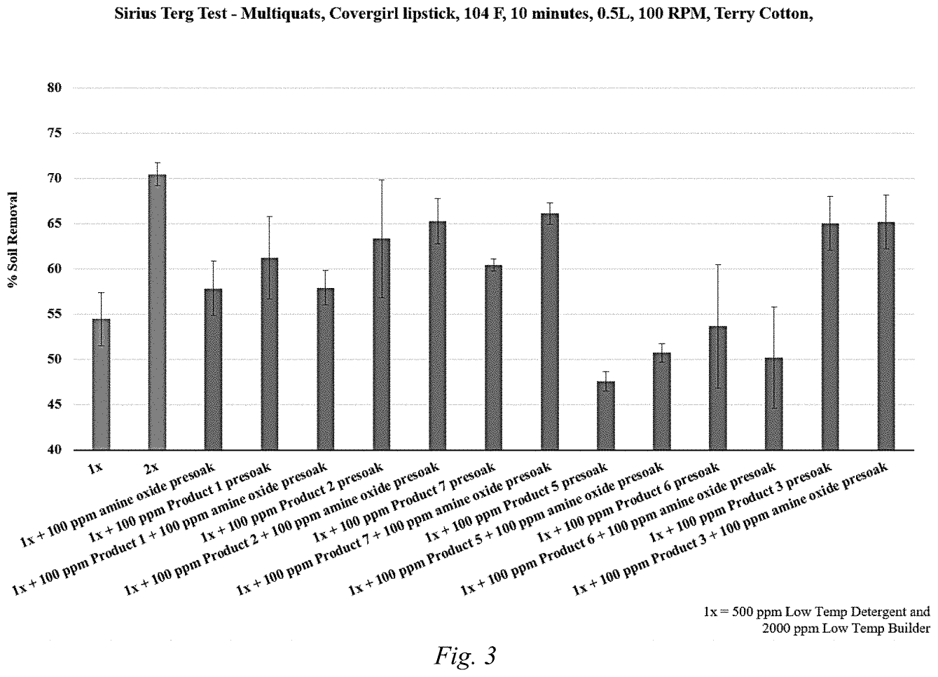

The results of this analysis are shown in FIG. 3. As shown in FIG. 3, many of the multiple charged cationic polymers-specifically Product 1, Product 2, and Product 3-beneficially performed well on their own. Multiple charged cationic polymer Product 7 performed well by itself, but the addition of a Cu cocoamine oxide did help increase soil removal. Multiple charged cationic polymers that provided approximately comparable commercial performance to the controls were Product 5 and Product 6.

1-20. (canceled)

21: A method of treating a target comprising:
contacting the target with a composition comprising a multiple charged cationic polymer formed from the reaction of a polyamine and a cationic monomer;
depositing the composition on the target; and
optionally removing soil from the target;
wherein the polyamine is a linear polyamine according to the structure: 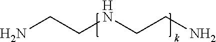
wherein k is an integer between 1 and 100, and/or
a branched polyamine according to the structure: 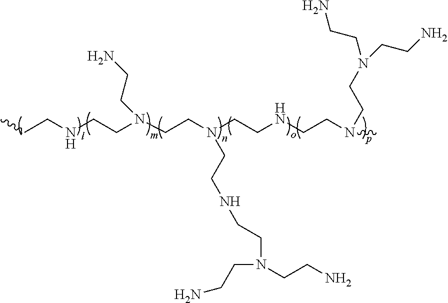
wherein l, m, n, o, or p is an integer of between 1 and 100; and
wherein the cationic monomer is a monomer according to the structure: 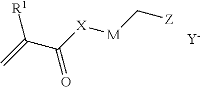
wherein R₁ is H, CH₃, or an unsubstituted, linear, or branched C₂-C₁₀alkyl group; X is NH or O, M is absent or an unsubstituted, linear C₁-C₃₀ alkylene group; and Z is —NR₄R₅R₆(+)Y(−) wherein R₄, R₅, and R₆ are independently a C₁-C₁₀ alkyl group or a benzyl group, and Y is a halide or a methyl sulfate group.

22: The method of claim 21, wherein the polyamine is tetraethylenepentamine, pentaethylenehexamine, hexaethyleneheptamine, or diethylenetriamine.

23: The method of claim 21, wherein the cationic monomer is (3-acrylamidopropyl)trimethylammonium chloride (APTAC), [3-(methacryloylamino)propyl]trimethylammonium chloride (MAPTAC), N,N-dimethylaminoethyl acrylate benzyl chloride quaternary salt (DMAEA-BCQ), 2-(methacryloyloxy)-N,N,N-trimethylethan-1-aminium methyl sulfate (DMAEMA-MSQ), 2-(acryloyloxy)-N,N,N-trimethylethanaminium chloride (DMAEA-MCQ), or a combination thereof.

24: The method of claim 21, wherein the multiple charged cationic polymer is a compound according to the structure: 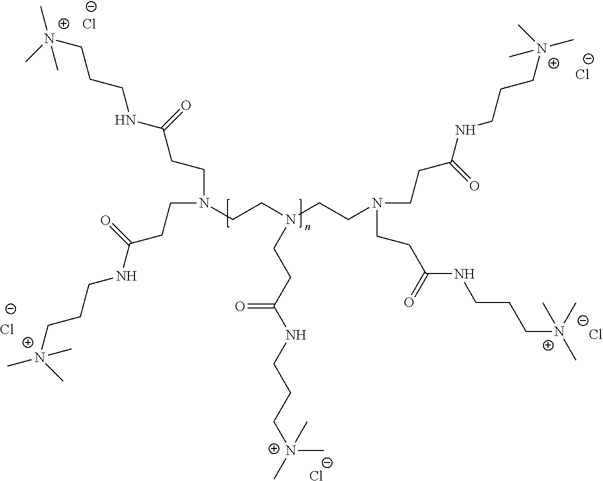
wherein n is an integer between 0 and 1000.

25: The method of claim 21, wherein the multiple charged cationic polymer is a compound according one or more of the structures:

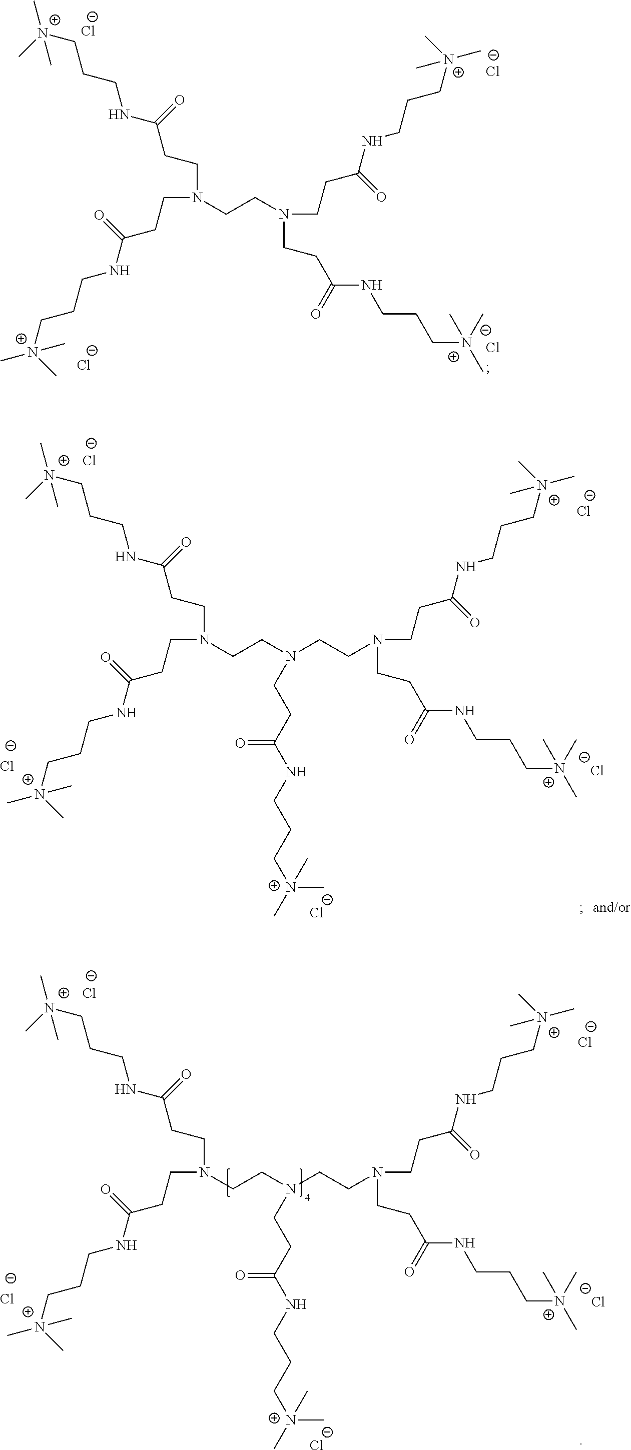

26: The method of claim 21, wherein the composition further comprises a silicone compound according to the structure: 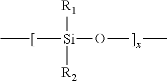
wherein each R₁ and R₂ are independently selected from a C₁-C₁₀ unsubstituted or substituted alkyl, alkenyl, or phenyl group; and x is a number from 50 to 300,000.

27: The method of claim 21, wherein the composition further comprises an amine softening agent.

28: The method of claim 27, wherein the amine softening agent comprises a triamine, ether diamine, aliphatic diamine, ethoxylated amine, branched amine, or a combination thereof.

29: The method of claim 27, wherein the amine softening agent is N-(3-aminopropyl)-N-dodecylpropane-1,3-diamine, N-(3-aminopropyl)-N-dodecylpropane-1,3-diamine, N, N-Bis (3-aminopropyl) dodecylamine, N1,N1,N3-tris(3-aminopropyl)-N3-dodecylpropane-1,3-diamine, N1,N1-bis(3-aminopropyl)-N3-dodecylpropane-1,3-diamine, N1-(3-aminopropyl)-N3-dodecylpropane-1,3-diamine, N-dodecylpropane-1,3-diamine, or a combination thereof.

30: The method of claim 21, wherein the target is a textile, and wherein the method occurs during a textile wash cycle that comprises a pre-soak phase, a wash phase, a rinsing phase, a finishing phase, and/or an extraction phase.

31: The method of claim 30, wherein the composition is applied to the textile during the pre-soak phase, the finishing phase, the wash phase, or a combination thereof.

32: The method of claim 30, wherein the multiple charged cationic polymer is on the textile for more than one wash cycle.

33: The method of claim 30, wherein the depositing provides effective soil removal for more than one wash cycle.

34: A multiple charged cationic polymer forming composition comprising:
a first reagent comprising a polyamine according to the one or more of the structures: 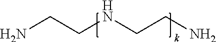
wherein k is an integer between 1 and 100, or
a branched polyamine according to the structure: 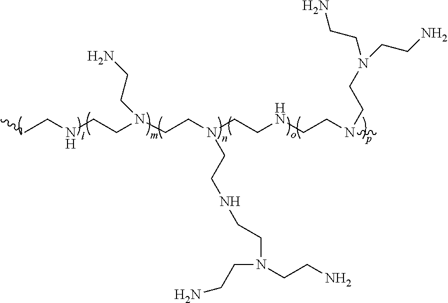
wherein l, m, n, o, or p is an integer of between 1 and 100; and
a second reagent comprising a cationic monomer according to the structure: 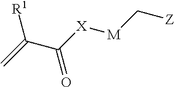
wherein R₁ is H, CH₃, or an unsubstituted, linear, or branched C₂-C₁₀ alkyl group; X is NH or O, M is absent or an unsubstituted, linear C₁-C₃₀ alkylene group; and Z is —NR₄R₅R₆(+)Y(−) wherein R₄, R₅, and R₆ are independently a C₁-C₁₀ alkyl group or a benzyl group, and Y is a halide;
wherein the first reagent and the second reagent are contacted to generate a multiple charged cationic polymer.

35: The composition of claim 34, wherein the polyamine is tetraethylenepentamine, pentaethylenehexamine, hexaethyleneheptamine, or diethylenetriamine.

36: The composition of claim 34, wherein the polyamine is a branched polyethylenimine according to the structure: 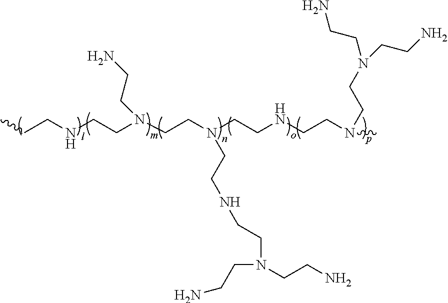
wherein l, m, n, o, or p is an integer between 1 and 100.

37: The composition of claim 34, wherein the cationic monomer is (3-acrylamidopropyl)trimethylammonium chloride (APTAC), [3-(methacryloylamino)propyl]trimethylammonium chloride (MAPTAC), N,N-dimethylaminoethyl acrylate benzyl chloride quaternary salt (DMAEA-BCQ), 2-(methacryloyloxy)-N,N,N-trimethylethan-1-aminium methyl sulfate (DMAEMA-MSQ), 2-(acryloyloxy)-N,N,N-trimethylethanaminium chloride (DMAEA-MCQ), or a combination thereof.

38: The composition of claim 34, wherein the multiple charged cationic polymer is a compound according to the structure: 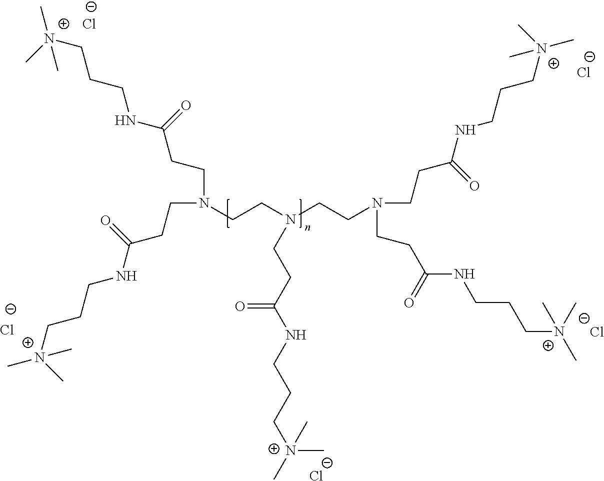
wherein n is an integer between 0 and 1000.

39: The composition of claim 34, wherein the multiple charged cationic polymer is a compound according to any one or more of the structures:

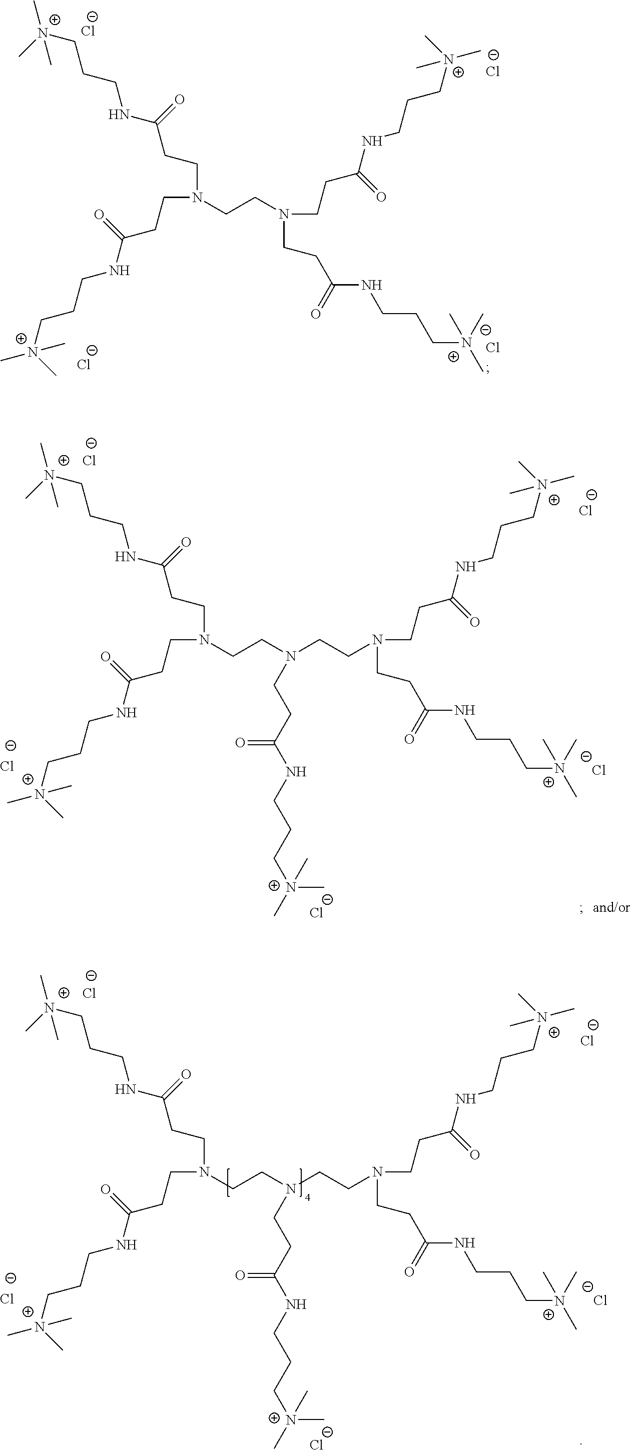

40: The composition of claim 34, wherein the composition further comprises an additional functional ingredient.
